(19) United States
(12) Patent Application Publication
(10) Pub. No.: US 2025/0210760 A1
(43) Pub. Date: Jun. 26, 2025

(54) ELECTRODES AND RELATED SYSTEMS AND METHODS THEROF

(71) Applicant: University of Virginia Patent Foundation, Charlottesville, VA (US)

(72) Inventors: Gary M. Koenig Jr., Fishersville, VA (US); Chen Cai, Charlottesville, VA (US); Ziyang Nie, Lexington, MA (US)

(21) Appl. No.: 18/847,574

(22) PCT Filed: Mar. 16, 2023
(86) PCT No.: PCT/US2023/064509

§ 371 Date: Sep. 16, 2024

Related U.S. Application Data
(60) Provisional application No. 63/320,657, filed on Mar. 16, 2022.
(60) Provisional application No. 63/423,956, filed on Nov. 9, 2022.
(60) Provisional application No. 63/423,995, filed on Nov. 9, 2022.

(51) Int. Cl. H01M 50/131; H01M 4/02; H01M 4/04; H01M 4/1391; H01M 4/36; H01M 4/505; H01M 4/525; H01M 4/62; H01M 10/0525

(52) U.S. Cl. CPC H01M 50/131; H01M 4/0471; H01M 4/1391; H01M 4/364; H01M 4/366; H01M 4/505; H01M 4/525; H01M 4/625; H01M 10/0525; H01M 2004/021

(57) ABSTRACT

According to various aspects, an electrochemical storage device includes an electrode. The electrode includes TiNb₂O₇, LiCoO₂, LiNi_{0.5}Mn_{0.5}O₂, lithium metal, LiMn₂O₄, Li₄Ti₅O₁₂, a mixture of LiMn₂O₄ and LiCoO₂, or mixture thereof.

### CROSS-REFERENCE TO RELATED APPLICATION

This application claims the benefit of priority to U.S. Provisional Patent Application Ser. No. 63/320,657 entitled “Electrode Cells and Related Systems and Methods Thereof,” filed Mar. 16, 2022; U.S. Provisional Patent Application Ser. No. 63/423,956 entitled “Coating Processing Using Sucrose for Thick Sintered Electrode Titanium Niobium Oxide Lithium-Ion Battery Anodes and Related Methods and Compositions Thereof,” Nov. 9, 2022; U.S. Provisional Patent Application Ser. No. 63/423,995 entitled “Processing Temperature Impact on TiNb₂O₇ Thick Sintered Lithium-Ion Battery Electrodes and Related Methods and Compositions Thereof,” Nov. 9, 2022, the disclosures of which are incorporated herein in their entirety by reference.

### STATEMENT OF GOVERNMENT SUPPORT

This invention was made with government support under Grant No. 1825216 awarded by the National Science Foundation. The government has certain rights in the invention.

### BACKGROUND

An electrode is a conductor that is used to establish electrical contact with a non-metallic part of a circuit. Electrodes are used in a wide range of applications, including in batteries, electrochemical cells, and various types of sensors. In medical applications, electrodes are used to measure electrical signals in the body, such as in electrocardiograms (ECGs) and electroencephalograms (EEGs).

Electrodes can be of various shapes and sizes, depending on their intended use. Some common shapes include rods, plates, wires, and discs.

### SUMMARY OF THE INVENTION

According to various aspects, an electrochemical storage device includes an electrode. The electrode includes TiNb₂O₇, LiCoO₂, LiNi_{0.5}Mn_{0.5}O₂, lithium metal, LiMn₂O₄, Li₄Ti₅O₁₂, a mixture of LiMn₂O₄ and LiCoO₂, or mixture thereof.

### BRIEF DESCRIPTION OF THE FIGURES

The drawings illustrate generally, by way of example, but not by way of limitation, various aspects of the present invention.

FIG. 1 provides schematic illustrations of sintered cell cathode structures. FIG. 1A shows a homogenous blend of LMO and LCO (“Blend”), FIG. 1B shows LMO next to current collector and LCO next to separator (“CC:LMO:LCO”), and FIG. 1C shows LMO next to separator and LCO next to current collector (“CC:LCO:LMO”). In all cases the total mass of the LMO and LCO in the electrodes was the same.

FIG. 2 is a schematic illustration of a carbon coating process for forming an electrode.

FIGS. 3A-3D show various electrical properties of various electrodes.

FIG. 4 is a graph showing an X-ray diffraction pattern of the synthesized TNO material.

FIG. 5A is a graph showing discharge capacity at different rates on gravimetric basis for both the TNO and LCO sintered electrodes in full cells for cathode limited conditions.

FIG. 5B is a graph showing discharge capacity at different rates on gravimetric basis for both the TNO and LCO sintered electrodes in full cells for anode limited conditions.

FIG. 6 is a graph showing sintered electrode geometric pore/void fraction for the different mass loadings of LCO blended with LNMO. Error bars are the standard deviations of the mean of xx independent electrode pellets.

FIG. 7 is a graph showing XRD patterns for synthesized powders of LCO and LNMO. FIGS. 8A-8D are SEM images for the synthesized powders of (a, b) LCO and (c, d) LNMO. The images in (b) and (d) are lower magnification of the same samples imaged in (a) and (c), respectively.

FIG. 9 shows XRD patterns for sintered electrode pellets. The materials are 100% LCO, 60% LCO, 45% LCO, 30% LCO, 15% LCO, and 0% LCO.

FIGS. 10A-10L show SEM images at relatively high magnification (left column) and low magnification (right column) taken on the surfaces of sintered electrode pellets. The relevant materials are 100% LCO (a, b), 60% LCO (c, d), 45% LCO (e, f), 30% LCO (g, h), 15% LCO (i, j), and 0% LCO (k, l).

FIG. 11 is a graph showing Volume fraction of the sintered electrode which was occupied by LCO particles as a function of LCO relative mass loading, based on the measured volume of the electrode, the measured mass of LCO in the electrode and the crystal density of LCO.

FIGS. 12A and 12B are graphs showing cathode discharge and a dQ/dV curve for various cathodes.

FIG. 13 is a plot showing a. First cycle charge/discharge voltage profiles for 0% LCO (e.g., LiNi_{0.5}Mn_{0.5}O₂) using a rate of C/500 and C/200 and paired with a sintered LTO anode. C/500 corresponded to 0.045 mA cm⁻².

FIGS. 14A-14F are voltage profiles at C/20-C/2.5 for sintered electrode cells comprised of LTO anodes and cathodes of the composition (a) 0% LCO, (b) 15% LCO, (c) 30% LCO, (d) 45% LCO, (e) 60% LCO, and (f) 100% LCO.

FIG. 15 is a graph showing the discharge capacity during rate capability evaluations of sintered electrode cells with LTO anodes and cathodes with composition of 0% LCO, 15% LCO, 30% LCO, 45% LCO, 60% LCO, and 100% LCO.

FIG. 16 is a plot showing electronic conductivities as a function of lithiation used in simulations.

FIGS. 17A and 17B are plots showing simulated Li concentration in the (a) electrolyte phase and (b) solid-state electrode phase at C/20 discharge (1.13 mA cm⁻²) following a C/20 charge cycle for pure LNMO (0% LCO) cell.

FIGS. 18A and 18B are graphs showing Li concentration in the (a) electrolyte phase and (b) electrode phase at C/20 discharge (1.13 mA cm⁻²) following a C/20 charge cycle for 45% LCO cell. ¹

FIGS. 19A-19E show various plots of discharge properties.

FIGS. 20A-20D are various scans of pellets.

FIGS. 21A-21D are plots showing discharge voltage profiles for sintered electrodes.

FIGS. 22A-22C are plots showing discharge voltage profile.

FIGS. 23A-23C are plots showing (discharge voltage profile.

FIGS. 24A-24B are plots showing theoretical maximum carbon content and actual carbon content determined from TGA for different initial added sucrose content to the TNO material before thermal treatment.

FIG. 25 shows plots showing XRD patterns for 0.0%-sucrose, 2.5%-sucrose, 5.0%-sucrose, and 7.5%-sucrose.

FIGS. 26A-26C are voltage profiles of sintered electrodes.

FIG. 27 is a plot showing average discharge potential of 0.0%-sucrose, 2.5%-sucrose, 5.0%-sucrose and 7.5%-sucrose as the TNO sintered cells paired with sintered LCO cathodes were cycled at different C rates.

FIG. 28 is a plot showing the slope of Δ dQ/dV peak position and overall conductivity of sintered electrode with 0 mass % sucrose, 2.5 mass % sucrose, 5.0 mass % sucrose, and 7.5 mass % sucrose.

FIG. 29 is a plot showing XRD of the TNO materials synthesized at temperatures of 1000° C., 800° C., 700° C., and 600° C.

FIGS. 30A-30B are plots showing (a) first charge/discharge voltage profiles at C/10 and (b) the corresponding calculated dQ/dV from those profiles for composite cells paired with Li foil anodes.

FIGS. 31A-31B are plots showing first charge/discharge voltage profiles at C/50 (0.85 mA cm⁻²) and (b) corresponding calculated dQ/dV profiles for sintered LCO cathodes paired with TNO sintered anodes which had been processed at 1000° C., 800° C., 700°, and 600° C.

FIGS. 32A-32D are plots showing discharge voltage profiles for (a) 1000 C, (b) 800 C, (c) 700 C, and (d) 600 C TNO sintered anode materials for the 1^{st} (green), 2^{nd} (cyan), 3^{rd} (blue), 4^{th} (purple), 5^{th} (orange), and 25^{th} cycle (red).

FIGS. 33A-33C show charge/discharge voltage profiles at higher rates of (a) C/20, (b) C/10, and (c) C/5 for 800 C sintered TNO anode (orange), 700 C sintered anode (green), and 600 C sintered anode (black), where C/5 corresponds to a current density of 8.5 mA cm².

### DETAILED DESCRIPTION OF THE INVENTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Lithium-ion (Li-ion) batteries are an indispensable technology which have been applied in many applications including automobiles, portable electronic devices, and the like. Compared to other rechargeable batteries, Li-ion cells have high energy and power density. However, the performance demands for energy storage are still increasing and necessitate further development. Conventional Li-ion battery electrodes are composites consisting of electroactive material, conductive additive, and polymer binders. Recently, electrodes composed of porous thin films containing only electroactive material that has undergone a thermal treatment (“sintered electrodes”) have been studied. Sintered electrodes can be made much thicker than composite electrodes, and thus the energy density at the cell level can be increased. In some examples a “sintered electrode” can alternatively be refereed to as a “all active material electrode”. This can mean that there is no electrochemically inactive material added to the electrode.

Reversible electrochemical cycling of sintered electrodes has been accomplished with LiCoO₂ (LCO) cathodes and Li₄Ti₅O₁₂ (LTO) anodes. However, these very thick electrodes and are found to result in ion transport resistances, which limits the ability to charge/discharge at high rates. Routes to mitigate the transport restrictions have included processing electrodes with reduced tortuosity and incorporating electrolytes with increased ion concentration/conductivity. Cell improvements (especially energy density) can be achieved by changing the active material components. Alternative materials evaluated for sintered cathodes include LiMn₂O₄ (LMO) and LiFePO₄ (LFP). LMO and LFP have environmental and cost benefits, though not necessarily higher energy density, than LCO but have electronic conductivity limitations. LTO is a popular anode option due to minimal strain during Li⁺ insertion/extraction and an operating voltage within the stability window of carbonate electrolytes. However, the gravimetric capacity of LTO (175 mAh g⁻¹) is relatively low compared to other Li-ion anode materials.

As disclosed herein, an alternative anode with electrochemical capacity within the stability window of carbonate electrolytes is TiNb₂O₇ (TNO). TNO has higher theoretical gravimetric capacity (388 mAh g⁻¹) and density (4.3 g cm⁻³ TNO vs. 3.5 g cm⁻³ LTO) than LTO, thus providing a significant opportunity to increase volumetric capacity as a sintered electrode anode.

According to an aspect of this disclosure, TNO was synthesized via sol-gel method. As further disclosed, TNO can be processed into both composite and sintered electrodes and evaluated electrochemically when paired in half and full cell configurations. The outcomes disclosed herein show that TNO is a suitable material as a sintered anode, providing stable and reversible electrochemical cycling.

More specifically, the instant disclosure shows that the energy density of lithium-ion batteries at a cell level can be improved via increasing thickness and reducing inactive material content of electrodes. One system which achieves both attributes are sintered electrodes comprised of porous thin films of only electroactive material. Li₄Ti₅O₁₂ has often been the used as a sintered anode, however, higher energy density anodes could significantly improve cell energy density. As disclosed herein, TiNb₂O₇ (TNO) was synthesized and evaluated as a sintered anode material. Sintered TNO had stable cycling and relatively high volumetric energy density, suggesting TNO has promise as a sintered anode.

As mentioned previously, examples of two routes to achieve high energy densities at the cell level are to reduce the mass fraction of inactive materials such as conductive additives and binders, and to increase electrode thickness. For both routes there are tradeoffs: electronic conductivity and mechanical flexibility/strength limitations for reducing/eliminating inactive materials and increased mass transfer resistances from using thick electrodes. However, one way to reduce inactive materials in the electrode and to increase thickness is to use electrodes comprised solely of electroactive materials. Such electrodes in some cases undergo a mild thermal treatment to improve the mechanical properties and will be referred to as “sintered electrodes” herein.

Sintered electrodes have been reported which are free of inactive conductive additives and binders, with high loadings exceeding 150 mg cm⁻² and thicknesses over 500 μm. The electrode microstructure for sintered electrodes does not contain inactive additives in the interstitial regions between particles, and thus sintered electrodes have lower tortuosity than conventional composite electrodes. However, the electrodes are still very thick, and thus ion transport limitations through the microstructure and electron transport through the electrode matrix can result in high polarization and rate capability limitations. Because electron conduction through the electrode matrix must proceed through the electroactive material itself in sintered electrodes, materials with relatively high electronic conductivity across the range of extents of lithiation experienced during charge/discharge of the cell are desirable. Thus, cathode materials such as LiCoO₂ (LCO) have been used in multiple sintered electrode studies. LCO is well suited to such electrodes due to its relatively high electronic conductivity: reported to range from 10⁻² to 10² S cm⁻¹ from Li₁CoO₂ to Li_{0.55}CoO₂.

Previous studies with composite cathodes have investigated using multiple cathode materials within the same electrode to improve electrode capabilities or properties. For example, a composite electrode blend using LiMn₂O₄ (LMO) and LiNiₓCo_{1-x-y}Al_{y}O₂ (NCA) demonstrated combined benefits of lower cost, higher operating voltage, and better rate capability from the LMO component and higher capacity, longer storage life, and greater stability from the NCA component.

As disclosed herein, the concept of combining multiple electrode materials is explored in a sintered electrode system. Composite electrodes experience relatively low temperatures during processing, and the individual active material particles (at least before calendaring) are generally separated from one another. In contrast, sintered electrode electroactive material particles have many contact points due to compression during processing, and then are subjected to temperatures which are mild for sintering but much higher than composite electrode solvent removal temperatures. Ideally, the benefits previously observed for multicomponent composite electrodes would translate directly to sintered electrodes; however, the dissimilar materials processed in direct contact with one another may result in unique considerations as will be discussed herein.

In addition, as described above for thick sintered electrodes, the electronic conductivity through the electrode matrix is dependent upon the electrode active material itself. Thus, LCO was chosen as one of the constituents due to its relatively high electronic conductivity as discussed earlier. For the second material in this disclosure, the cathode material LMO was chosen. LMO has been used commercially in composite electrodes, and has benefits relative to LCO with regards to cost due to the higher relative abundance of Mn compared to Co, and may also have environmental benefits. However, the low electronic conductivity of LMO results in high polarization and limited rate capability in a thick sintered electrode system. Thus, combinations of LMO and LCO will be explored as a multicomponent thick sintered electrode in this disclosure.

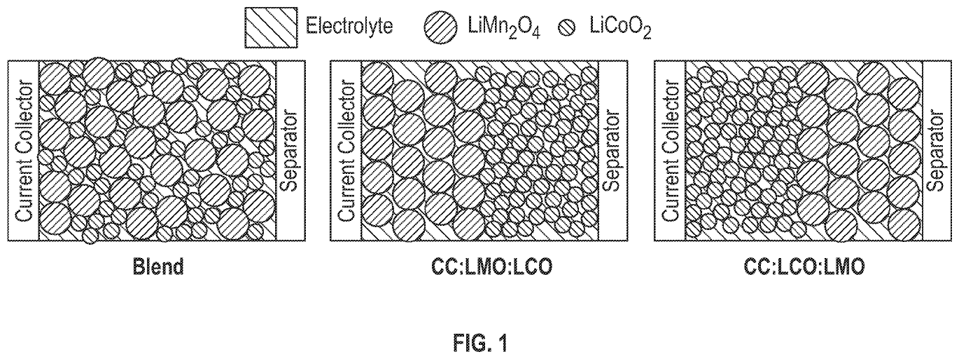

According to various examples of the instant disclosure, sintered cathodes containing both LMO and LCO, three different situations will be described. The first is a homogeneous blend, where powders of the two materials are blended together and then processed into a sintered electrode, which will be referred to as “Blend” (FIG. 1A). For the other two cases, the same relative fraction of materials as the homogeneous blend were used, however the powders were segregated into two separate layers. Then, the two-layer sintered electrode was fabricated into a cell where either the LMO component was on the current collector side (FIG. 1B, referred to as “CC:LMO:LCO”) or the LCO component was on the current collector side (FIG. 1C, referred to as “CC:LCO:LMO”). Previous reports with sintered electrodes have suggested that the progression of lithiation/delithiation within the electrode as a function of electrode depth are dependent on the relevant electronic and ionic transport restrictions in the system. Thus, the drastically different electronic conductivity of LMO and LCO provided a system to assess how the location of the electronically conductive material layer influenced electrochemical outcomes for the cell. The results for these three systems will be discussed in the context of electrochemical characterization and pseudo-two-dimensional (P2D) simulations of the electrochemical cells.

In view of the foregoing, in accordance with various aspects, an electrochemical storage device can include an electrode. The electrode can include many suitable materials. Examples of suitable materials can include TiNb₂O₇, LiCoO₂, LiNi_{0.5}Mn_{0.5}O₂, lithium metal, LiMn₂O₄, Li₄Ti₅O₁₂, a mixture of LiMn₂O₄ and LiCoO₂, or mixture thereof. Depending on various aspects, the electrode can be an anode or a cathode. In specific examples, a cathode can include LiCoO₂. In some examples, the LiCoO₂ includes at least one dopant, at least two dopants, or any suitable number. The at least one dopant has a 1⁺, 2⁺, or 3⁺ oxidation state. As non-limiting examples, the at least one dopant comprises copper, aluminum, sulfur, potassium, or a mixture thereof.

The benefits of the electrodes described herein can be achieved when the electrode is a sintered electrode or a composite electrode. In examples where the electrode is a composite, the electrode can include a metallic substrate to which the TiNb₂O₇, LiCoO₂, LiNi_{0.5}Mn_{0.5}O₂, lithium metal, LiMn₂O₄, Li₄Ti₅O₁₂, a mixture of LiMn₂O₄ and LiCoO₂, or mixture thereof is applied. While not so limited, the metallic substrate can include a stainless steel, aluminum, alloys thereof, or mixtures thereof.

As explained herein, electrode thickness is an important parameter of the electrode. As an example, a thickness of the electrode can be in a range of from about 50 μm to about 2000 μm, about 70 μm to about 400 μm, less than, equal to, or greater than about 50 μm, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1110, 1120, 1130, 1140, 1150, 1160, 1170, 1180, 1190, 1200, 1210, 1220, 1230, 1240, 1250, 1260, 1270, 1280, 1290, 1300, 1310, 1320, 1330, 1340, 1350, 1360, 1370, 1380, 1390, 1400, 1410, 1420, 1430, 1440, 1450, 1460, 1470, 1480, 1490, 1500, 1510, 1520, 1530, 1540, 1550, 1560, 1570, 1580, 1590, 1600, 1610, 1620, 1630, 1640, 1650, 1660, 1670, 1680, 1690, 1700, 1710, 1720, 1730, 1740, 1750, 1760, 1770, 1780, 1790, 1800, 1810, 1820, 1830, 1840, 1850, 1860, 1870, 1880, 1890, 1900, 1910, 1920, 1930, 1940, 1950, 1960, 1970, 1980, 1990, or about 2000 μm.

A porosity of the electrode can be in a range of from about 30% to about 50%, about 35% to about 40%, less than, equal to, or greater than about 30%, 31, 32, 33, 34, 35, 36, 37, 38, 39, 40, 41, 42, 43, 44, 45, 46, 47, 48, 49, or about 50%. The porosity can alternatively be expressed as a void space of the portion of the electrode that is empty. The pores can be through pores in some examples.

According to various examples, the electrode is substantially free of any conductive additives. For example, the electrode can include about 0 wt % to about 5 wt % conductive additive, about 0 wt % to about 0.50 wt %, less than, equal to, or greater than about 0 wt %, 0.1, 0.2, 0.3. 0.4,.0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %. Non limiting examples of conductive additives that the electrode is free of include a polymer binder, a conductive carbon, or a mixture thereof.

The material(s) and construction of the electrode can control the capacity of the electrode. As an example, the capacity of the electrode can be in a range of from about 7 mAh/cm² to about 100 mAh/cm², about 10 mAh/cm² to about 50 mAh/cm², less than, equal to, or greater than about 7 mAh/cm², 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or about 100 mAh/cm².

The electrode, in some aspects, can be associated with an electrically conductive current collector to facilitate the flow of electrons between the electrode and an exterior circuit. The current collector can include metal, such as a metal foil or a metal grid. In some aspects, the current collector can be formed from nickel, aluminum, stainless steel, copper or the like. The electrode material can be cast as a thin film onto the current collector. The electrode material with the current collector can then be dried, for example in an oven, to remove solvent from the sintered electrode. In some aspects, the dried sintered electrode material in contact with the current collector foil or other structure can be subjected to a pressure, such as, from about 2 to about 10 kg/cm² (kilograms per square centimeter).

The separator is located between the positive electrode and the negative electrode. The separator is electrically insulating while providing for at least selected ion conduction between the two electrodes. A variety of materials can be used as separators. Commercial separator materials are generally formed from polymers, such as polyethylene and/or polypropylene that are porous sheets that provide for ionic conduction. Commercial polymer separators include, for example, the Celgard® line of separator material from Hoechst Celanese, Charlotte, N.C. Also, ceramic-polymer composite materials have been developed for separator applications. These composite separators can be stable at higher temperatures, and the composite materials can significantly reduce the fire risk. In some further examples the separator can include glass fibers. Glass fiber separators can be especially useful when a sintered electrode is used.

The electrolyte includes solvated ions as electrolytes, and ionic compositions that dissolve to form solvated ions in appropriate liquids are referred to as electrolyte salts. Electrolytes for lithium ion batteries can comprise one or more selected lithium salts. Appropriate lithium salts generally have inert anions. Suitable lithium salts include, for example, lithium hexafluorophosphate, lithium hexafluoroarsenate, lithium bis(trifluorometh yl sulfonyl imide), lithium trifluoromethane sulfonate, lithium tris(trifluoromethyl sulfonyl) methide, lithium tetrafluoroborate, lithium perchlorate, lithium tetrachloroaluminate, lithium chloride, lithium difluoro oxalato borate, and combinations thereof. Traditionally, the electrolyte comprises a 1 M concentration of the lithium salts, although greater or lesser concentrations can be used.

A non-aqueous liquid can be used to dissolve the lithium salt(s). The solvent generally does not dissolve the electroactive materials. Appropriate solvents include, for example, propylene carbonate, dimethyl carbonate, diethyl carbonate, 2-methyl tetrahydrofuran, dioxolane, tetrahydrofuran, methyl ethyl carbonate, γ-butyrolactone, dimethyl sulfoxide, acetonitrile, formamide, dimethyl formamide, triglyme (tri(ethylene glycol) dimethyl ether), diglyme (diethylene glycol dimethyl ether), DME (glyme or 1,2-dimethyloxyethane or ethylene glycol dimethyl ether), nitromethane and mixtures thereof.

The electrodes described herein can be incorporated into various commercial battery designs, such as prismatic shaped batteries, wound cylindrical batteries, coin batteries or other reasonable battery shapes. The batteries can comprise a single sintered electrode stack or a plurality of sintered electrodes of each charge assembled in parallel and/or series electrical connection(s). Appropriate electrically conductive tabs can be welded or the like to the current collectors, and the resulting jellyroll or stack structure can be placed into a metal canister or polymer package, with the negative tab and positive tab welded to appropriate external contacts. Electrolyte is added to the canister, and the canister is sealed to complete the battery. Some presently used rechargeable commercial batteries include, for example, the cylindrical 18650 batteries (18 mm in diameter and 65 mm long) and 26700 batteries (26 mm in diameter and 70 mm long), although other battery sizes can be used.

The sintered electrode can be formed according to many suitable methods. For example, the electroactive material of the electrode is sintered. Sintering can be performed at a temperature in range of from about 500° C. to about 1100° C., about 700° C. to about 900° C., less than, equal to, or greater than about 500° C., 550, 600, 650, 700, 750, 800, 850, 900, 950, 1000, 1050, or about 1100° C. Sintering can be conducted at a constant temperature or at a variable temperature during the sintering process. Sintering can last for any amount of time in a range of from about 0 hours to about 20 hours, about 12 hours to about 18 hours, less than, equal to, or greater than about 0 hours, 1, 2, 3, 4, 5, 6, 7, 8, 9, 10, 11, 12, 13, 14, 15, 16, 17, 18, 19, or about 20 hours. Sintering can be conducted in one step or across multiple sintering steps.

Alternatively, a composite electrode can be formed by disposing the electroactive material on a substrate. The electroactive material can be in the form of a slurry mixed with a solvent, carbon source, and any other suitable component. The substrate can be an aluminum foil. After the slurry is disposed on the substrate, the slurry is allowed to dry in an oven to form the electrode.

As mentioned previously, in some aspects the electrode can include a degree of porosity. The structure and/or arrangement of pores in the sintered electrode microstructure can lead to additional improvements in the energy and power density of the energy storage device to which the electrode is incorporated. As an example, aligning the pores can improve these properties. One method that can be used to accomplish this is to fabricate an electrode using reactants that are capable of forming an anisotropic structure. This can be accomplished by producing an anisotropic precipitate particle that includes a single transition metal or multiple transition metals. The precipitate can be used as a precursor template in formulating battery active material having an anisotropic morphology. Any suitable transition metal can be used to form the precursor template.

In producing the sintered electrode, there are different strategies to improve or overcome inherent electronic conductivity limitations of electroactive materials. One route is to dope the electroactive material with elements that result in increased electronic conductivity, and this method has even been applied to sintered electrodes with an example being the material LiMn₂O₄ (LMO) or TNO. There are limits to the electronic conductivity improvements via doping methods and at too high of a doping level secondary phases can result. Another option is to carbon coat the electroactive material, and this strategy has been attributed to improving rate capability of other low electronic conductivity electroactive materials such as LiFePO₄. Carbon coating of electroactive materials has been broadly reported for improved interfacial stability and electronic conductivity. Sucrose is a common carbon source that also can serve as a particulate binder material. As described herein a carbon coated sintered electrode can be produced using sucrose both as a sacrificial binder for sintered electrode processing and as a carbon source, where the carbon coating process does not require an extra step for treating the electroactive material powder or the sintered porous pellet relative to processing the electrodes without the coating.

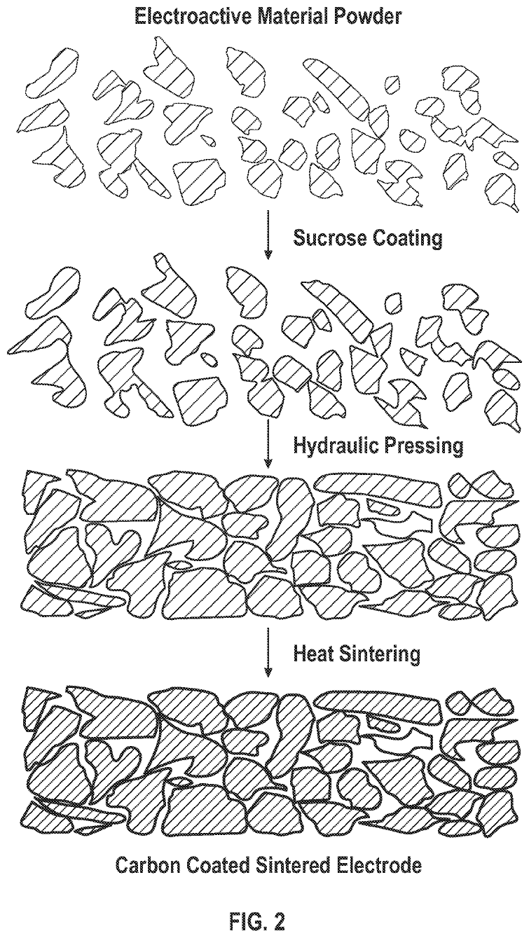

The carbon coating processing is schematically illustrated as an example in FIG. 2. The electroactive material, TNO, can be synthesized via a sol-gel route. The TNO powder can then be coated with sucrose via mixing with an aqueous solution containing dissolved sucrose and drying off the solvent. The sucrose coated powder can then be hydraulically pressed into a porous pellet. Finally, the pellet is heated in an inert atmosphere which converts the sucrose to carbon and results in a porous sintered pellet of TNO with remaining residual carbon from the sucrose source.

The electrochemical storage device described herein can be disposed in many suitable articles. For example, the electrochemical storage device can be disposed in vehicle (e.g., an electric vehicle) or an electronic device.

Examples

Various aspects of the present inventive subject matter can be better understood by reference to the following Examples which are offered by way of illustration. The present inventive subject matter is not limited to the Examples given herein.

### Example 1

### Materials and Methods

### 1. Powder Material Preparation

TiNb₂O₇ (TNO) was synthesized via sol-gel method adapted from literature. First, 0.01 mol Ti(OC₃H₇)₄ (Sigma-Aldrich) and 0.02 mol NbCl₅ (Sigma-Aldrich) was added into 40 mL ethanol with 300 rpm stirring. The solution was heated to 60° C. for 2 hours. Then, the solution was air dried in a fume hood overnight at room temperature to evaporate ethanol. The resulting gel was transferred to an 80° C. oven and dried for 24 hours in air. The resulting powder was washed with deionized (DI) water. Next, the material was fired at 700° C. for 2 h in a Carbolite CWF 1300 box furnace with the heating and cooling rate set to be 1° C. min⁻¹. Powder X-ray diffraction (Empyrean) of the product confirmed the crystal structure of the TNO material was consistent with previous reports.

[symbol]

LiCoO₂ (LCO) was synthesized via coprecipitation of CoC₂O₄·2H₂O followed by lithiation of the precursor. First, 1800 mL of 62.8 mmol·L⁻¹ Co(NO₃)₂·6H₂O (Fisher Reagent Grade) solution and 1800 mL of 87.9 mmol L⁻¹ (NH₄)₂C₂O₄·H₂O (Fisher Certified ACS) solution was prepared and heated to 50° C. Then the Co(NO₃)₂ was poured into (NH₄)₂C₂O₄ solution all at once with 800 rpm stirring to facilitate the mixing. After maintaining at the same temperature for 30 minutes, the solid precipitate was collected using vacuum filtration and rinsed with 4 L DI water. The powder was dried in an 80° C. oven for 24 h in air. The oxalate precursor was mixed with Li₂CO₃ (Fisher Chemical) with a molar ratio of 1.02:1 for Li:Co using mortar and pestle. Then, the powder mixture was fired at 800° C. in air in a Carbolite CWF 1300 box furnace with a ramp rate of 1° C. min⁻¹. The sample was cooled to room temperature without control of cooling rate after reaching 800° C. The LCO product was then milled in a Fritsch Pulverisette 7 planetary ball mill using 57 zirconia beads (5 mm diameter) at 300 rpm for 5 hours.

LiFePO₄ (LFP) cathode powder was purchased from a commercial supplier (Xiamen TOB New Energy Technology) and used as received. Characterization and electrochemical properties of LCO and LFP material used in this study can be found in previous publications.

### 2. Electrode Preparation

### 2.1 Composite Electrode Fabrication

The composite electrode was made via slurry casting. The active material was mixed with Super P carbon (Alfa Aesar) and polyvinylidene difluoride (PVDF, Alfa Aesar) dissolved in n-methyl-2-pyrrolidone (NMP) solvent. The weight ratio of active material:carbon:PVDF was 8:1:1. The slurry was cast onto an aluminum foil and dried in an 80° C. oven in air atmosphere for 12 hours. The electrode sheet was transferred to a vacuum oven and further dried in 80° C. in vacuum for 3 hours. The resulting electrode was stored in a dry box.

The composite LiNi_{0.8}Co_{0.15}Al_{0.05}O₂ (NCA) electrode was provided by Argonne CAMP facility with a loading of 9.9 mg cm⁻². For cell fabrication, a 9/16″ discs were punched from electrodes.

### 2.2 Sintered Electrode Fabrication

TNO or LCO powder was mixed with 1 wt. % polyvinyl butyral (Pfaltz & Bauer) solution dissolved in ethanol (Acros). 1 g powder was blended with 2 mL polymer binder solution with a mortar and pestle. After the solvent evaporated, 0.2 g of the mixture was loaded into a 13 mm diameter Carver pellet die and pressed with 12,000 lbf for 2 minutes in a Carver hydraulic press. The pellets were then heated in a Carbolite CWF 1300 box furnace in an air atmosphere at a ramp rate of 1° C. min⁻¹ from 600° C., held at 600° C. for 1 hour, then cooled at 1° C. min⁻¹ to 25° C.

### 3. Electrochemical Cell Fabrication

All electrochemical characterization was conducted using CR2032 coin cells. For TNO composite half cell, the TNO electrode was paired with a 100 μm thick, 9/16″ diameter Li foil disc. For composite full cells, the TNO anode was paired with a composite cathode. 8 drops of electrolyte (1.2 mol L⁻¹ LiPF₆ in 3:7 EC:EMC, Gotion) were added for each composite cell. For sintered full cell, the LCO pellets were pasted onto the bottom plate of the coin cell and TNO pellets were pasted on a stainless steel spacer (15.5 mm in diameter and 0.5 mm in thickness). The paste was composed of 1:1 weight ratio Super P carbon to PVDF dissolved in NMP. After drying in an 80° C. oven for 12 hours in air, the pellets were fabricated in to full cells with 16 drops of electrolyte added. Cell fabrication was conducted in an Ar atmosphere glove box with both O₂ and H₂O content <1 ppm and Celgard 2325 separators were used for all cells.

Galvanostatic charge/discharge cycling was conducted at different C rates using a MACCOR battery cycler. The C rate was based on the mass loading of the cathode material with an assumed capacity (150 mAh g⁻¹ for LCO, 165 mAh g⁻¹ for LFP and 180 mAh g⁻¹ for NCA).

TABLE 1

| | Assumed | | Voltage | 1 C |
|---|---|---|---|---|
| | cell | Anode | window | current |
| | capacity | capacity:cathode | (V, | density |
| Cell | (mAh) | capacity | cell) | (mA cm⁻²) |
| TNO/LCO | 1.4 | 2.0 | 0.4-2.6 | 0.88 |
| TNO/LFP | 1.6 | 1.6 | 0.4-2.2 | 1.03 |
| TNO/NCA | 2.6 | 0.9 | 0.4-2.9 | 1.63 |

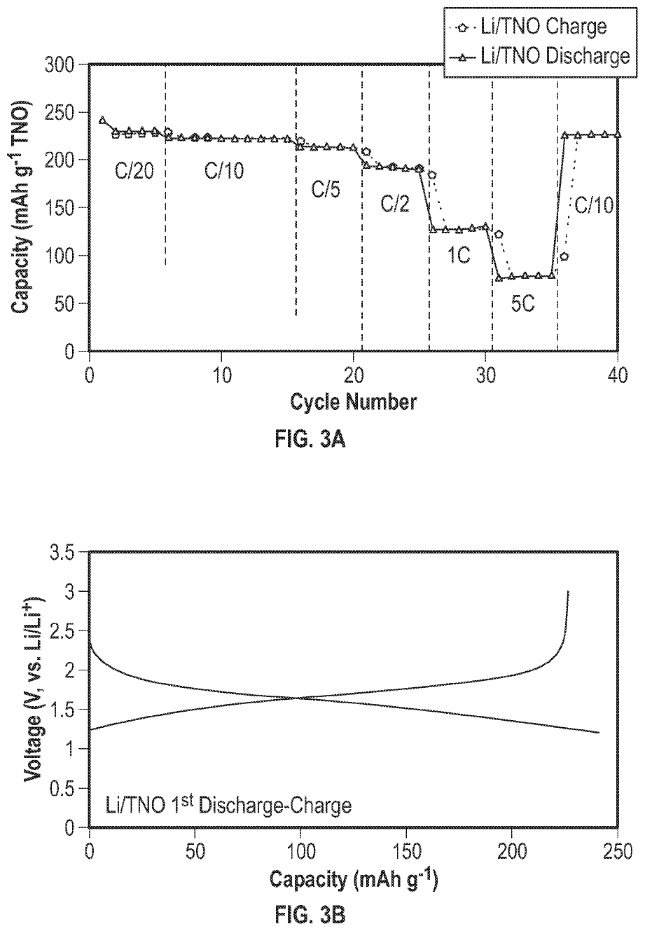

The charge and discharge capacity of a Li/TNO cell with a composite TNO cathode at different rates of charge/discharge can be found FIG. 3A. The charge/discharge rate was the same for each cycle and is noted on the figure. Also, the first discharge-charge cycles (Li/TNO cell starts with discharge) at C/10 are shown in FIG. 3B. The voltage window was 1.2-3.0 V (vs. Li/Li⁺), and the average voltage at C/10 rate was ˜1.6˜1.7 V vs. Li/Li⁺, slightly above the voltage plateau for LTO (˜1.5 V vs. Li/Li⁺). A flat voltage plateau was not observed for TNO. The first cycle columbic efficiency was 95%, possibly due to some slight electrolyte decomposition and interphase formation on cell components (Li foil, Al current collector and TNO). After the first cycle, the columbic efficiency approached 100% and the capacity was stable at each cycling rate, indicating good reversibility of electrochemical capacity. The capacity at a relatively low rate (C/10) was ˜230 mAh g⁻¹ TNO; and at a high rate of 5 C, 78 mAh g⁻¹ TNO capacity was delivered. Compared to a prior report, the gravimetric capacity of TNO was lower, but this was in part due to a slightly different voltage window. More capacity can be obtained at a lower voltage cut off (i.e., 0.8 V vs. Li/Li⁺), but at the expense of increased capacity fade with cycling. In this work, stable cycling of the sintered TNO electrode was desired, thus the voltage range was restricted to avoid excessive capacity fade.

Composite full cell electrochemical capacity (on a LCO cathode basis) for full cells of TNO composite anodes paired with LCO composite cathodes can be found in FIG. 3C. The charge rate was set at C/10 for all cycles and the discharge rate is noted in the figure. The charge/discharge voltage profile for the first cycle of the TNO/LCO composite electrode cell can be seen in FIG. 3D. Both TNO and LCO have sloped voltage profiles as a function of extent of lithiation, and thus the full cell also had a gradual slope (e.g., no clear plateau regions). The capacity of the TNO/LCO cell was fairly stable with cycling, and a low (C/10) rate capacity of ˜134 mAh g⁻¹ LCO was delivered.

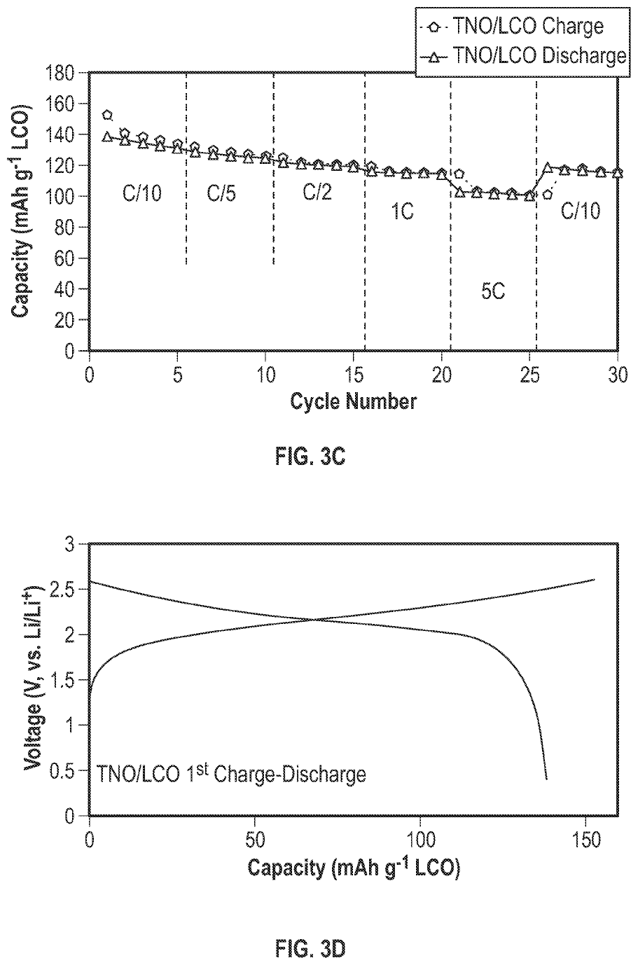

The irreversible first cycle capacity of 9% for the TNO/LCO cell likely had significant contribution from the presence of the TNO (with 6% first cycle irreversible capacity, FIG. 3B); however, slight capacity fade in later cycles may have been due to LCO capacity losses. At higher discharge rate such as 5 C, ˜101 mAh g⁻¹ LCO capacity was still delivered, indicating good retention of capacity at increasing rates (i.e., 75% at 5 C relative to C/10) with thin composite electrodes. Cycling at increasing rates for TNO composite anodes paired two other composite cathode materials is shown in FIG. 4, with corresponding cell parameters in Table 1. The TNO material was overall stable for multiple cycles at a variety of rates when processed into composite electrodes.

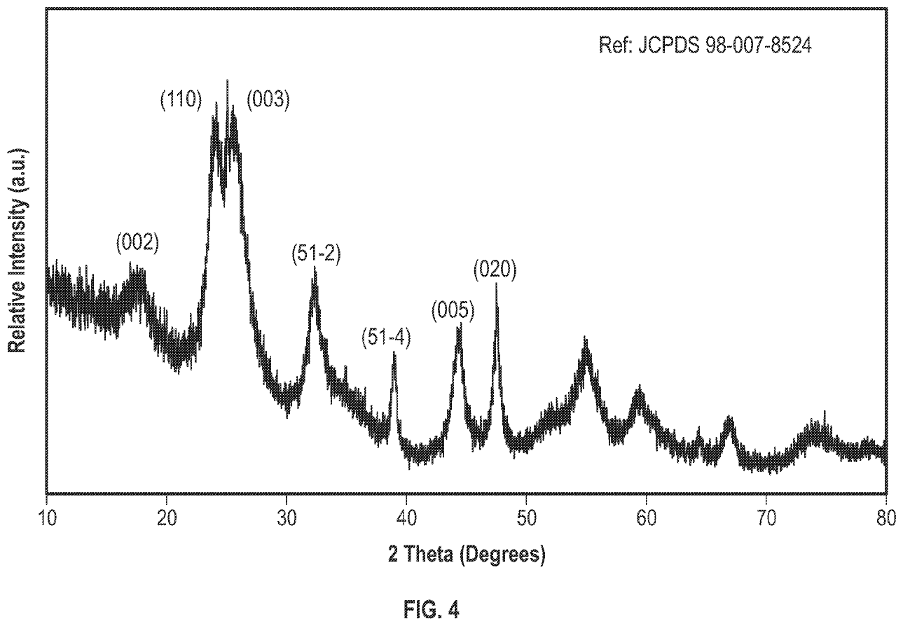

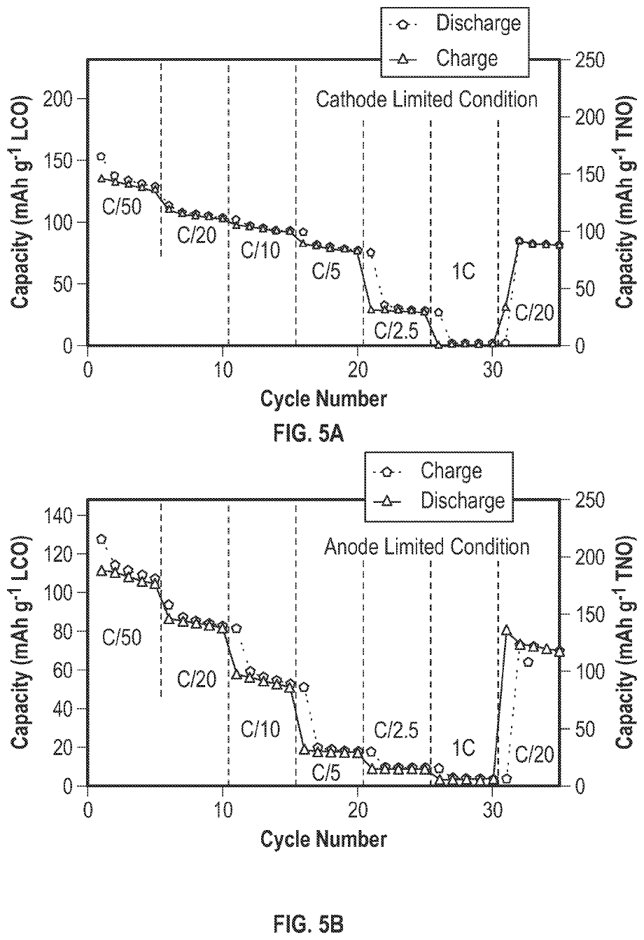

Stability of TNO in composite electrodes led to further assessment of its suitability as a sintered electrode active material. Sintered electrodes do not have conductive carbon and polymer binder as additives. The electrodes consist of only active materials and were much thicker than the composite electrodes (for TNO ˜70 μm for composite and ˜400 μm for sintered electrodes). TNO sintered anodes were paired with LCO sintered cathodes. Two cell variations will be described: one was a cathode limited condition, where the LCO was 191 mg and TNO was 177 mg (˜38.9 mAh anode and ˜28.6 mAh cathode based on composite electrode capacities). The second condition was anode limited where 147 mg TNO was paired with 250 mg LCO (˜32.3 mAh anode and ˜37.5 mAh cathode based on composite electrode capacities). The gravimetric capacities on both TNO and LCO bases at increasing rates can be found in FIG. 5. For each condition, 3 nominally identical cells were tested and the data shown in FIG. 4 was one representative cell chosen for each condition.

The capacity was relatively stable for each cell at each rate (FIG. 5), though an overall slight fade in capacity was observed with cycling. The retention of capacity at increasing rate was not as high as the composite TNO/LCO cell (FIG. 3C). This was attributed to the increased ion transport resistance from the thicker electrodes. It is noted that the electronic conductivity especially of the sintered TNO was lower than the composite electrode due to lack of conductive additives. However, the much greater thickness of the sintered electrodes results in capacity increases on an aerial and cell level, where for the composite electrodes the low rate cell capacity was 1.2 mAh and for the sintered electrodes the low rate cell capacity was 25 mAh. Detailed discussion on limitations and improvements of cells with sintered electrodes can be found in previous publications.

The rate capability results in FIG. 5 revealed that the cathode limited cell condition resulted in higher capacity retention at increasing rate. This outcome was attributed to differences in the transport restrictions for the two conditions. For the two cells showed in FIG. 5, the total active material loading was not equivalent. Loading differences changed estimates of cell capacity (28.6 mAh for cathode limited vs. 32.3 mAh for anode limited); thus with the C rate being adjusted by the cell capacity an equivalent C rate for the anode limited condition had higher total current and current density. Increased current resulted in higher electronic and ionic transport polarization in the cell. Electrode thicknesses were also note equivalent. For the cathode limited condition, the anode thickness was 0.51 mm and the cathode thickness was 0.44 mm. For anode limited condition, the anode thickness was 0.44 mm and the cathode was 0.59 mm. The LCO electrodes had lower porosity (˜35%) than TNO electrodes (˜40%), and thicker LCO would result in higher ion transport polarization and reduced rate capability.

Another difference between the cells was capacity fade with cycling. Although for the cycles within each rate the capacity was stable, comparison of the series of cycles at C/20 (e.g., cycles 6-10 compared with cycles 31-35) revealed different capacity fade. The underlying cause of capacity fade will be the subject of future reports; however, several factors may have contributed to the fade. One factor was that the volume change of TNO material during lithiation/delithiation process has been reported as 7.22%, which was much larger than the volume change of LTO (0.2%) used in previous studies, [symbol] and also higher than the LCO material (1.9%) used as cathode in this work. This volume change could result in internal stress and impact particle contacts necessary for electronic conductivity through the electrode matrix and access to electrode capacity. Another contributor may have been the different extents and progression of lithiation/delithiation during the cycling. Although the overall cell voltage window was carefully controlled, TNO does not have a flat voltage plateau and thus it is challenging to be confident the overpotential experienced by the active material particles was the same both conditions. There may have been regions within the sintered electrodes where the local potential could have resulted in extra irreversible capacity loss due to exceeding electrolyte stability limits or reversible lithiation extents of the TNO. Overall, sintered TNO/LCO cells showed promising cycling performance.

The use of TNO can improve the energy density at a cell level and ion transport polarization relative to using LTO. For example, a 0.5 mm thick, 35% porosity LCO pellet has a capacity of 32.2 mAh. And thus, a balanced LTO (40% porosity) anode requires a thickness of 0.66 mm. However, a balanced TNO anode needs a thickness of only 0.43 mm, which is a 35% reduction in anode thickness and a 20% reduction in total cell electrode thickness. Assuming a constant cathode, a thinner sintered anode will reduce ion transport resistance and increase volumetric energy density-increasing both the power and energy of the cell.

As demonstrated herein, TNO was synthesized via sol-gel method and processed into composite and sintered electrodes. Composite TNO electrodes showed good cycling stability both in half cells paired with Li metal anodes and full cells paired with composite LCO cathodes. TNO/LCO sintered electrode full cells also had promising reversible electrochemical capacity, although some fade was observed which warrants further investigation. TNO has a relatively high gravimetric and volumetric capacity, and this work demonstrated the cycling of TNO anodes in sintered full cells, which shows promise for providing high cell level energy density when coupling the electrochemical properties of TNO materials with the large thicknesses achievable with sintered electrode processing.

### Example 2

### 1.1 Active Material Powder Synthesis

LNMO was synthesized via high temperature lithiation and calcination of a transition metal oxalate precursor. The precursor was synthesized using precipitation methods. 200 mM of sodium oxalate (Na₂C₂O₄) was dissolved into 400 mL of deionized (DI) water within a 1000 ml beaker. 100 mM of manganese sulfate monohydrate (MnC₂O₄·2H₂O, Fisher Chemical) and 100 mM of nickel sulfate hexahydrate (NiSO₄·6H₂O, Fisher Chemical) were dissolved into 400 mL DI water using a separate 1000 ml beaker. Both solutions were heated to 60° C. before pouring the Mn/Ni sulfate solution into the oxalate solution all at once. The precipitation reaction proceeded for 30 minutes at 60° C. at 300 RPM stirring. Then, the precipitate was collected using vacuum filtration and rinsed with 1.6 L DI water before drying overnight at 80° C. in air. The resulting Ni_{0.5}Mn_{0.5}C₂O₄·2H₂O was mixed with LiOH with a target molar ratio of 1:1.1 transition metal:Li using mortar and pestle by hand for 10 minutes. The powder mixture was then transferred to a furnace (Carbolite CWF 1300) for calcination. The temperature profile for the thermal process included a hold at 480° C. for 3 hours and then 950° C. for 10 hours. Temperature increases occurred at a rate of 1° C. min⁻¹, but the cooling rate back to room temperature was not controlled.

For LCO, 200 mM each of Na₂C₂O₄ and cobalt sulfate heptahydrate (CoSO₄·7H₂O, Acros Organics) were separately dissolved into 400 mL of DI water into two 1000 ml beakers. The reaction conditions were otherwise the same as the LNMO precursor synthesis. The CoC₂O₄·2H₂O was mixed with Li₂CO₃ (Fisher Chemical) with a target molar ratio of 2:1.05 oxalate precursor:lithium carbonate. The mixture was heated to 800° C. without a hold at the top temperature using a heating rate of 1° C. min⁻¹. Upon reaching the set temperature, cooling proceeded to room temperature without temperature control. The synthesized powder was then ball-milled (Fritsch Pulverisette 7 planetary ball miller) with zirconia beads of 4.8 mm diameter for 5 hours at 300 RPM using a powder to beads mass ratio of 1:5.

### 1.2 Sintered Electrode Fabrication

To fabricate sintered electrode cathodes, the synthesized active material powders of LNMO and LCO were used in isolation or in blends. For sintered electrode anodes, the material was purchased from a commercial vendor and was Li₄Ti₅O₁₂ (LTO, NEI corporation). Material and electrochemical properties for the LCO and LTO materials, both in composite and sintered electrodes, have been reported previously. To prepare a sintered electrode, the active material powder of 1 g was blended with 2 mL of 1 wt % polyvinyl butyral (PVB, Pfaltz & Bauer) in ethanol. The suspension was mixed using mortar and pestle by hand until the ethanol evaporated and the powder appeared dry. PVB-coated powder was used for fabricating all the sintered electrodes.

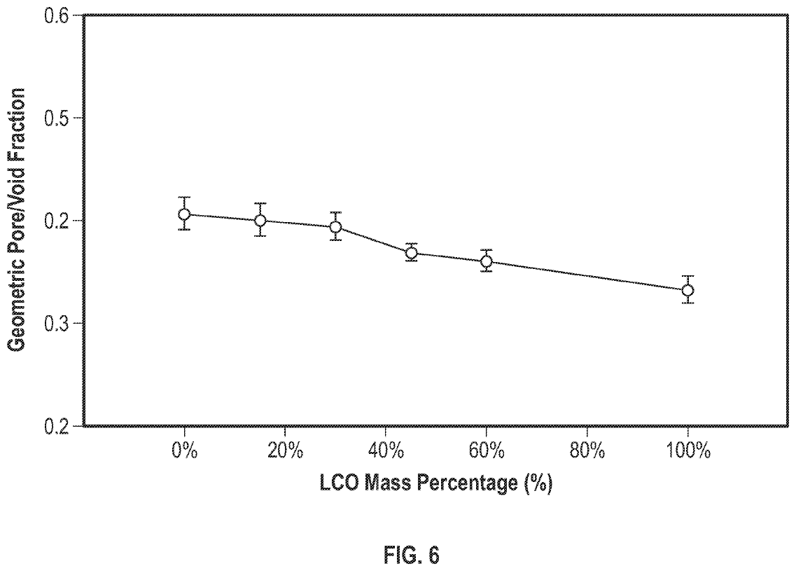

For sintered electrode cathodes, PVB-coated LNMO and LCO powder was used and blended at the desired mass ratio by hand using mortar and pestle. The compositions used on a LCO mass percentage basis were 0%, 15%, 30%, 45%, 60%, and 100% (denoted as 0% LCO, 15% LCO, 30% LCO, 45% LCO, 60% LCO, and 100% LCO). 0.2 g of resulting cathode powder was loaded into a pellet die (Carver) with diameter of 13 mm before being hydraulically pressed at 430 MPa for 2 minutes (Carver). The pressed pellet was thermally treated by heating to 600° C. at a rate of 1° C. min⁻¹ without a hold and then allowed to cool without control over the cooling rate to room temperature. The sintered pellets had thicknesses ranging from 450 to 550 μm as measured using calipers and loadings ranging from 145 to 150 mg cm⁻². Due to the morphology and particle size differences, the pellet geometric void/pore volume fraction for pure LNMO was 0.41 and linearly decreased to 0.33 for pure LCO (see FIG. 6).

For sintered LTO anode fabrication, 0.2 g of PVB-coated LTO was pressed following the same procedures as the cathode powders. For thermal treatment of the electrode, the temperature was increased at a rate of 1° C. min⁻¹ to 600° C., held for 1 h, and the temperature was ramped down at a rate of 1° C. min⁻¹ back to room temperature. The sintered LTO electrodes had thickness ranging from 710-720 μm and loadings ranging from 148-152 mg cm⁻², with geometric porosity/void fractions of 0.40.

### 1.3 Material Characterization

Scanning electron micrographs (SEM) were collected using a FEI Quantum 650. Primary particle sizes were measured for 20 particles in SEM images to calculate mean primary particle size. SEMs were taken for both LNMO and LCO as both loose active material powder and after processing into sintered pellets. X-ray diffraction (XRD) patterns were collected on both powders and pellets using a PANalytical X′pert ProMPD.

### 1.4 Electrochemical Characterization

For composite electrode cells, the synthesized cathode active material powder (LNMO or LCO) was blended with acetylene carbon black (CB, Alfa Aesar), and polyvinyl pyrrolidone (PVP, Sigma Aldrich, 360 kDa molecular weight) using ethanol (Fisher) solvent with a mass ratio of 8:1:1 electroactive material:CB:PVP. The blend was then processed in a slurry mixer (Thinky AR-100) at 2000 RPM for 4 minutes, sonicated for 5 minutes, and blended in the slurry mixer for an additional 4 minutes at 2000 RPM. The resulting slurry was coated onto an aluminum foil with a doctor blade. The coated composite electrode was vacuum dried at 80° C. before punching into circular discs with an area of 1.33 cm² and transferring the electrodes into a glove box. The LNMO and LCO composite cathode loadings were approximately 5.1 mg cm⁻² and 3.6 mg cm⁻². Celgard 2325 punched into circular discs with an area of 1.98 cm² was used as separator and Li foil discs with an area of 1.60 cm² were used as anodes. 1.2 M LiPF₆ in 3:7 ethylene carbonate:ethyl methyl carbonate (Gotion) was used as electrolyte. Coin cells (2032-type) were assembled and cycled using a multichannel battery cycler (MACCOR) with a voltage range of 2.5 V to 4.4 V (vs. Li/Li⁺).

For sintered electrode cells, sintered pellet cathode and anode were adhered to a stainless steel bottom plate and a spacer, respectively, using a custom carbon paste. The carbon paste was made by blending a slurry consisting of by weight 4.76%:4.76%:90.48% CB:PVP:ethanol. The attached pellet electrodes were vacuum dried at 80° C. for 1 h before transferring to the glove box. Glass fiber (Fisher, type G6 circles) was used as a separator and the same electrolyte (Gotion) as for the composite electrode cells was used. Cells were cycled between 1.0 V and 2.85 V, where 1.13 mA cm⁻² was used as C/20 rate, assuming the gravimetric capacity of cathode material to be 150 mAh g⁻¹ based on a loading of ˜150 mg cm⁻². Each individual charge and discharge cycle used the same current density, although the current density/rate applied was systematically varied for rate capability testing. Rate capability tests were conducted using C rates varying from C/20 to C/2.5.

### 2. Results & Discussion

### 2.1 Material Characterizations

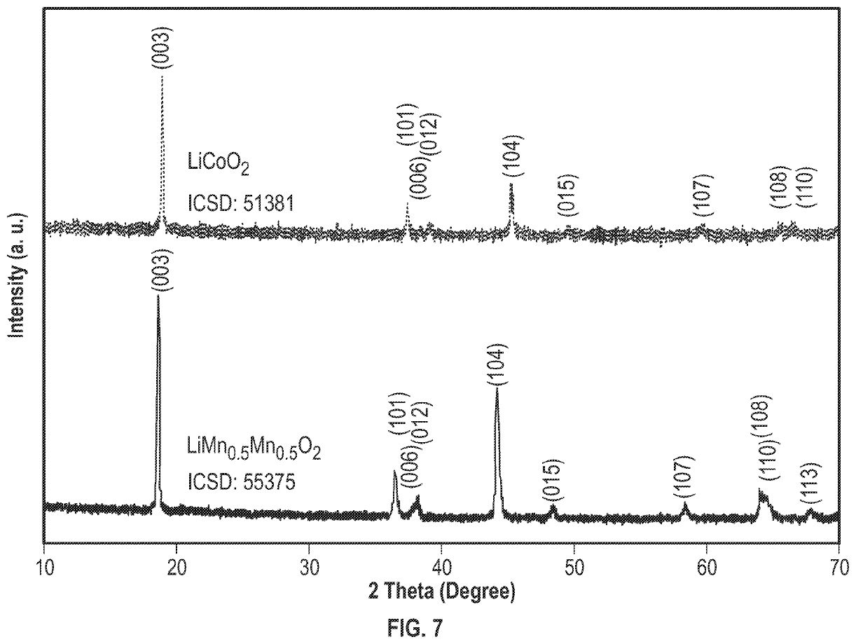

The XRD patterns for both LNMO and LCO exhibited no impurity peaks (for the patterns see FIG. 7), and each peak was assigned based on the expected space group for these materials of R-3m. SEM images of active material powders (FIG. 8) suggested that LCO had an irregular particle morphology and relatively small primary particle size of 300±150 nm, while LNMO had slightly larger primary particles of 420±130 nm with a more rounded morphology (uncertainties were the standard deviation based on 20 randomly selected individual primary particles). Some of the differences in the observed morphology may have originated as a consequence of LCO undergoing a ball-milling process, while LNMO was not ball-milled. Part of the reason why LCO was ball-milled was to be consistent with processes used in prior reports, although for the goal of a blended electrode with percolated LCO finer LCO particles may be desirable to improve dispersion in the interstitial regions between LNMO particles, though such morphology impacts on distribution of LCO material was speculative.

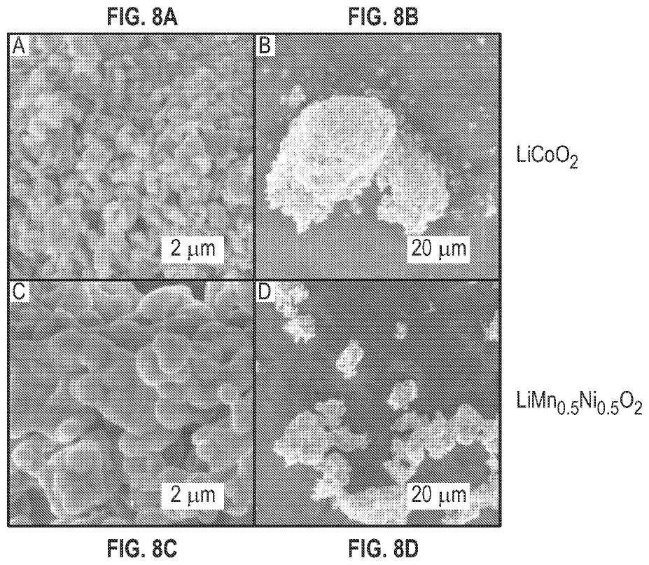

XRD patterns for all sintered electrodes can be found in, FIG. 9. The mild sintering procedure did not create any new phases for 0% LCO (pure LNMO) and 100% LCO. Clearly, with increasing LCO content, the relative peak intensity of the LCO constituent increased as expected. Although the thermal treatment would be expected to result in some interdiffusion between Co and Mn/Ni, from XRD the two materials appeared to remain segregated and compositionally and structurally distinct. More specifically, the (003) peak for pure LNMO was distinctly located at 2θ of 18.63°, while for LCO the corresponding peak was at 2θ of 18.96°. For the blended materials, the relative magnitudes of these peaks changed, but the peak positions did not shift, suggesting that the two materials remained largely compositionally and structurally segregated, at least for the bulk materials responsible for the XRD patterns.

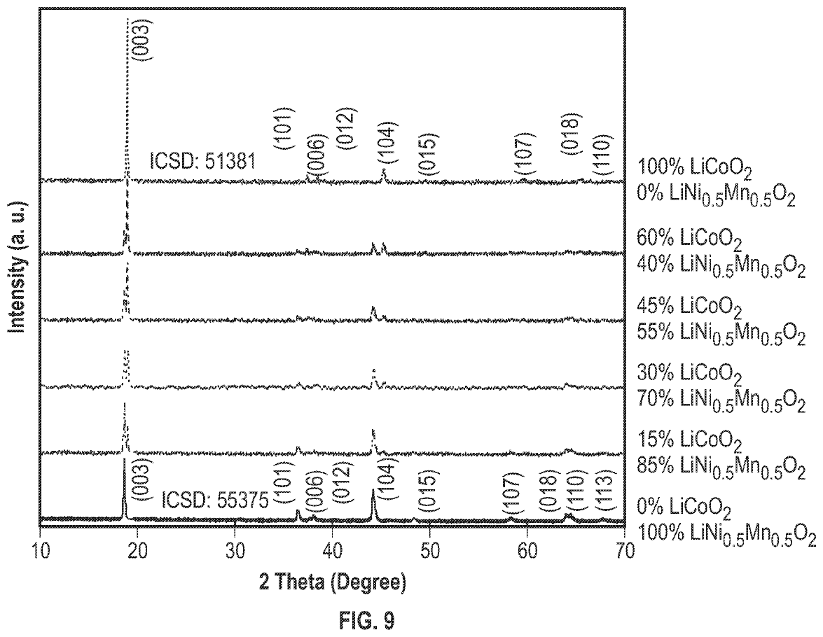

SEM images of the surfaces for each sintered electrode composition can be found in FIG. 10. For pure LCO and LNMO, with the mild thermal treatment conditions applied to the porous ceramic pellets, there was a slight increase in the mean primary particle size, however, the size distribution was wide so it was difficult to confirm a particle coarsening effect from the thermal treatment. The primary particle size was 400±80 nm for LCO, and 460±100 nm for LNMO (uncertainties based on standard deviation for 20 independent particle measurements). For the blend pellets, it was noticeable that as the LCO content was increased the fraction of smaller particles observed in SEM also increased, consistent with a relative increase of the smaller LCO particles in the electrode pellet.

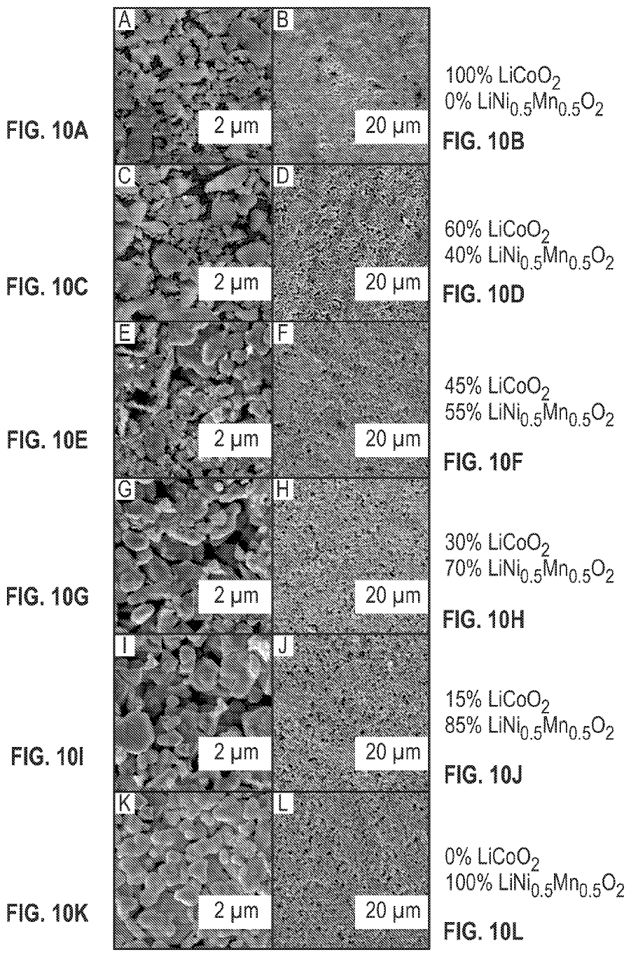

Disordered jammed sphere packing, which may be a reasonable representation of the sintered electrodes, has been reported to have a critical volume fraction to achieve percolation for a given sphere material in the system of 0.199 for a three-dimensional system. Based on the reported crystal density for LNMO and LCO, the LCO volume fraction reached 0.17 for 30% LCO (slightly below the threshold) and 0.27 for 45% LCO (well above the threshold). The calculated volume fraction of LCO for each sample can be found in FIG. 11. To further support the formation of a percolated LCO network, EDS mapping of 15% LCO, 30% LCO, 45% LCO, and 60% LCO sintered electrodes was performed. While the two-dimensional EDS maps cannot confirm that there was three-dimensional continuous connectivity of the LCO particles, it was observed that the LCO particles started to form larger connected regions for 45% LCO, and had a very well-connected structure for the 60% LCO. Due to the two-dimensional limitations of EDS and preferential surface sensitivity, formation of a percolated network of LCO may have occurred at a lower loading than the observed 45% LCO.

### 2.2 Electrochemical Characterizations

### 2.2.1 Pure LCO Cell Electrochemical Evaluation

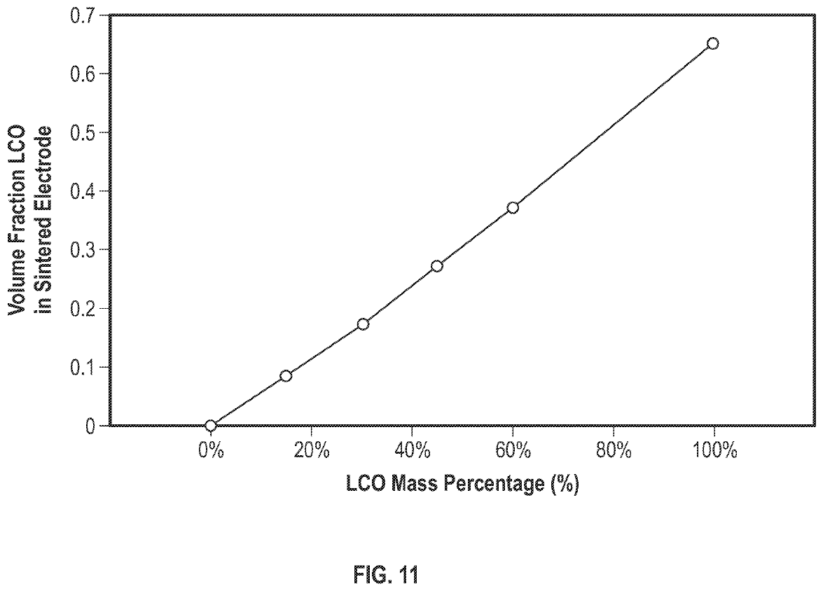

To obtain data most representative of the intrinsic electroactive particle charge/discharge profiles without the electronic conductivity and large thickness complications of the sintered electrodes, LCO was first evaluated in conventional composite electrodes paired with Li metal anodes. With a voltage window of 2.5 V to 4.4 V, LCO reached 140 mAh g⁻¹ cathode discharge for the first cycle at C/10 (FIG. 12A). A dQ/dV curve (FIG. 12B) of the first cycle at C/10 suggested a voltage plateau at ˜3.9 V (versus Li/Li⁺). The as prepared LCO exhibited electrochemical charge/discharge curves consistent with expectations.

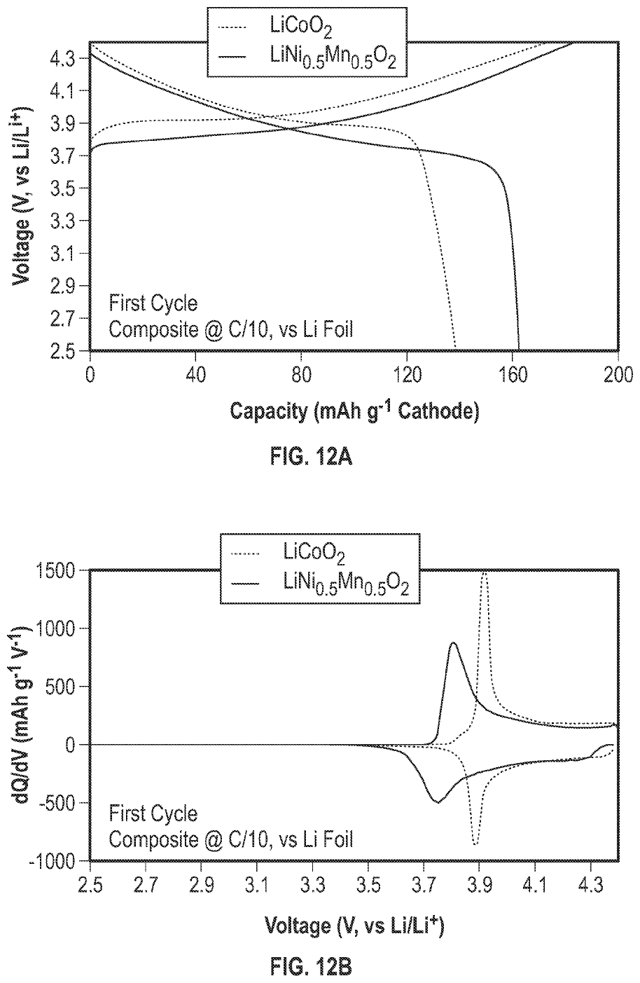

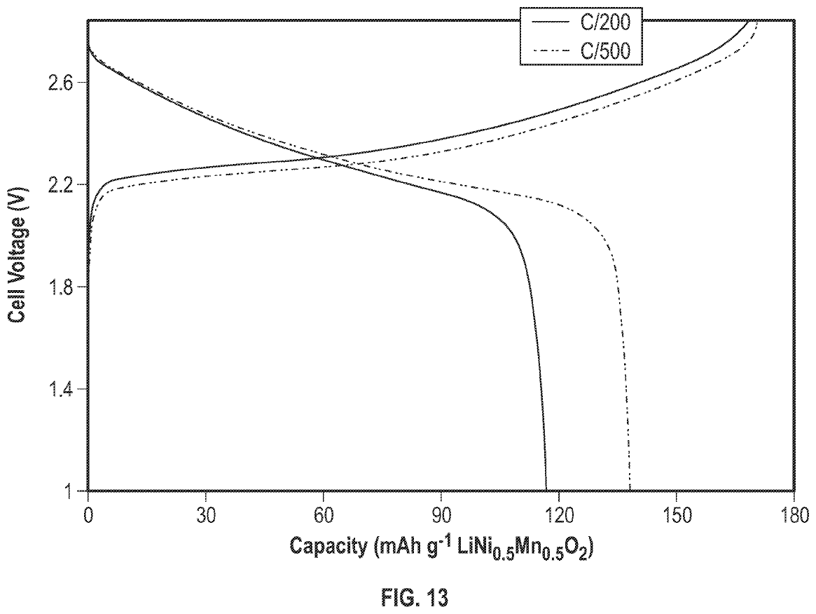

For the sintered LCO electrode (100% LCO) paired with sintered LTO using a voltage window from 1.0 V to 2.85 V (corresponding to 2.56 V to 4.41 V vs. Li/Li⁺, assuming the OCV of LTO was 1.56 V vs. Li/Li⁺), the first cycle at C/80 attained nearly the same discharge capacity (139 mAh g⁻¹ cathode) as the composite cathode cells. The sintered electrode cell dQ/dV had a single peak at 2.3 V, which was consistent with previous reports. At higher rates of C/20, C/10, C/5, and C/2.5, the sintered electrode cell discharge capacity was 112 mAh g⁻¹, 62 mAh g⁻¹, 29 mAh g⁻¹, and 12 mAh g⁻¹, respectively, on an LCO mass basis. Such decrease in capacity was expected to have originated from the ionic transport limitations though the thick electrode microstructure for this material pairing, as has been described thoroughly in previous reports. The voltage profiles and rate capability results can be found in FIGS. 13 and 14.

### 2.2.2 Pure LNMO Cell Electrochemical Evaluation

For LNMO material evaluated in a composite cell paired with Li metal anode, the same voltage window as with LCO of 2.5 V to 4.4 V was used. The first discharge cycle at C/10 reached 163 mAh g⁻¹ cathode. The dQ/dV of LNMO for that cycle compared to that of LCO had a broader peak located at slightly lower voltage of 3.75 V, consistent with previous literature.

For the sintered LNMO cathode cell, the first discharge at C/80 (0.282 mA cm⁻²) only reached 97 mAh g⁻¹ cathode. Based on the composite electrode dQ/dV result and the voltage offset from using LTO in the sintered cell, a peak was expected at 2.16 V; however, a clear dQ/dV peak was not observed for this discharge. The discharge capacity retention of the sintered cell relative to the composite cathode cell for LNMO was 60%, while for LCO it was 99% at C/80. Such differences were hypothesized to result from the much lower electronic conductivity of the LNMO, which has been reported with a range from 10⁻⁵ to 10⁻⁶ S cm⁻¹ for the pristine material before cycling. These electronic conductivity values are more than 4 orders of magnitude lower than LCO, where for over 95% of the lithiation range typically accessed for LCO the electronic conductivity is over 10⁻¹ S cm⁻¹. Cells cycled at C/200 and C/500 delivered 117 mAh g⁻¹ LNMO and 138 mAh g⁻¹ LNMO on the first discharge cycle, which was 72% and 85% retention relative to composite electrode initial discharge gravimetric capacity.

Interestingly, the first charge capacity at C/200 and C/500 were quite similar (169 mAh g⁻¹ and 171 mAh g⁻¹), where the differences (2 mAh g-1 cathode) were much smaller than that of the discharge (21 mAh g⁻¹ cathode). This outcome would be consistent with the LNMO material having a variable electronic conductivity as a function of lithiation, where the electronic conductivity increases upon delithiation similar to other layered materials such as LCO. Thus, the charging process may have extracted all of the available capacity from the LNMO active material, facilitated by the improved electronic conductivity as the material was delithiated. However, as more Li intercalated into the LNMO crystal during discharge, the electronic conductivity would have decreased. This severe drop would have resulted in electronic overpotential which likely limited the electrochemical capacity that was able to be discharged. The later P2D simulations section contains a more detailed discussion of the impacts of LNMO electronic conductivity.

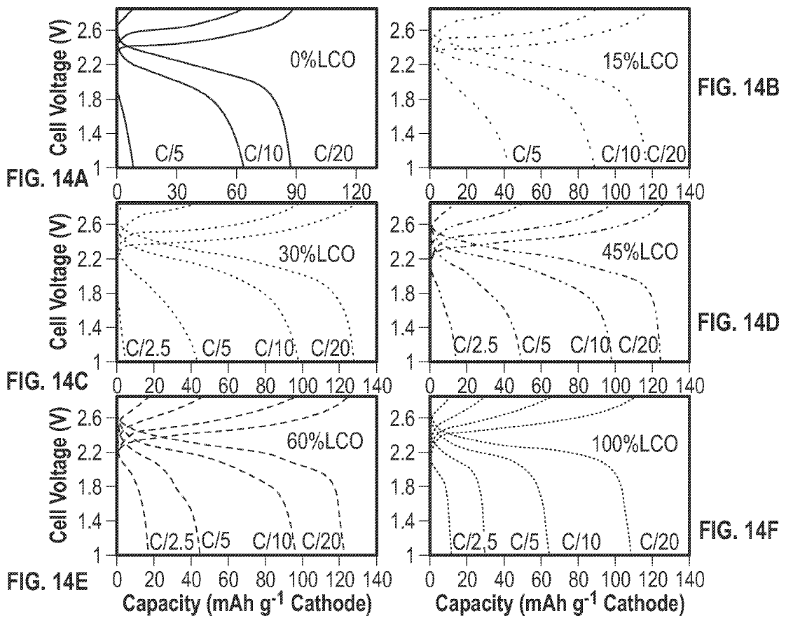

Although LNMO has lower electronic conductivity than LCO, at C/10 the sintered LNMO discharged 63 mAh g⁻¹, which was greater than the pure sintered LCO. This was likely due to a few of other contributing factors. First, as mentioned earlier it was suspected that LNMO has an increasing electronic conductivity with delithiation, and thus was able to extract that level of capacity at C/10 before reaching extents of lithiation during discharge where the electronic conductivity dropped and the resulting overpotential limited the ability to deliver additional capacity. Second, another factor beyond electronic conductivity was the potential of the electrochemical reactions for the different cathode materials (e.g., thermodynamic or OCV factors). LNMO had an overall lower OCV for electrochemical charge/oxidation compared to LCO. As an example, a large charging voltage plateau region for LCO was ˜0.14 V higher than that of LNMO. The lower charging potential for extracting lithium and capacity means that after reaching an equivalent charging capacity that LNMO has greater potential range remaining before hitting the cutoff voltage, where the cutoff was the same for all sintered electrode full cells. Thus, the relative thermodynamic driving force for extracting additional capacity on charge at greater charging extents was expected to be greater for LNMO relative to LCO. In addition, porosity of sintered LCO electrodes (˜0.33) was lower than that of LNMO electrode (˜0.41), likely due to morphology differences for the powders. Thus, the overpotential from ion transport was greater for the LCO electrodes relative to LNMO electrodes. Ion transport through the electrode microstructure has previously been demonstrated to be a major limiting factor for thick sintered electrodes, and the higher porosity for the LNMO would improve the relative ionic conductivity of these electrodes. At higher rates such as C/5 the sintered LMNO delivered very low capacity (6 mAh g⁻¹), suggesting the low electronic conductivity of LNMO (0% LCO) was too resistive at that rate to facilitate much of the electrode achieving high extents of lithiation. Voltage profiles and rate capability results starting from C/20 is shown in FIG. 15.

### 2.2.3 Blended LNMO/LCO Cell Electrochemical Evaluation

As the relative LCO content in the sintered electrodes increased, at the slow rate of C/80, the discharge capacity became closer to the composite electrode gravimetric limit/line. This outcome was attributed to the increasing electronic matrix conductivity expected as the LCO relative content was increased. As the relative LCO content was increased from 0% LCO to 15% LCO at the slow rate of C/80, the discharge capacity dramatically increased from ˜97 to ˜141 mAh g⁻¹ cathode, although the increase in capacity with further increases in LCO was minimal-the discharge capacity more or less was the same for the different blend compositions. At the higher rates, C/10 and C/5 in particular, the greatest discharge capacity was observed for the 45% LCO. This result was speculated to result from a combination of (i) reaching above a threshold LCO fraction for a well-connected LCO electronically conductive percolated network; (ii) still having significant LNMO content with its OCV function that had greater lower voltage capacity and resulted in greater driving force when approaching the higher voltage charging cutoff; and (iii) an intermediate porosity to the pure LCO and LNMO sintered electrodes to at least provide lower ionic overpotential relative to the pure LCO sintered electrodes. In summary, the combination of material (LCO) with relative higher electronic conductivity and lower gravimetric capacity with material (LNMO) with relative higher gravimetric capacity and porosity but lower electronic conductivity resulted in increased gravimetric discharge capacity than either of these materials used alone in sintered electrodes.

Closer inspection of the first discharge voltage profile at C/80 revealed that as the LCO content in the sintered electrodes increased, the average discharge voltage also increased. This was a consequence not only of the higher electronic conductivity of LCO compared to LNMO, but the intrinsic properties of the material with regards to the potentials at which the intercalation reactions occur. The relative impact of the voltage of the electrochemical reactions of the different materials can be further informed by examining the dQ/dV of the first discharge voltage profile at C/80. As mentioned previously, pure LNMO (0% LCO) had a very broad dQ/dV across the voltage range without a clear peak. However, even the 15% LCO sintered cathode had a clear dQ/dV peak assigned as arising from the LNMO component at 2.16 V (vs. LTO/anode). As the LCO content in the electrodes was increased from 15% LCO towards 100% LCO, the dQ/dV peak that was due to the LCO component (at 2.3 V) increased while the LNMO dQ/dV peak decreased, as would be expected for their changing relative compositions in the electrodes. However, the LNMO peak intensity change was not proportional to the LNMO content, in particular when comparing the dQ/dV peaks for 15% LCO and 30% LCO. This observation may have been due to the more limited improvement in matrix electronic conductivity at these extents of LCO loading, which then did not enable the LNMO to be fully accessible in the electrode for delivering capacity at these discharge rates.

### 2.2 P2D Simulations and Analysis

### 2.2.1 Pure LNMO Sintered Electrode Simulation

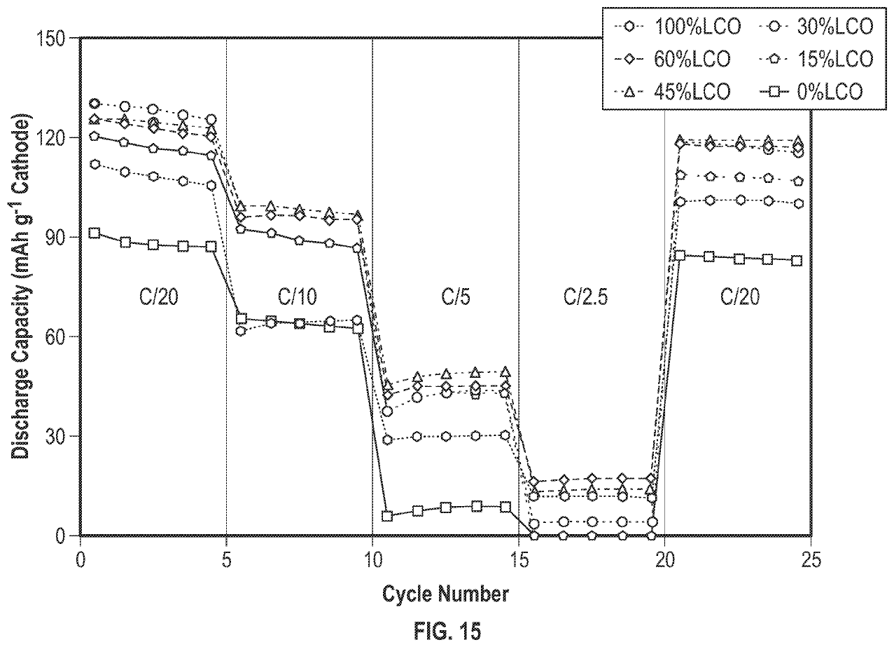

Representative simulation of the discharge of sintered cathodes relies on an accurate electronic conductivity as a function of lithiation for the active materials. The lack of LNMO electronic conductivity as a function of lithiation resulted in a poor match between the simulated and experimental voltage profiles. Using the measured value of 9.5×10⁻⁴ S m⁻¹ for as synthesized/fabricated LMNO pellets as a constant electronic conductivity in simulation, the predicted voltage curve at C/20 was not representative of the experimental curve, where the predicted capacity and average discharge voltage were only 18 mAh g⁻¹ cathode and 1.70 V, compared to the experimental measurements of 91 mAh g⁻¹ cathode and 2.15 V. Both LCO and LNMO have a similar layered oxide crystal structure. For LCO, upon delithiation the production of Co⁴⁺ and the shortened distance between Co—Co has been reported to result in high electronic conductivity. Although for LNMO the transition metals were Mn and Ni instead of Co, it was speculated that decreasing transition metal-transition metal distances would similarly increase the electronic conductivity of LNMO upon delithiation. The LNMO electronic conductivity at high levels of delithiation was assumed to have a plateau similar to LCO, and then taper down to the experimental value measured at full lithiation. The LNMO value for the plateau region (the “high” conductivity) was adjusted until the error relative to the discharge profile at C/20 was minimized. The corresponding fitted electronic conductivity was plotted and is shown in FIG. 16. The predicted capacity and average voltage for the fitted electronic conductivity profile were 93 mAh g⁻¹ cathode and 2.13 V, which had much improved agreement with the experimental values.

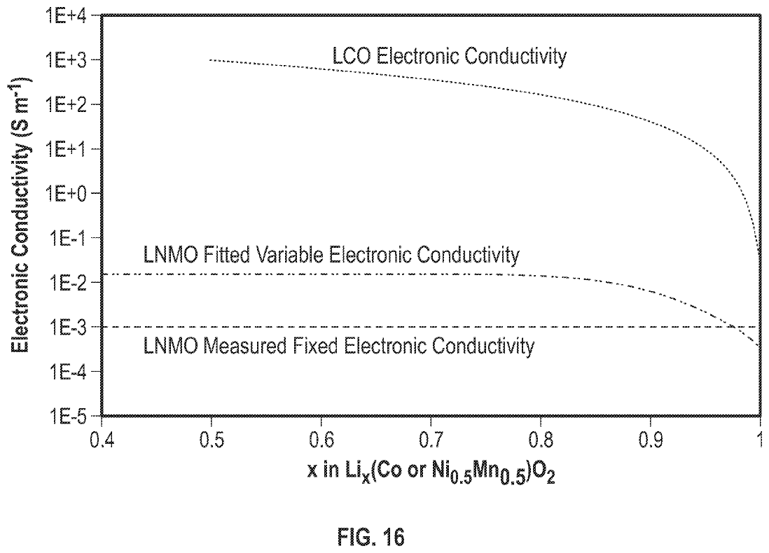

An overpotential distribution analysis throughout the discharge simulation was performed and a detailed introduction of the process associated with such analysis can be found in a previous report. In brief, the overpotentials associated with ionic resistance, electronic resistance, interfacial resistance, and OCV differences are calculated at different depths within the cell during the discharge simulation. These overpotentials are then weighted by the electrochemical current being produced at each location, and then they are summed up. Thus, at any given point in the discharge the relative overpotential for each of the resistances mentioned above for the cathode, anode, and separator were calculated. Such analysis provides insights into the factor(s) responsible for deviations between the discharge potential and the thermodynamic maximum potential for a given extent of discharge capacity delivered. In addition, the electrolyte and electrode concentration at selected discharged capacities is shown in FIG. 17.

Due to the limited electronic conductivity of the solid phase (smaller than ionic conductivity of electrolyte phase), the initial condition from discharge simulation included a more delithiated region near the current collector for the LNMO electrode (FIG. 17B). For the first 10 mAh g⁻¹ cathode discharged, due to a combination of the OCV difference across the cathode depth due to the lithiation distribution at the end of charge and the limited electronic conductivity, the intercalation was largely confined near the current collector in the LNMO (FIG. 17B). The OCV overpotential contribution was even negative due to the more lithiated LNMO near the current collector, and the low electronic conductivity drove the electronic overpotential to ˜0.08 V. As the discharge proceeded up to 79 mAh g-1 cathode, the intercalation preferentially still happened near the current collector side, which was due to the low matrix electronic conductivity arising from the LMNO material. The electronic overpotential reached a plateau of ˜0.11 V, which notably exceeded the other overpotential sources, including the sum of overpotentials from the separator and anode. The OCV overpotential reached a plateau of ˜−0.09 V and resulted from the material being more lithiated near the current collector side first during discharge, due to the low electronic conductivity of the LNMO material. For the rest of the discharge process (to 93 mAh g⁻¹ cathode), very little lithiation occurred in the LNMO near the current collector due to the limited capacity still available in this region, which then resulted in more lithiation occurring near the separator. The current had to travel via the electroactive material before reaching the lithiation region near the separator and the electronic conductivity near the current collector had significantly decreased due to that material being near the full lithiation state. These two effects combined to result in the electronic overpotential significantly increasing. In summary, the following processes result in the LNMO cathode full cells having relatively low discharge capacity: (i) the low electronic conductivity drove intercalation/lithiation early in the discharge near the current collector region in the cathode; (ii) once the current collector side reached near its capacity limit, more and more current had to pass through this region which had very low electronic conductivity (due to decreasing electronic conductivity with increasing lithiation); and (iii) the electronic overpotential then severely increased, causing the cell voltage to plummet and reach the lower voltage cutoff.

### 2.2.2 45% LCO Sintered Electrode Simulation

For the 45% LCO sintered electrode, it was assumed that 1) the LCO was at sufficient volume fraction to form a percolated network, and 2) the LCO electronic conductivity as a function of lithiation was the same as for pure LCO. Note that the matrix electronic conductivity effectively followed the LCO material conductivity because the electronic resistance was so much lower relative to the LNMO material. It is noted that the second assumption would require minimal incorporation of the Ni or Mn into the LCO material in the electrode, which was consistent with the XRD results. The simulated discharge voltage profile at C/20 matched with the experiment well, except that at later points in the discharge (over 80 mAh g⁻¹ cathode) the simulated voltage was slightly higher. Such deviation was possibly due to (i) inhomogeneous distribution of LCO in the electrode; (ii) the electronic conductivity enhancement from LCO was not effective because further in the discharge the LCO was at near full lithiation state with relatively low electronic conductivity (will be elaborated later); and (iii) the co-diffusion of Mn, Ni, and Co from mild sintering was not detected in the bulk but still sufficiently reduced the electronic conductivity of the percolated LCO network relative to pure LCO.

The electrochemical potential of the electrode materials provides the driving force for the electrochemical reactions to occur. This can be analyzed in the context of the OCV of the materials in the electrode, which varies as a function of charge/discharge time and location as the reactions proceed. LCO had ˜90% of its capacity above ˜3.8 V (versus Li/Li⁺), where LNMO had only ˜56% of its capacity above this voltage. Before moving to the same analysis as the one done to the pure LNMO cell, a capacity contribution separately from each material (LNMO and LCO) was extracted from the simulation. For the first ˜30 mAh g⁻¹ cathode capacity delivered, both LCO and LNMO contributed roughly similar capacity, which could be attributed to the initially sloped OCV functions for both materials. From ˜30 until ˜60 mAh g⁻¹ cathode capacity delivered, the LCO started to contribute more capacity because it had much more capacity at ˜2.3 V (cell voltage, corresponding to the LCO voltage plateau at ˜3.9 V vs. Li/Li⁺). From ˜60 until ˜115 mAh g⁻¹ cathode capacity delivered, the LNMO replaced LCO as the major capacity contributor due to its voltage plateau at ˜2.1 V (cell voltage, corresponding to the LNMO voltage plateau at ˜3.7 V vs. Li/Li⁺). For the final portion of delivered capacity until the end of discharge, both LCO and LNMO approximately equally contributed capacity, due to the sloped OCV function and similar to the early portion of the discharge capacity.

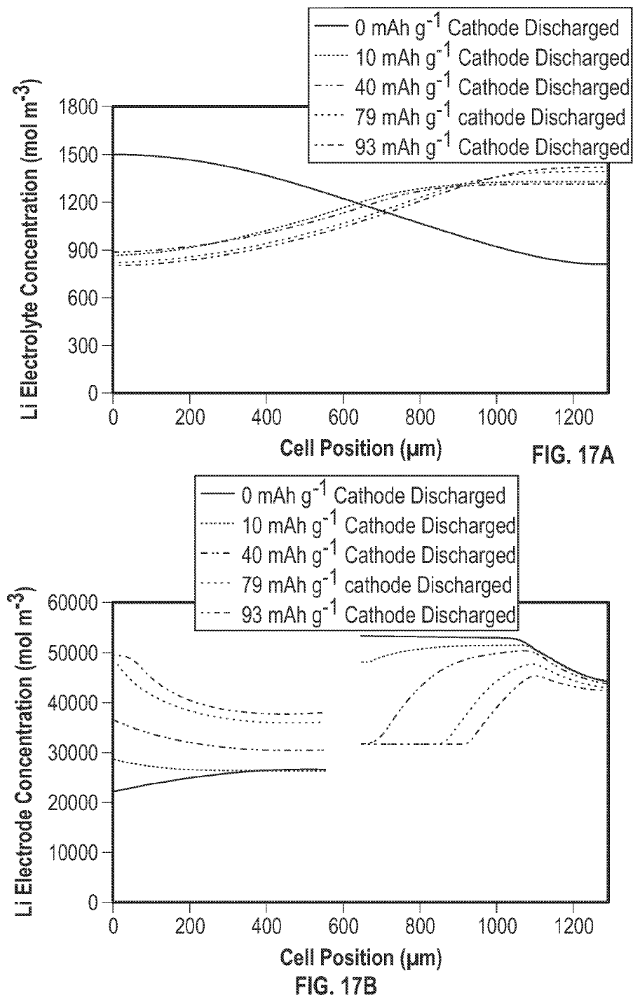

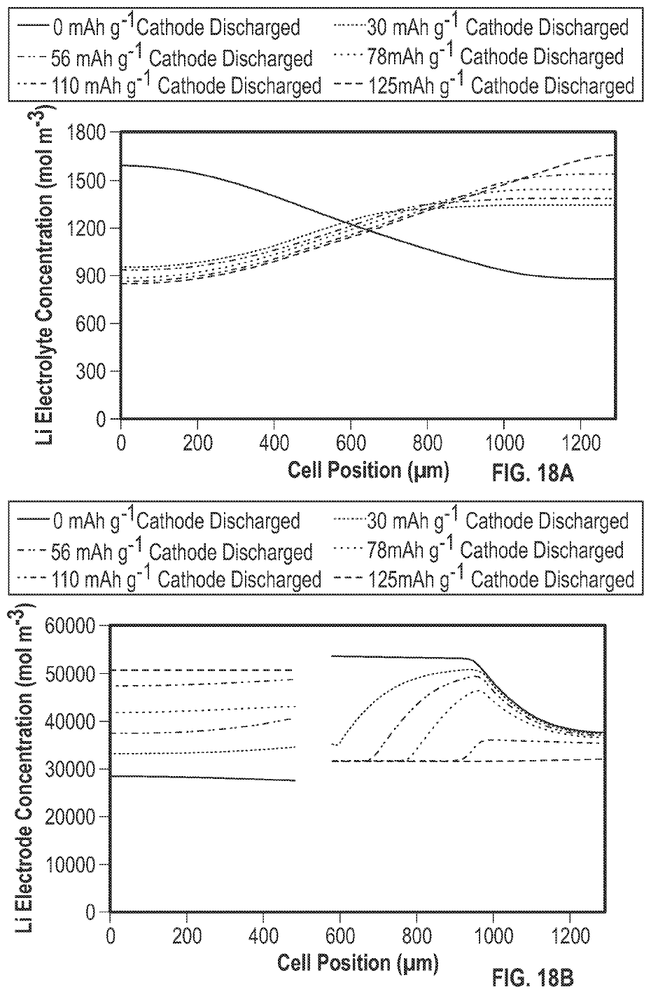

The same overpotential distribution analysis as was conducted for the LNMO sintered electrode cell was performed for the cell with the 45% LCO cathode. The Li concentration in the electrode for the solid (averaged based on the wt % of LNMO and LCO) and electrolyte phase can be found in FIG. 18. The change in Li electrode concentration of each of LNMO and LCO at selected delivered capacity points is shown in FIG. 19. For the first 30 mAh g⁻¹ cathode capacity delivered, both LCO and LNMO had slightly more Li intercalated near the separator region. This was in contrast to the pure LNMO case where the initial intercalation was near the current collector and was due to the relatively higher electronic conductivity of the blended material solid electrode compared to the ionic conductivity of the electrolyte. The interfacial overpotential from LNMO was slightly greater than that of the LCO, which originated from the smaller interfacial area of LNMO and smaller reaction rate constant used in the simulation. From 30 until 56 mAh g⁻¹ cathode capacity delivered, the LCO interfacial overpotential increased but that of LNMO decreased, which was because the LCO was in its voltage plateau regions and thus less capacity was provided by LNMO in this region. Correspondingly, much more Li was intercalated into LCO and also more Li was intercalated near the separator region. From 56 until 78 mAh g⁻¹ cathode capacity delivered, the capacity from LCO voltage plateau was nearly depleted. A large amount of Li intercalated into the LCO, but this capacity was concentrated in the current collector region. Such observation was consistent with previous thick sintered electrode reports, where an electrode with a flat OCV curve and relatively higher electronic conductivity (relative to ionic conductivity) resulted in a reaction front which initiated from the separator and propagated towards the current collector. Correspondingly, the ionic overpotential rose and fell depending on whether it was further from or closer to the separator, respectively. From 78 to 110 mAh g⁻¹ cathode capacity delivered, the LNMO interfacial overpotential increased but that of LCO decreased, which was because the LNMO started delivering a larger fraction of the capacity due to now being in the LNMO voltage plateau region. In examining the change in Li electrode concentration, the LNMO accepted more Li, but the reaction was not as concentrated as LCO at the separator side. Such behavior may have resulted due to (i) the electrode electronic conductivity was not as high as when LCO was being discharged because the LCO network was now at a much higher extent of lithiation and correspondingly lower electronic conductivity; (ii) LNMO had slightly smaller reaction rate constant and interfacial area than that of LCO; and (iii) LNMO OCV compared to LCO was more sloped, and flatter OCV profiles promote sharper reaction propagation gradients.

From 110 mAh g⁻¹ cathode capacity delivered until the end of discharge, a reaction front in the LNMO similar to that observed for LCO earlier was observed. There was also a similar peak that occurred with regards to the ionic overpotential, and more Li was intercalated into the LNMO at the current collector side. Note that the electronic overpotential throughout the discharge was dramatically suppressed from the electronic conductivity enhancement of the blended LCO. The electronic overpotential started to increase at ˜120 mAh g⁻¹ cathode capacity due to the decreasing electronic conductivity of LCO phase. Such decrease in electronic conductivity of LCO led to a decreased voltage, and the resulting voltage was lower than observed experimentally suggesting that the electronic conductivity in the simulation may have been underestimated at high extents of lithiation for the LCO.

### Model Description

The model used to generate data in Example 2 is 1-D implicit numerical, The following are the governing equations used this work:

For pure LNMO cell:

### Electrolyte Concentration:

$${ϵ}_{E} \frac{\partial {c}_{E}}{\partial t} = \frac{\partial }{\partial x} ( {D}_{eff} ( {c}_{E} ) \frac{\partial {c}_{E}}{\partial x} ) + {A}_{LNMO} {j}_{LNMO} ( 1 - {t}_{+}^{0} )$$

### Electrode Potential:

$$\frac{\partial {ϕ}_{1}}{\partial x} = \frac{- {i}_{1}}{{σ}_{eff} ( {c}_{LNMO} )}$$

### Electrolyte Potential:

$$\frac{\partial {ϕ}_{2}}{\partial x} = - \frac{{i}_{2}}{{κ}_{eff} ( c )} + \frac{2 R T}{F} ( 1 + \frac{\partial ln {f}_{\pm } ( {c}_{E} )}{\partial ln {c}_{E}} ) ( 1 - {t}_{+}^{0} ) \frac{\partial ln {c}_{E}}{\partial x}$$

### Lithium Flux Kinetics:

$${j}_{L N M O} = - 2 {k}_{L N M O} {{c}_{E}^{0.5} ( {c}_{L N M O}^{surface} )}^{0.5} {( {c}_{L N M O}^{surface} - {c}_{LNMO , max}^{surface} )}^{0.5} Sinh ( \frac{F}{R T} ( {ϕ}_{1} - {ϕ}_{2} - {U}_{L N M O} ) )$$

Lithium Flux across Electrode & Electrolyte Interface:

$${j}_{L N M O} = - {D}_{L N M O} = \frac{\partial {c}_{LMNO}^{surface}}{\partial r}$$

### Electrolyte Current:

$${A}_{L N M O} {j}_{L N M O} = - \frac{1}{F} \frac{\partial {i}_{2}}{\partial x}$$

### Conservation of Current:

$$I = {i}_{1} + {i}_{2}$$

### Volumetric Surface Area:

$${A}_{L N M O} = \frac{3}{{R}_{L N M O}} {ϵ}_{L N M O}$$

### Electrode Particle Concentration:

$$\frac{\partial {c}_{LMNO}}{\partial t} = {D}_{L N M O} ( \frac{1}{{r}^{2}} \frac{\partial }{\partial r} ( {r}^{2} \frac{\partial {c}_{LMNO}}{\partial r} ) )$$

### Effective Ionic Conductivity and Diffusivity:

$$\frac{{κ}_{eff} ( {c}_{E} )}{κ ( {c}_{E} )} = \frac{{D}_{eff} ( {c}_{E} )}{D ( {c}_{E} )} = {ϵ}_{E}^{α}$$

### Effective Electronic Conductivity:

$${σ}_{eff} ( {C}_{LCO} , {C}_{LNMO} ) = {σ}_{LNMO} {∈}_{LNMO}^{α}$$

### For Blended 45% LCO Cathode Cell:

### Electrolyte Concentration:

$${ϵ}_{E} \frac{\partial {c}_{E}}{\partial t} = \frac{\partial }{\partial x} ( {D}_{eff} ( {c}_{E} ) \frac{\partial {c}_{E}}{\partial x} ) + ( {A}_{LCO} {j}_{LCO} + {A}_{L N M O} {j}_{L N M O} ) ( 1 - {t}_{+}^{0} )$$

### Electrode Potential:

$$\frac{\partial {ϕ}_{1}}{\partial x} = \frac{- {i}_{1}}{{σ}_{eff} ( {c}_{LCO} , {c}_{LNMO} )}$$

### Electrolyte Potential:

$$\frac{\partial {ϕ}_{2}}{\partial x} = \frac{{i}_{2}}{{κ}_{eff} ( c )} + \frac{2 RT}{F} ( 1 + \frac{\partial ln {f}_{\pm } ( {c}_{E} )}{\partial ln {c}_{E}} ) ( 1 - {t}_{+}^{0} ) \frac{\partial ln {c}_{E}}{\partial x}$$

### Lithium Flux Kinetics:

$${j}_{LCO} = - 2 {k}_{LCO} = {{c}_{E}^{0.5} ( {c}_{LCO}^{surface} )}^{0.5} {( {c}_{LCO}^{surface} - {c}_{LCO , max}^{surface} )}^{0.5} Sinh ( \frac{F}{RT} ( {ϕ}_{1} - {ϕ}_{2} - {U}_{LCO} ) )$$

$${j}_{LNMO} = - 2 {k}_{LNMO} {{c}_{E}^{0.5} ( {c}_{LNMO}^{surface} )}^{0.5} {( {c}_{LNMO}^{surface} - {c}_{LNMO , max}^{surface} )}^{0.5} Sinh ( \frac{F}{RT} ( {ϕ}_{1} - {ϕ}_{2} - {U}_{LNMO} ) )$$

Lithium Flux across Electrode & Electrolyte Interface:

$${j}_{LCO} = - {D}_{LCO} \frac{\partial {c}_{LCO}^{surface}}{\partial r}$$

$${j}_{LNMO} = - {D}_{LNMO} \frac{\partial {c}_{LNMO}^{surface}}{\partial r}$$

### Electrolyte Current:

$${A}_{LCO} {j}_{LCO} + {A}_{L N M O} {j}_{L N M O} = - \frac{1}{F} \frac{\partial {i}_{2}}{\partial x}$$

### Conservation of Current:

$$I = {i}_{1} + {i}_{2}$$

### Volumetric Surface Area:

$${A}_{L C O} = \frac{3}{{R}_{L C O}} {ϵ}_{L C O}$$

$${A}_{L N M O} = \frac{3}{{R}_{L N M O}} {ϵ}_{L N M O}$$

### Electrode Particle Concentration:

$$\frac{\partial {c}_{L C O}}{\partial t} = {D}_{L C O} ( \frac{1}{{r}^{2}} \frac{\partial }{\partial r} ( {r}^{2} \frac{\partial {c}_{L C O}}{\partial r} ) )$$

$$\frac{\partial {c}_{L N M O}}{\partial t} = {D}_{LNMO} ( \frac{1}{{r}^{2}} \frac{\partial }{\partial r} ( {r}^{2} \frac{\partial {c}_{L N M O}}{\partial r} ) )$$

### Effective Ionic Conductivity and Diffusivity:

$$\frac{{κ}_{eff} ( {c}_{E} )}{κ ( {c}_{E} )} = \frac{{D}_{eff} ( {c}_{E} )}{D ( {c}_{E} )} = {ϵ}_{E}^{α}$$

### Effective Electronic Conductivity (Perfect Percolation Assumed):

$${σ}_{eff} ( {c}_{LCO} , {c}_{L N M O} ) = {σ}_{L C O} {ϵ}_{L C O}^{α} + {σ}_{L N M O} {ϵ}_{L N M O}^{α}$$

List of Symbols

| | |
|---|---|
| Electronic Conductivity | □ |
| Ionic Conductivity | □ |
| Liquid Li⁺ Concentration | c_{E} |
| Solid Li⁺ Concentration in LCO | c_{LCO} |
| Solid Li⁺ Concentration in LNMO | c_{LNMO} |
| Solid Potential | □_{□} |
| Liquid Potential | □_{□} |
| Volume Fraction | □ |
| Li⁺ Intercalation | j |
| Open Circuit Potential | U |
| Discharge Current Density | I |
| Solid Phase Current Density | i₁ |
| Liquid Phase Current Density | i₂ |
| Volumetric Solid Particle Surface Area | A |
| LCO Solid Particle Radius | R_{LCO} |
| LNMO Solid Particle Radius | R_{LNMO} |
| Electrolyte Diffusivity | D |
| Solid State Diffusivity | Dₛ |
| Bruggeman Exponent | □ |
| Transference number | t₊⁰ |
| Faraday Constant | F |
| Temperature | T |
| Gas Constant | R |

TABLE 2
Cathode Parameters used in P2D simulations.

| Parameters | LiCoO₂ | LiNi_{0.5}Mn_{0.5}O₂ |
|---|---|---|
| Solid State Li⁺ Diffusivity (m² s⁻¹) | 3.5 × 10⁻¹³ [4] | 1 × 10⁻¹⁴ [5] |
| Active Material Radius (m) | 2.0 × 10⁻⁷, SEM | 2.3 × 10⁻⁷, SEM |
| Rate Constant (m^{2.5} mol^{-0.5} s⁻¹) | 3.1 × 10⁻¹³ [6] | 7.0 × 10⁻¹⁴ [7] |
| Crystal Density (g cm⁻³) | 5.0 [8] | 4.63 [9] |
| Electronic Conductivity (S m⁻¹) | 7000 × (1 − x)² + | 9.5 × 10⁻⁴, Measured |
| | 5 × (1 − x) + 0.054, | |
| | 0.5 ≤ x ≤ 1.0 | |
| | in LiₓCoO₂ [3, 10, 11] | |
| Modified Conductivity | | (1 + Tanh((0.88 − x) × 12))/ |
| (S m⁻¹) | | 130 − 0.0012 × x + 0.0011 + |
| | | (−1 + Tanh((0.94 − x) × 60))/ |
| | | 5000, |
| | | 0.4 ≤ x ≤ 1.0 |
| | | in LiₓNi_{0.5}Mn_{0.5}O₂, Fitted |
| Open Circuit | −Tanh(5.7(x − 0.555)) − | Tanh(−(x − 0.295) × 2.7) + 1 − |
| Voltage (V) | 1)/3.1 − (Exp(59(x − | Exp((x − 0.92) × 90)/1000 + |
| | 0.84) + 1)/4000 + | 3.685, |
| | Tanh(7(x − 0.76) − 1)/ | 0.4 ≤ x ≤ 1.0 |
| | 45 + Exp(−400(x − 0.5))/ | In LiₓNi_{0.5}Mn_{0.5}O₂, Fitted |
| | 40 + 3.88, | |
| | 0.5 ≤ x ≤ 1.0 | |
| | in LiₓCoO₂ | |

TABLE 3
Anode and other parameters used in P2D simulations.

| Electrolyte and Other Parameters | Value |
|---|---|
| Transference number, t₊⁰ | 0.415 [12] |
| Initial Concentration (mol m⁻³) | 1200, Experimental |
| $Thermodynamic Factor , ( 1 + \frac{\partial {lnf}_{\pm }}{\partial lnc} ) ( 1 - {t}_{+}^{0} )$ | 0.28687 c² + 0.74678 c + 0.44103 [13] |
| Conductivity (S m⁻¹) | 0.1297c³ + 2.51c^{1.5} + 3.329c [13] |
| Diffusivity (m² s⁻¹) | (−6.9444c² + 7.3611c + 2.65) × 10⁻¹⁰, c < 0.8, |
| | 6.4753 × Exp(−0.573c) × 10⁻¹⁰, c ≥ 0.8 [13] |
| Temperature (K) | 298.15, Room Temperature |
| Gas Constant (J K⁻¹ mol⁻¹) | 8.3145 |
| Faraday Constant (A s mol⁻¹) | 96485 |
| Separator Thickness (μm) | 100, Experimental |
| Separator Bruggeman Exponent | 5.1, Experimental |
| Separator Porosity | 0.78, Experimental |
| Anode Thickness (μm) | 710, Experimental |
| Anode Solid State Li⁺ Diffusivity (m² s⁻¹) | 2.0 × 10⁻¹² [14] |
| Anode Active Material Radius (m) | 1.7 × 10⁻⁷ [15] |
| Anode Porosity | 0.40, Experimental |
| Anode Bruggeman Exponent | 1.5 |
| Anode Rate Constant (m^{2.5} mol^{-0.5} s⁻¹) | 3.90 × 10⁻¹³ [16] |
| Anode Density (kg m⁻³) | 3480 [17] |
| Anode Capacity (mA h g⁻¹) | 175 [18] |
| Anode Variable conductivity (S m⁻¹) | 300(x + 10⁻⁶)^{0.38} × 5^{(y -1)}/Exp(4.37(y − 1)²⁰⁰), |
| | 0 ≤ y ≤ 1.0 in Li_{4+3y}Ti₅O₁₂ [19] |
| Anode Open Circuit Voltage (V, vs Li/Li⁺) | 0.21Exp(−116.96y) + 0.45Exp(−5000y) + |
| | 0.27706Exp(−1010.1y) + 1.56 − |
| | 0.001Exp(50(y − 0.87)), |
| | 0 ≤ y ≤ 1.0 in Li_{4+3y}Ti₅O₁₂ [3, 19] |

TABLE 4
Cathode Dimensions used in P2D simulation

| Parameters | 0% LCO | 45% LCO |
|---|---|---|
| Cathode Thickness (m) | 5.5 × 10⁻⁴, | 4.8 × 10⁻⁴, |
| | Measured | Measured |
| Bruggeman Exponent | 1.5 | 1.5 |
| LCO Volume Fraction | 0 | 0.27 |
| LNMO Volume Fraction | 0.59 | 0.36 |
| Electrolyte Volume Fraction | 0.41 | 0.37 |

### Example 3

### 1.1 Active Material Powder Synthesis

LiMn₂O₄ (LMO) active material powder was synthesized. 100 mM of sodium oxalate (Na₂C₂O₄, Fisher Chemical) and 10 mM of sodium citrate dihydrate

(Na₃C₆O₇H₅·2H₂O, Sigma-Aldrich), were dissolved into 400 mL of deionized (DI) water at the same time using a 1000 ml beaker. Within a separate 1000 ml beaker 100 mM of manganese sulfate monohydrate (MnC₂O₄·2H₂O, Fisher Chemical) was dissolved into 400 mL DI water. The two solutions were heated to 60° C. followed by pouring the manganese sulfate solution into the oxalate solution all at once. The reaction was allowed to proceed for 30 minutes at 60° C. and 300 RPM. The precipitate was then collected via vacuum filtration before rinsing with 1.6 L of DI water. The powder cake was dried at 80° C. overnight in air. The resulting precipitate MnC₂O₄·2H₂O was then mixed with Li₂CO₃ (Fisher Chemical) with a targeted molar ratio of Li:Mn of 1.05:2. The calcination temperature profile used was to ramp the temperature up to 900° C. at a rate of 1° C. min⁻¹, hold at 900° C. for 6 h, ramp the temperature down to 700° C. at 1° C. min⁻¹, hold at 700° C. for 10 h, and then ramp the temperature down to room temperature at a cooling rate of 1° C. min⁻¹.

For LiCoO₂ (LCO), the electroactive material was also synthesized from an oxalate precursor precipitate. 200 mM of each sodium oxalate and cobalt sulfate heptahydrate (CoSO₄·7H₂O, Acros Organics) were dissolved separately into 400 mL of deionized (DI) water in 2 beakers with volumes of 1000 mL. Both solutions were preheated to 60° C., followed by adding the cobalt sulfate solution into the oxalate solution all at once. The reaction solution was maintained at 60° C. and stirred at 300 RPM for the entire 30 minutes reaction duration. The solution containing the precipitates was then processed using vacuum filtration to collect the solid particles. After rinsing with 1.6 L of DI water, the powder cake was dried at 80° C. overnight in an air atmosphere. The resulting CoC₂O₄·2H₂O was blended with Li₂CO₃ (Fisher Chemical) at a targeted molar ratio of 1.05:1 Li:Co using a mortar and pestle by hand for 10 minutes. After the blended powder was transferred into the furnace (Carbolite CWF 1300), it was heated with a ramp rate of 1° C. min⁻¹ to 800° C. without a hold at the high temperature and allowed to cool down to room temperature without control over the cooling rate. The resulting LCO was then ball-milled (Fritsch Pulverisette 7 planetary ball miller) with 4.8 mm zirconia beads for 5 h and 300 RPM with a powder to bead mass ratio ˜1:5. Typical quantities loaded into the jar were ˜4 g of LCO and ˜20 g of beads (corresponding to 57 beads).

### 1.2 Active Material Powder Synthesis

Scanning electron micrographs (SEM) and energy dispersive X-ray spectroscopy (EDS) were conducted using a FEI Quantum 650. Primary particle sizes were measured for 20 particles in SEM images for both active material powder and sintered pellets to calculate the mean primary particles size. Pellets comprised of two layers (LCO and LMO) were mounted such that EDS analysis could be performed through the thickness dimension on the edge of the entire pellet. Powder x-ray diffraction (XRD) patterns were collected using a PANalytical X′pert ProMPD. Crystalline size and strain were calculated from Debye-Scherrer equation using the largest XRD peaks, and Williamson-Hall relations for strain were analyzed using the three largest XRD peaks.

### 1.3 Sintered Electrode Fabrication

1 g of each electrochemically active material powder (LMO or LCO) was mixed with 2 mL of 1 wt % polyvinyl butyral (PVB, Pfaltz & Bauer) in ethanol, separately, and the suspension was blended by hand with mortar and pestle until it appeared dry. All sintered electrodes were prepared with the PVB-coated active material powders.

For the Blend sintered cathode case, 0.116 g of PVB-coated LCO and 0.100 g of PVB-coated LMO were mixed with mortar and pestle by hand for 5 minutes. The masses were chosen to result in an approximately 50% by volume blend of the two materials (LCO crystal density is 5.0 g cm⁻³, while LMO crystal density is 4.3 g cm⁻³). The resulting blended powder was loaded into a circular pellet die (Carver) with an area of 1.33 cm² and pressed at 430 MPa for 2 mins with a hydraulic press (Carver). For both the CC:LMO:LCO and CC:LCO:LMO cases, 0.116 g of LCO was first loaded in to the pellet die with mild pressure by hand to flatten the powder surface, and then 0.1 g of LMO was loaded above the LCO powder before using the same pressure treatment with the hydraulic press as for all other samples. The pressed pellet was then transferred into the furnace with air atmosphere and heated at a ramp rate of 1° C. min⁻¹ to 600° C., held at 600° C. for 1 h, then cooled back to room temperature at a rate of 1° C. min⁻¹. After heating, pellet thicknesses were measured with calipers and varied between of 510-530 m, and the mass for all samples ranged between 0.204-0.209 g. The approximate geometric pore/void fraction was 34% for the total pellet thickness (it is noted that pellets pressed with only LMO or LCO powders and heated with the same furnace profile also had an approximate geometric pore/void volume of 34%). The 1.16 mass ratio resulted in the same total thickness for all pellets and the same thickness for the LCO and LMO individual layers for the two-layer cathodes. For pure LCO and LMO pellets, 0.2 g of coated powder was loaded into the pellet die and then followed the same procedure with regards to hydraulic compression and heat treatment. The final pure material pellets had porosity of ˜34%, mass of 0.197 g, and thicknesses of 470 μm and 540 μm, respectively. It is noted here that 600° C. was chosen as the processing temperature for the sintered cathodes in an effort to keep the temperature as low as possible to avoid any possible new material/composition interface formation. Temperatures of 400 and 500° C. were also attempted but resulted in fragile pellets which collapsed during handling.

For the anode, Li₄Ti₅O₁₂ (LTO, NEI corporation) was used as the electroactive material for all sintered electrode cells. 0.2 g of PVB-coated LTO was processed following the same procedure described for the cathode materials above, and the final pellets had thicknesses ranging from 700-720 μm and masses ranging from 0.194-0.199 g, with a geometric pore/void fraction of 40%.

### 1.4 Composite Electrode Fabrication

Cathode material powders (100% LCO, 100% LMO, or a mix of 54% LCO 46% LMO by mass) were mixed with polyvinyl pyrrolidone (PVP, Sigma Aldrich, 360 kDa molecular weight) dissolved in ethanol (Fisher) and acetylene carbon black (Alfa Aesar) with a mass ratio of 8:1:1 active material:PVP:carbon black. While PVP is not as commonly used as a Li-ion electrode binder, in this work PVP was used as the binder for a conductive layer adhered between the sintered electrodes and current collectors (described in the next paragraph). PVP was chosen as the binder because it enabled the use of ethanol as a solvent, which resulted in much faster drying and processing of the sintered electrode cells. PVP was then used for processing of composite electrodes to ensure consistency of the binder used across different cell systems. The components were combined via a slurry mixer (Thinky AR-100) at 2000 RPM for 4 minutes, followed by 5 minutes of sonication, and then 4 additional minutes in the slurry mixer at 2000 RPM. The slurry was coated onto an aluminum foil using a 400 μm gap doctor blade. The electrodes were dried in air for 0.5 h followed by vacuum drying at 50° C. for 1 h. Circular shaped 1.33 cm² cathode discs were punched out, with resulting loadings across all electrodes ranging between 1.4-4.5 mg cm⁻².

### 1.5 Cell Fabrication and Electrochemical Evaluation

For sintered electrode cells, to reduce interfacial resistance between the sintered pellet electrode and current collector, conductive carbon paste comprised of acetylene carbon black (Alfa Aesar) and PVP with a mass ratio of 1:1 in ethanol was used between the electrode and current collector (bottom plate for the cathode and metal disc spacer for the anode) of the 2032-type cell. The attached pellet sintered electrodes were dried at 50° C. for 1 hour under vacuum to drive off the ethanol. To assemble the coin cell, 1.2 M LiPF6 in 3:7 ethylene carbonate:ethyl methyl carbonate (Gotion) was used as the electrolyte and glass fiber (Fisher) was used as separator. The cell was cycled between 1.0 V to 2.8 V (cell voltage) with a multichannel battery cycler (MACCOR), where 142.5 mA g⁻¹ cathode electroactive material was assumed to be 1 C, and C rates were adjusted based on the actual mass of cathode material in the coin cell. For the sintered electrode full cells, 1 C would correspond to ˜21 mA cm⁻².

For composite electrode cells, Li foil and Celgard 2325 were used as anode and separator, and the same electrolyte was used as that in the sintered electrode cells. All composite cathode cells were cycled between 2.5 V to 4.3 V (versus Li/Li⁺) where 137, 148,and 142.5 mA g⁻¹ cathode material were assumed to be 1 C for 100% LCO, 100% LMO, or 54% LCO 46% LMO by mass, respectively.

It is noted here that for rate capability evaluation, sintered electrodes were in general cycled at lower C rates compared to composite electrodes. This was due to the major differences between the two types of electrodes with regards to electrode thickness and electroactive material loading. Even with the removal of inactive components from the electrode microstructure the sintered electrodes are much thicker, which limits higher C-rate cycling. Sintered electrodes also have approximately an order of magnitude greater areal loading of active material, which means the areal current densities are approximately and order of magnitude higher for the same C-rate.

### 1.6 P2D Simulation

For the two-layered sintered cathode simulations, the cathode was divided into 2 regions of LCO and LMO with equal thickness of 255 μm. The initial composition of the assembled cell electroactive materials was assumed to correspond to Li₄Ti₅O₁₂, LiMn₂O₄, and LiCoO₂ for the respective materials. The simulation then proceeded with charging the cell to 2.8 V at a current density that would correspond to C/50. This was the initial condition before simulating discharge at C/50. The end of discharge simulation at C/50 was then used as the initial condition for simulating the charge at C/20. Then the end of charge at C/20 was used as the initial condition for simulating the discharge at C/20. All physical properties of LCO, LMO, LTO, separator and electrolyte can be found in Supporting Information, Tables 5 and 6. As will be discussed in the following sections, the Blend electrode was not simulated. The voltage plateau below 3 V (versus Li/Li⁺) of LMO was also not considered in the simulation even though the voltage window used in simulation was 1.0 V to 2.8 V (cell, equivalent to 2.86 V-4.36 V versus Li/Li⁺).

### 2. Results and Discussions

### 2.1 Materials Characterization

For sintered electrodes, generally small (<1,000 nm) primary particles have been used in efforts to increase electrochemically active surface area and decrease solid-state transport resistances. Thus, for LCO the active material powder was ball-milled before pressing into a pellet and sintering. The ball-milled LCO powder had primary particle lengths of 220±70 nm, and after sintering the size was determined to be 240±90 nm (averages and standard deviations from measurements of 20 independent particles in the SEM images), suggesting the primary particle size was maintained after the thermal treatment. For LMO active material powder before sintering, the primary particle length was 780±170 nm, and after sintering the size was determined to be 760±190 nm, again suggesting the primary particle size was not impacted by the mild sintering process. Note that the after sintering primary particle measurements reported were for pure LCO or LMO particle contacts, and not for the Blend system.

When looking at the pellet before sintering, the XRD pattern reflected a blend of both LMO and LCO materials, with distinct peaks present for each material and consistent with previous reports. LMO had an Fd-3m spinel structure with a crystalline size of ˜50 nm and strain of 0.0027 determined from XRD analysis; LCO had a R-3m layered structure with a crystalline size of ˜72 nm and strain of 0.0016 determined from XRD analysis, and the peaks were consistent with contributions from each of these phases. Although the heat treatment was relatively mild (heated to 600° C. and held for 1 h), after heat treatment the LCO peaks shifted towards lower values, suggesting an increased lattice size for layered LCO, which could possibly be attributed to the substitution of Co (ionic radius of 56 pm) by Mn (ionic radius of 63 pm).

Similarly, all the LMO features shifted to increasing values, suggesting a decreased lattice size for spinel LMO, where Co may have been incorporated into the LMO lattice as well. In addition, an impurity peak was observed at 31.2° C., which was attributed to the formation of Co₃O₄ phase. One possible cause of the impurity in the Blend pellet could be diffusion of Li⁺ from the LCO to the LMO during the heat treatment process, resulting in loss of Li from the LCO and formation of the Co₃O₄ impurity. The results of the XRD analysis suggested that a large fraction of the electroactive material had undergone significant modifications of its material properties for the Blend pellet, and that new phases and interfaces likely resulted.

Such interface has not been observed after the heat treatment of LCO without LMO directly in contact with the LCO and was not observed for the LCO layer for the two-layer pellet. Heat treated pure LMO had a crystalline size of ˜57 nm and strain of 0.0013 determined from XRD analysis. These results suggest that there was not an obvious change in crystalline size, but there was a reduction in strain. The heat treated pure LCO had a crystalline size of ˜49 nm and strain of 0.0013 determined from XRD analysis. Both the crystalline size and strain were decreased for the heat treatment of the LCO powder.

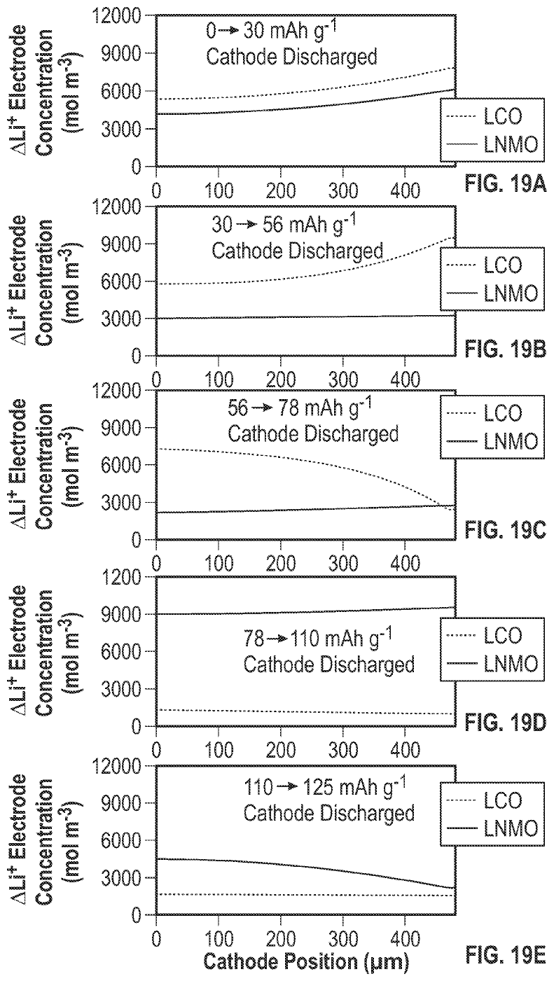

To further investigate LCO-LMO contact regions after the thermal treatment, SEM and EDS analysis was conducted at the interface region of the two-layered LCO-LMO pellet (FIG. 20). An EDS map of the edge of the two-layer LCO-LMO pellet (FIG. 20C, 20D) confirmed the presence of a Mn-rich region (LMO) and Co-rich region (LCO). There was a clear area in the SEM (FIG. 20B) where there was a gradient in Co and Mn composition. This layer was ˜5 μm thick (according to the line scan on the pellet edge in FIG. 20A), or about ˜1% of the total electrode thickness. Given that the total cathode thickness was over 500 μm, the interface was not expected to have much impact the total electrochemical capacity available within the individual LMO and LCO electrode regions. However, the thickness of the interface region was much greater than individual primary particle sizes for either LMO or LCO. Coupled with the XRD results discussed earlier, this suggested that a significant portion of the Blend pellet had co-diffusion of Co and Mn.

### 2.2. Electrochemical Characterization

### 2.2.1 Single Material Cathodes

Before examining the electrochemical properties of multi-material cathodes, single material cathodes of only LMO and LCO in both conventional composite half cells and sintered full cells were investigated. For LCO in a composite half cell paired with Li metal and cycled between 2.5 and 4.3 V (vs. Li/Li⁺), the material achieved 131 mAh g⁻¹ LCO for the first C/20 discharge cycle after a C/20 charge cycle. It is noted that 86% of the discharge capacity was above 3.8 V. After the same heat treatment was applied to LCO powder as was used for sintering of LCO sintered electrode pellets, the LCO capacity was observed to increase to ˜140 mAh g⁻¹ LCO for the first C/20 discharge cycle and had a slight increase in initial cycle coulombic efficiency. The rate capability was also improved after heat treatment. The origin of this moderate improvement in electrochemical properties with heat treatment was not investigated further, but may have been due to slight improvements in cation ordering or defect density with the mild heat treatment.

For the LCO processed into a sintered electrode and paired with a sintered LTO anode, the cell achieved 144 mAh g⁻¹ LCO for the first C/50 discharge cycle after a C/50 charge cycle. A lower rate was used for the sintered electrode cell to minimize impacts of ion transport resistance during initial cell cycling, and the voltage window was 1.0 to 2.8 V (cell). The voltage plateau was distinct and its voltage (2.31 V versus LTO, assuming 1.56 V versus Li/Li⁺, roughly 3.87 V versus Li/Li⁺) was close to that in a composite half cell (˜3.9 V versus Li/Li⁺), suggesting that the single LCO sintered cathode did not have high electronic polarization even in the absence of conductive additives, consistent with previous results. The extra 7 mAh g-1 LCO in the sintered electrode compared to the composite electrode could possibly originate from a higher relative charge voltage window for the sintered electrode, and/or possibly more irreversible capacity loss in the composite electrode due to slightly higher electroactive area per mass particles. At C/20, C/10, and C/5, the sintered LCO cell reached 124 mAh g⁻¹ LCO, 83 mAh g⁻¹ LCO, and 39 mAh g⁻¹ LCO, respectively.

LMO in a composite half cell was paired with Li metal and cycled between 2.5 and 4.3 V (vs. Li/Li⁺) at a charge and discharge rate of C/20. The electroactive material achieved a discharge capacity of 120 mAh g⁻¹ LMO at 3.5 V (before overlithiating beyond lithium extracted during charge into Li₁₊ₓMn₂O₄ phase), and 184 mAh g⁻¹ LMO at the end of first C/20 discharge. Three distinct voltage plateaus were observed at ˜4.1 V (transition between λ-MnO₂ and Li_{0.5}Mn₂O₄), ˜4.0 V (transition between Li_{0.5}Mn₂O₄ and LiMn₂O₄), and ˜2.8 V (transition between LiMn₂O₄ and Li₂Mn₂O₄), consistent with previous reports for a LMO spinel electrode material paired with Li metal. After the same heat treatment was applied to LMO powder as was used for sintering of LMO sintered electrode pellets, the LMO capacity was not noticeably impacted across all cycles and rates relative to the material that did not undergo the additional heat treatment. All LMO composite electrodes also had severe capacity fade especially at the first three slow charge/discharge cycles due to the Jahn-Teller distortion upon overlithiation when the lower voltage cutoff of 2.5 V was used. When the voltage window was restricted to 3.0 V and 4.3 V, initial discharge capacity was reduced, but the capacity fade was mitigated by avoiding LMO overlithiation.

However, when LMO was used as a sintered electrode paired with sintered LTO and charged and discharged at C/50, the initial C/50 discharge capacity only achieved 106 mAh g⁻¹ LMO. There was a flat voltage plateau at ˜2.45 V (which would correspond to ˜4.01 V in the Li half cell with the composite electrode assuming a flat LTO potential of 1.56 V), however, sintered LMO cathode cell had a significant slope to the polarization curve between ˜2.4 and ˜2.0 V, compared to a much flatter plateau at the corresponding ˜4.0 V region in the Li half cell with the composite electrode. This behavior has been previously reported for LMO sintered electrodes, and has been attributed to the limited electronic conductivity especially near full lithiation of the LMO material—note that LMO has been reported to be ˜4 orders of magnitude lower than LCO in electronic conductivity. The capacity from below 3 V for the composite LMO cell was not present at all in the corresponding regions for the sintered electrode cell, although for the sintered full cell system there was only as much Li⁺ available from the anode as was intercalated during charge, whereas with the Li metal anode there was an excess Li⁺ source available to provide the lower potential redox reaction. The sintered LMO electrode also had discharge capacity fade from 106 to 87 mAh g⁻¹ LMO even during the first three cycles at C/50 and down to ˜71 mAh g⁻¹ LMO in the final (15^{th}) cycle which also was at C/50. The capacity fade and limited rate capability of LMO in sintered electrode without conductive carbon was likely due to some combination of the limited electronic conductivity, Jahn-teller distortion, and Mn dissolution. The heat treatment during the sintering process not expected to negatively impact the electrochemical properties of the cathode based on the outcomes for similar processed material in composite electrodes. At C/20, the capacity was only 22 mAh g⁻¹ LMO, and there was almost no capacity at higher rates, which was attributed to the limited electronic conductivity of the material.

### 2.2.2 Blended Material Cathodes

For the blended cathode in a composite electrode, the discharge voltage profile had features from both LCO and LMO. The three plateaus from LMO (˜2.9 V, ˜4.0 V and ˜4.1V versus Li/Li⁺) and one plateau region from LCO (˜3.9 V versus Li/Li⁺) were distinct, suggesting that physical blending without sintering retained the electrochemical properties of both materials proportional to their loading. The rate capabilities also matched an average between the individual pure cathode material cells. Heat treatment of the individual LMO and LCO powders using the same heat treatment which was applied to during sintered electrode pellet processing and combined in a multicomponent electrode resulted in a combination of what was observed for the pure material electrodes that underwent identical processing. The blend of LCO and LMO powders which had undergone heat treatment had slightly higher discharge capacity at all rates, consistent with the higher capacity for the relative fraction of the LCO component and its electrochemical properties observed for the material in isolation.

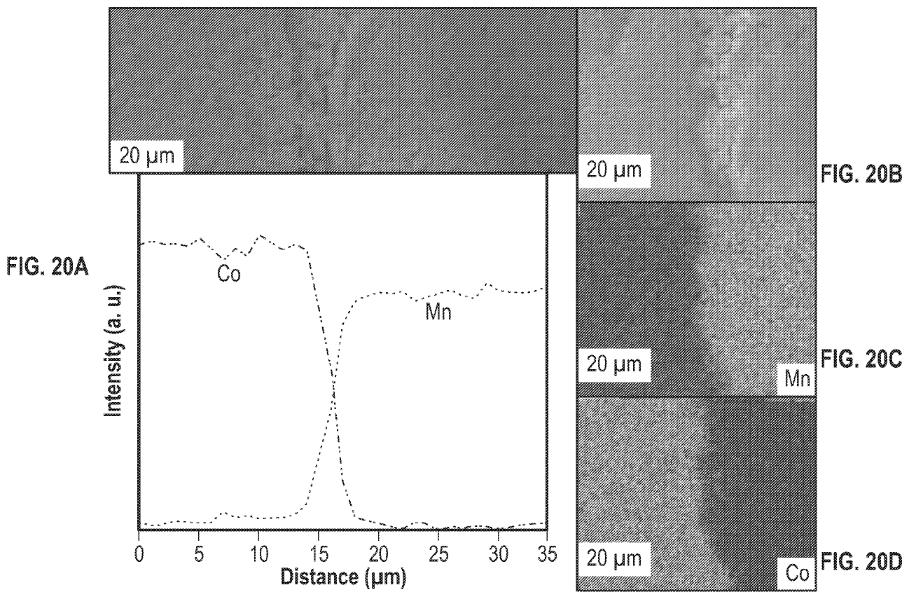

The hydraulically pressed and thermally treated Blend sintered electrode had very different electrochemical properties relative to the composite electrode. As shown in FIGS. 21A-21D, at the first C/50 discharge, the capacity only reached 42 mAh g⁻¹, which was much lower compared to the 132 mAh g⁻¹ for the physical blend in the composite half cell above 3 V. The capacity based on the relative loadings in the cathode of the Blend sintered cell was 125 mAh g⁻¹. The drastic capacity reduction was likely due to the interface formation from the heat treatment of these materials with dissimilar compositions and phases. Such observation had similarities to a previous study, where an interface formed between dissimilar composition and phase olivine Li_{1.4}Al_{0.4}Ge_{1.6}(PO₄)₃ and spinel LiMn_{1.5}Ni_{0.5}O₄ after thermal treatment when in direct contact with one another. In that previous work, an elemental gradient was observed across the interface and impurity GeO₂ phase formed, which resulted in very little electrochemical capacity being retained for the cathode material. The crystal structure and compositions in that prior study were very different from this present report, but the formation of a new interface material composition and its detrimental impact on electrochemical capacity were shared outcomes. The low electrochemical capacity and less knowledge of the impact of the new interface region on electrode physical parameters led us not to pursue detailed simulation analysis for the Blend case.

One additional item of note was that although the Blend sintered electrode had very low gravimetric capacity at slow rate, there was relatively high retention of that capacity at higher rates for a sintered electrode. One possible contributor to this outcome may have been the Co diffusion into the LMO lattice from the LCO, which could increase the electronic conductivity of the LMO. The higher conductivity LCO would also be expected to increase the electronic conductivity of the sintered electrode more generally, at least relative to LMO sintered electrodes.

### 2.2.3 Two-Layer Sintered Cathodes

For the sintered electrode cell with a two-layer cathode of CC:LMO:LCO (LMO in contact with the current collector side), for the first cycle at charge and discharge of C/50 the initial discharge capacity was 124 mAh g⁻¹ cathode (FIG. 21B). Using the composite electrode low rate initial discharge capacity and the weighted average of the electrode composition the projected capacity would be 131 mAh g⁻¹ cathode, and thus at low rate (C/50) the two-layered sintered electrode was close to extracting this projected capacity based on composite electrode cycling. At C/20 charge/discharge, a reduced capacity of 68 mAh g⁻¹ was achieved (FIG. 21C), and there was very little capacity at higher rates. On inspection of the first discharge cycle at C/50, a voltage plateau was observed between ˜2.15 V to ˜2.0 V, which could not be readily attributed to the individual LCO or LMO materials. As charge/discharge cycling continued, this plateau region included increased capacity between the voltage range of ˜2.2 V to ˜1.7 V. This discharge curve feature was attributed to the limited electronic conductivity of LMO layer, where electrons would need to traverse this resistive LMO layer and experience a large voltage drop when moving towards/away from the LCO layer. The increased resistance may have arisen from the degradation of LMO sintered electrode materials during cycling, which will be elaborated on in the later P2D simulation analysis.

For the CC:LCO:LMO (LCO in contact with the current collector side), for the first cycle at charge and discharge of C/50 the initial discharge capacity was 127 mAh g⁻¹ cathode (FIG. 21C). Unlike the CC:LMO:LCO case, there was a small amount of electrochemical capacity observed below 1.2 V. This capacity may have been from overlithiation of LMO to form the Li₁₊ₓMn₂O₄ tetragonal phase. A possible source for the Lit necessary for this low voltage capacity may have been structural instability of LCO. Although both two-layer electrodes were charged to 2.8 V, for CC:LCO:LMO more Lit was extracted from the LCO layer due to relatively lower electronic overpotential, which may have resulted in some irreversible structural collapse in the LCO layer. This structural collapse coupled with Li⁺ extraction may have resulted in some of the Li⁺ then inserting into the LMO during the lower voltage LMO process on discharge rather than the no longer available small amount of capacity in the LCO phase. At C/20 charge/discharge, a capacity of 101 mAh g⁻¹ cathode was reached, much larger than that of the CC:LMO:LCO. At C/10, 60 mAh g⁻¹ cathode was delivered in contrast with the minimal capacity for the CC:LMO:LCO. Unlike the CC:LMO:LCO case, the unexpected voltage plateau at ˜2 V was not observed. Degradation of LMO was not determined to have had as great of an impact on the voltage profile due to the relative position of LCO and LMO and their different electronic conductivities.

### 2.3. P2D Simulation Analysis

For sintered electrodes, the matrix electronic conductivity was provided by the electroactive material only, and the electronic conductivity of intercalation materials has been reported to be dependent upon the degree of lithiation. Accurate simulations using the P2D model thus required information on the electronic conductivity as a function of lithiation. For LCO sintered cathodes, the electronic conductivity as a function of degree of lithiation has been reported with relatively consistent values. However, for LMO, the electronic conductivity as a function of lithiation has been reported with conflicting trends. A trend of decreasing electronic conductivity with increasing extent of lithiation was found to be consistent with experimental observations for LMO sintered electrode materials. The general trend was that fully delithiated LMO has the highest electronic conductivity, with both voltage plateaus having a corresponding flat electronic conductivity, and LMO lithiated to Li₁Mn₂O₄ had the lowest electronic conductivity. Li₁₊ₓMn₂O₄ region was not considered due to lack of existing literature data and because the relevant capacity region was not significantly observed for sintered full cells. The electronic conductivity was thus aligned with the OCV of the LMO, or the different phases involved during LMO lithiation/delithiation: the two-phase reaction between spinel λ-MnO₂ (˜0.64 mS cm⁻¹) and spinel Li_{0.5}Mn₂O₄ (˜0.14 mS cm⁻¹) followed by a single-phase reaction proceeding to the LiMn₂O₄ (˜0.07 mS cm⁻¹). Another assumption for the P2D simulation of two-layer sintered electrodes was the treatment of the interface layer between the LMO and LCO. This was treated as a single discretized point between the LCO and LMO layers and was assumed to be electrochemically inactive and having the same electronic conductivity as the adjacent discretized point towards the current collector direction.

### 2.3.1 CC:LMO:LCO

For the CC:LMO:LCO two-layer electrode, at a discharge rate of C/50 the simulated and experimental profiles matched well for the first 90 mAh g⁻¹ cathode (FIG. 21A). However, the later stages of the discharge at C/50 had deviations between experiment and simulation, where the experimental discharge curve had an abrupt decrease in voltage and then a lower resulting final capacity (120 mAh g⁻¹ cathode experimental vs. 130 mAh g⁻¹ cathode simulated). At the higher rate of discharge of C/20, the experimental discharge curve deviated from the simulated outcome at the beginning of the discharge, where the experimental voltage was lower than the simulated at all extents of discharge and the resulting experimental capacity was only 68 mAh g⁻¹ cathode, while the simulated capacity reached 114 mAh g⁻¹ cathode.

To better assess the overpotentials during discharge for the two-layered CC:LMO:LCO sintered electrodes, a dQ/dV analysis was performed and can be found in FIG. 21B. The first experimental discharge cycle at C/50 and the corresponding simulation was represented by black solid and black dashed curves, respectively. An overpotential-free dQ/dV was calculated using the OCV functions (fitted from composite half cell paired with lithium foil anode) in Tables 5 and 6 assuming the same mass ratio used for the experimental sample (red dashed curve). The resulting curve was shifted lower by 1.56 V to reflect an ideal case where if the cell were discharged infinitely slow, then all overpotential sources would became zero and only dictated by the OCV functions of LMO and LCO.

Above 2.6 V (4.16 V vs Li/Li⁺) LMO would be expected to hardly provide any capacity based on low rate composite electrode dQ/dV profiles. In this voltage region, there was a small amount of capacity (˜10 mAh g⁻¹) that mostly should have been contributed by the LCO. The experimental dQ/dV plot had peaks in differential capacity that were shifted to a slightly lower voltage relative to the OCV dQ/dV, but the dQ/dV capacity peaks for the simulation were shifted to much lower voltages. This outcome suggested an underestimated electronic conductivity of LMO for the λ-MnO₂ phase, where the matrix electronic resistance of the LMO was expected to account for the lower peak positions in the dQ/dV experiments.

Even though the onset of the first experimental dQ/dV peak was at ˜2.6 V (vs. anode/LTO), similar to the OCV calculation, the magnitude (˜270 mAh g⁻¹ V⁻¹) and position (2.50 V) of this peak were much lower than the OCV calculation (˜1290 mAh g⁻¹ V⁻¹ and 2.57 V). The OCV dQ/dV LCO contribution above 2.45 V had differential capacity less than ˜100 mAh g⁻¹ V⁻¹. LMO provided almost all of its discharge capacity associated with its higher voltage plateau between ˜2.6 V and ˜2.5 V (from λ-MnO₂ to Li_{0.5}Mn₂O₄ reaction). This result suggested that the smaller observed experimental peak in this voltage region was indeed from the first higher voltage LMO reaction, but that it was delivered at a lower and more sloped voltage profile due to overpotential in the cell. A probable source of that overpotential would be the low electronic conductivity of the Li_{0.5}Mn₂O₄ phase. For the dQ/dV curve from the P2D simulation, the LMO started delivering capacity at 2.56 V, a lower voltage than observed experimentally. This result supported an underestimated electronic conductivity of the λ-MnO₂ phase because that capacity was delivered experimentally at a higher voltage than simulation.

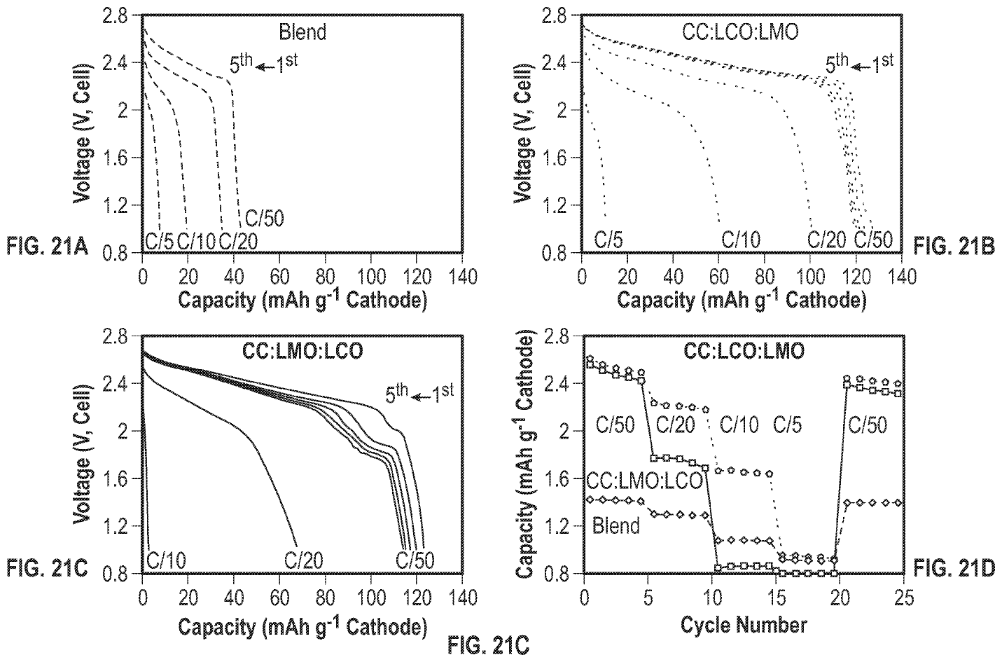

The second lower voltage discharge dQ/dV peak associated with the LMO material can be observed at 2.44 V (vs. anode/LTO) from the OCV calculation. The corresponding experimental differential capacity was a much broader peak of a smaller magnitude at 2.36 V, which initiated capacity at ˜2.40 V. The offset relative to the OCV dQ/dV peak location for the experimental lower voltage LMO peak compared to the higher voltage one was consistent with the Li₁Mn₂O₄ phase being even more resistive than Li_{0.5}Mn₂O₄ phase and causing increasing polarization as the discharge proceeded and more LiMn₂O₄ phase was formed. This outcome was also consistent with previous observations for sintered LMO electrodes. From the P2D simulation, the second lower voltage dQ/dV peak attributed to the LMO reaction occurred at 2.40 V and capacity initiated at ˜2.42 V (FIG. 22). These potentials were higher than the experimental results and suggested that the electronic conductivity used for the LiMn₂O₄ phase in the simulation may have been overestimated.

In the OCV calculation (FIG. 22), a peak attributed to the LCO phase was observed at 2.34 V. Experimentally, there was instead much broader dQ/dV peaks observed at two locations of 2.25 V and 2.00 V. The experimental peak at 2.25 V was attributed to the high overpotential from the low electronic conductivity in the LMO phase, which the electrons have to pass through before arriving to the LCO layer. The lower experimental dQ/dV peak at 2.00 V was not likely to be from overlithiation of LMO to the Li₁₊ₓMn₂O₄ phase because such capacity was not expected until below ˜1.3 V, and thus this capacity was also attributed to the LCO phase. It is speculated that the capacity at 2.00 V resulted from additional overpotential from a sudden drop in the electronic conductivity of the LMO phase. This may have been due to the Jahn-Teller effect from an induced tetragonal phase, which could be potentially more than one order of magnitude lower electronic conductivity than the spinel phase.

The P2D simulation used an electronic conductivity function that had a decrease near the state of full lithiation of LMO. This decrease in LMO electronic conductivity shifted the LCO capacity down and resulted in a dQ/dV peak at 2.14 V; however, a second lower dQ/dV peak such as that observed experimentally at 2.00 V was not observed in the simulation. To further explore the possibility of the LCO lithiation resulting in two dQ/dV peaks due to changes in LMO electronic conductivity, the discharge simulations were conducted again with an alternative function for LMO electronic conductivity. A change was made where the conductivity at near full lithiation of LMO was reduced to a much lower value of 0.012 mS cm⁻¹ (Table 5). With the modified electronic conductivity function for LMO, the simulated voltage had a plateau at 2.0 V, consistent with the experimental outcome. Although the simulation with the modified LMO electronic conductivity did not perfectly match the experimental discharge profile and dQ/dV, qualitatively the P2D simulation result supported a more dramatic and sudden drop in LMO electronic conductivity at nearly full lithiation during discharge.

The experimental lowest voltage dQ/dV peak provided further insights by monitoring its progression with continued cycling. With each cycle the capacity above ˜2.2 V decreased, and the capacity associated with the lowest voltage dQ/dV peak region increased and shifted to lower voltages with each cycle. Each successive discharge proceeded down to 1 V (˜2.65 V vs Li/Li⁺), which could have provided sufficient potential to convert some small amount of LMO to the tetragonal Li₂Mn₂O₄ phase (which would be expected at ˜1.2 V; e.g. ˜2.8 V vs Li/Li⁺). Formation of this phase would result in Mn valence closer to 3+, where the Jahn-Teller effect becomes more pronounced. Thus, the degradation of LMO would be consistent with even lower electronic conductivity from the LMO layer in the electrode, which would result in more and more capacity in the lowest dQ/dV peak region.

Although obtaining the most accurate electronic conductivity as a function of lithiation for LMO was a challenge, the lithium intercalation position during simulations was expected to be semi-quantitatively or at least qualitatively reflective of the experimental system, because a major determining factor of the electrochemical reaction was the OCV difference of the electroactive materials. FIG. 22C displays the P2D simulated capacity delivered as a function of the depth in the two-layer electrode during different amounts of total capacity delivered from discharge (e.g., as the discharge proceeded). The solid purple curve was when most (93%) of the LMO capacity had been delivered and was a total of 88 mAh g⁻¹ cathode. The other purple dashed lines represent 25%, 50%, and 75% of that 88 mAh g⁻¹ cathode capacity, or correspondingly that percentage progression of the LMO discharge process (though some LCO discharge occurs during this time as well). The green lines then represent 25%, 50%, 75%, and 100% of the remaining capacity delivered in the electrode from 88 mAh g⁻¹ cathode to 130 mAh g⁻¹ cathode, when nearly all the capacity came from the LCO layer. Thus, the discharge was split into the process with LMO discharge and without LMO discharge.

During the process with LMO discharge (FIG. 22C), during the first 25% of delivered capacity roughly the same capacity was delivered from the LCO and LMO layers. This was in part because the highest voltage capacity comes from the LCO phase until the LMO first plateau reaction can proceed. The LMO layer dominates the capacity delivered from the cell as the discharge proceeds through both LMO reaction plateau regions. The LMO layer capacity tended to be delivered first from the current collector region and then propagate towards the separator. This outcome reflected the low electronic conductivity of the LMO, where the most favorable overpotential was generally closer to the current collector. There are two “waves” of the LMO reaction being selectively near the current collector at 25% and 75% of the purple region, where at 50% the separator region caught up due to the more favorable OCV of the higher voltage plateau reaction proceeding nearer the separator region and driving the capacity to catch up near the separator. At the end of the LMO discharge process (purple), the LMO layer had delivered ˜120 mAh g⁻¹ while the LCO layer had only delivered about one third of its capacity. The LCO lithiation profile was more uniform and gradual throughout the LCO layer depth. This more uniform lithiation in the LCO layer was due to the more sloped OCV as a function of lithiation for LCO relative to LMO, where if a region had favorable overpotential and started to react more the OCV driving force of the less reacted LCO regions tended to flatten out the capacity delivered as a function of depth. This capacity delivered as a function of depth from the LCO remained relatively uniform even when the capacity was delivered without LMO, although during this part of the discharge process the overpotential of the capacity delivered from the LCO region was very high due to the low electronic conductivity of the nearly fully lithiated LMO phase that the electrons have to traverse before arriving at the LCO layer.

### 2.3.2 CC:LCO:LMO

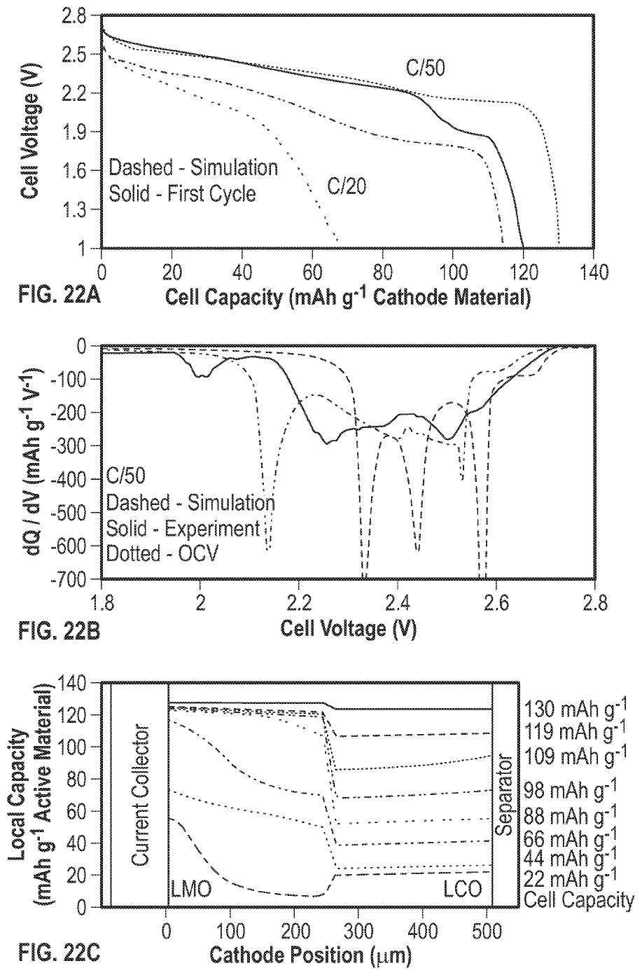

For the CC:LCO:LMO two-layer electrode, at C/50 discharge rate, the simulated and experimental profiles matched well for the first 115 mAh g⁻¹ cathode (FIG. 23A), but the final predicted capacity was slightly greater than that of the experiment (127 mAh g⁻¹ cathode experimental vs. 130 mAh g⁻¹ cathode simulated). At the higher rate of discharge of C/20, the experimental discharge curve deviated from the simulated outcome at the beginning of the discharge, but the deviation compared to the CC:LMO:LCO case was much smaller. The final experimental capacity was 101 mAh g⁻¹ cathode, and the simulated capacity was 130 mAh g⁻¹ cathode. At such low rate and with the more resistive LMO layer no longer between LCO and the current collector, for the simulation the discharge capacity was nearly the same for C/50 and C/20 (with less than 1 mAh g⁻¹ cathode decrease at C/20), although the voltage was slightly lower.

dQ/dV analysis was also performed for the CC:LMO:LCO two-layer electrode and can be found in FIG. 23B. The first experimental discharge cycle at C/50 and the corresponding simulation was represented by black solid and dashed curves, respectively. An identical overpotential-free calculated dQ/dV curve was used as discussed for the previous two-layer case since this curve was independent of the relative position of the LMO and LCO and only reflected the thermodynamic potentials of two materials.

Above 2.6 V, the experimental dQ/dV curve resembled the OCV dQ/dV curve. The experimental would be expected to have slightly lower voltages because even if the LCO had minimal electronic resistance, the cell voltage should be smaller due to the overpotentials from the ionic resistance of the cathode and overpotentials contributed from anode. It was speculated that this relatively high voltage discharge capacity resulted as a consequence of the LCO in the sintered electrode being charged to 2.8 V (˜4.36 V vs Li/Li⁺), because the OCV function did not access above 4.3 V vs Li/Li⁺ and thus did not have capacity at as high of a potential as the sintered electrode cell likely experienced experimentally. This speculation was also consistent with the observation of a small amount of capacity below 1.2 V, where LCO may have underwent mild irreversible structural collapse at the higher potential the sintered cathode was subjected to relative to the composite cathodes.

The first experimental dQ/dV peak was at 2.52 V, which was lower than the OCV calculation (2.57 V) and the discrepancy was attributed to the electronically resistive Li_{0.5}Mn₂O₄ phase. The first experimental dQ/dV peak position was slightly higher than that of experimental dQ/dV of the CC:LMO:LCO case (2.50 V), which possibly originated from the reduced ionic overpotential from a reduced ionic path with LMO being next to separator. The corresponding P2D simulated dQ/dV peak had a much greater peak magnitude but initiated later than the first experimental dQ/dV peak, suggesting an underestimated electronic conductivity of λ-MnO₂ phase and overestimated electronic conductivity from Li_{0.5}Mn₂O₄ phase, which was consistent with the trend observed from the CC:LMO:LCO simulation.

The second experimental dQ/dV peak had an onset at ˜2.45 V, but a peak position was difficult to define and was possibly overlapped with capacity contributed from LCO at lower voltage, and the capacity was delivered at a much lower voltage than the OCV calculation (2.44 V). This observation was consistent with the CC:LMO:LCO case and a previous sintered LMO report where the Li₁Mn₂O₄ phase was suggested to be even more electronically resistive than the values in the electronic conductivity function. The P2D simulated dQ/dV had much greater capacity and more pronounced peak in this voltage region compared to experiment, suggesting an overestimated Li₁Mn₂O₄ phase electronic conductivity in simulations consistent with the CC:LMO:LCO observations.

The experimental LCO peak was assigned at 2.29 V, which had a much greater magnitude, sharper profile, and closer agreement with the corresponding voltage from the OCV calculation (2.34 V) than for the CC:LMO:LCO case. This result suggested the electronic conductivity overpotential contributing to the location of this peak was much smaller, as expected due to the absence of an LMO layer in between the LCO and current collector. The simulated dQ/dV peak position matched the experimental well, suggesting that the LCO electronic conductivity used in the simulation was a more accurate reflection of the LCO material within the cell.

Examining the progression of the first five discharge experimental dQ/dV curves, the peak at below 2.2 V was not observed for the case where LCO was the layer in contact with the current collector. The LMO did still undergo some mild capacity fade, which may have been due to factors such as Mn dissolution or Jahn-Teller distortion. For LCO, from the first cycle until the fifth one, the peak shifted from 2.30 V to 2.29 V, the intensity decreased from ˜480 mAh g⁻¹ V⁻¹ to ˜380 mAh g⁻¹ V⁻¹, and the peak became broader. Such capacity fading was consistent with previous reports for structural collapse of the LCO due to overcharge, which could have resulted due to the relatively high potential experienced by the cathodes in the sintered electrode cell.

Analysis of lithium intercalation as a function of cell depth was also extracted from simulations of the CC:LCO:LMO case and can be found in FIG. 23C. The solid purple curve corresponded to when most (˜94%) of the LMO capacity had been delivered and was a total of 118 mAh g⁻¹ cathode. Compared to the CC:LMO:LCO case, 30 mAh g⁻¹ cathode more capacity was discharged, primarily from the LCO layer, due to the absence of electronically resistive LMO layer between the LCO and current collector. Similar to the CC:LMO:LCO case, the LMO had two waves of lithiation/capacity that propagated from the region closest to the current collector towards the region closest to the separator and corresponded to when capacity was extracted from the two different voltage plateaus of the LMO phase. Also consistent with the previous case, the LCO lithiation/capacity was fairly uniform as a function of depth within the LCO layer during all the capacity delivered regions during discharge.

### 2.4. Multicomponent Material Sintered Electrode Considerations

While homogeneously blended composite electrodes with multiple different electroactive material compositions/phases have been reported with beneficial properties, sintered electrodes can be more challenging to implement with multiple compositions and phases. As demonstrated in this study, differences in phase and/or concentration can lead to formation of new interfacial regions. In some cases, such a region could be beneficial if, for example, a third phase with higher electronic conductivity was formed and the electrochemical capacity and OCV of the constituent desired phases was not dramatically impacted. However, in this study and in other cases interfacial regions tend to result in increased resistances and/or loss of electrochemical capacity.

Composite electrodes with layers of different materials/particle sizes/phases have been reported to result in improved rate capability. For sintered electrodes with multiple active materials in a multiple layer architecture, there are potential benefits originating from the spatial arrangement of materials with different potentials associated with their electrochemical reactions and electronic conductivities. From an electronic conductivity perspective, a layer with relatively high electronic conductivity next to the current collector does not limit the rate capability (e.g., CC:LCO:LMO). However, for the scenario where a material layer with low electronic conductivity is next to the current collector, the conductivity needs to approach the same order of magnitude as the ionic conductivity of the electrolyte used or else the electronic conductivity of this material will limit the rate capability of the cell. With this higher electronic conductivity, the rate capability at rates of C/20 and C/50 was no longer limited by the electronic conductivity of the LMO material layer and nearly all the electrode capacity was accessed, consistent with previous analysis. This suggests that there may be processing methods such as the addition of electronically conductive coatings to materials such as LMO to aid in achieving higher utilization of the electrode materials.

When using single materials with relatively high electronic conductivity in sintered electrodes such as LCO or LTO, lithiation/delithiation tended to initiate from the separator and propagated towards the current collector side, in some cases via a front with a pronounced gradient. Such electrode depth/position dependence of the electrochemical reactions may not be desirable. For example, the reaction selectively occurring near the separator might accelerate additional cathode-electrolyte interphase (CEI) formation in this region. The CEI could then potentially impede the pores and restrict the transport of lithium further towards the current collector where there would be additional capacity remaining in the electrode. Also, regardless of CEI complications at high discharge rates the electrolyte concentration will become depleted near the current collector side of the cathode due to ion transport limitations. As a result, electrode regions with remaining capacity nearer the current collector can have situations where the electrolyte concentration becomes too low for Li to continue to intercalate, limiting the voltage and capacity of the cell. Thus, electrode designs with multiple layers may enable strategies to have more capacity from the current collector regions earlier in the discharge process to avoid the later ion transport restrictions that can more severely limit capacity.

This study investigated multicomponent sintered electrodes, where the two materials combined in the cathode architecture were LCO and LMO. Homogeneous blending of the two material powders resulted in new interfacial compositions forming during the thermal processing of the electrode and severe reductions in electrochemical capacity. This highlights the importance of considering the formation of new phases during multicomponent sintered electrode processing. When the LCO and LMO were processed as two separate layers, the interfacial component was a relatively small contributor to overall electrode electrochemical properties. Instead, the electrochemical properties resulting from the location of the electrodes on either the current collector or separator side were investigated.

Depending on which layer (LCO or LMO) was near the current collector dramatically changed electrochemical properties of the cells, which was attributed to the very different electronic conductivities of the two materials. Simulations provided further insights into the progression of the electrochemical reactions in the cell. For thick sintered electrodes, careful consideration must be given to the thermodynamics (e.g., OCV at different locations at any given point in the discharge progression), and electronic and ionic transport pathways which dramatically influence the spatial location of the lithiation and delithiation reactions. These results provide insights into the design considerations for multicomponent sintered electrode batteries.

P2D simulation was used to generate some of the data herein, with the systems of equations used below.

### Electrolyte Concentration:

$$ϵ \frac{\partial c}{\partial t} = \frac{\partial }{\partial x} ( {D}_{eff} ( c ) \frac{\partial c}{\partial x} ) + Aj ( 1 - {t}_{+}^{0} )$$

### Electrode Potential:

$$\frac{\partial {ϕ}_{1}}{\partial x} = \frac{- {i}_{1}}{σ ( {c}_{s} )}$$

### Electrolyte Potential:

$$\frac{\partial {ϕ}_{2}}{\partial x} = - \frac{{i}_{2}}{{κ}_{eff} ( c )} + \frac{2 RT}{F} ( 1 + \frac{\partial ln f \pm ( c )}{\partial ln c} ) ( 1 - {t}_{+}^{0} ) \frac{\partial ln c}{\partial x}$$

### Lithium Flux Kinetics:

$$j = - 2 {{kc}^{0.5} ( {c}_{s}^{surface} )}^{0.5} {( {c}_{s}^{surface} - {c}_{s , max}^{surface} )}^{0.5} Sinh ( \frac{F}{R T} ( {ϕ}_{1} - {ϕ}_{2} - U ) )$$

Lithium Flux across Electrode & Electrolyte Interface:

$$j = - {D}_{s} \frac{\partial {c}_{s}^{surface}}{\partial r}$$

### Electrolyte Current:

$$Aj = \frac{1}{F} \frac{\partial {i}_{2}}{\partial x}$$

### Conservation of Current:

$$I = {i}_{1} + {i}_{2}$$

### Volumetric Surface Area:

$$A = \frac{3}{{r}_{0}} ( 1 - ϵ )$$

### Electrode Particle Concentration:

$$\frac{\partial {c}_{s}}{\partial t} = {D}_{s} ( \frac{1}{{r}^{2}} \frac{\partial }{\partial r} ( {r}^{2} \frac{\partial {c}_{s}}{\partial r} ) )$$

### Effective Ionic Conductivity and Diffusivity:

$$\frac{{κ}_{eff} ( c )}{κ ( c )} = \frac{{D}_{eff} ( c )}{D ( c )} = {ϵ}^{α}$$

List of symbols are shown below.

List of Symbols

| | |
|---|---|
| Electronic Conductivity | □ |
| Ionic Conductivity | □ |
| Liquid Li⁺ Concentration | c |
| Solid Li⁺ Concentration | cₛ |
| Solid Potential | □_{□} |
| Liquid Potential | □_{□} |
| Porosity/Electrolyte Volume Fraction | □ |
| Li⁺ Insertion | j |
| Open Circuit Potential | U |
| Discharge Current Density | I |
| Solid Phase Current Density | i₁ |
| Liquid Phase Current Density | i₂ |
| Volumetric Solid Particle Surface Area | A |
| Solid Particle Radius | r₀ |
| Electrolyte Diffusivity | D |
| Solid State Diffusivity | Dₛ |
| Bruggeman Exponent | □ |
| Transference number | t₊⁰ |
| Faraday Constant | F |
| Temperature | T |
| Gas Constant | R |

TABLE 5

| Parameters | LiCoO₂ | LiMn₂O₄ |
|---|---|---|
| Thickness (μm) | 255, Experimental | 255, Experimental |
| Solid State Li⁺ Diffusivity (m² s⁻¹) | 3.5 × 10^{-13 3} | 1 × 10^{-14 4} |
| Active Material Radius (m) | 1.2 × 10⁻⁷ | 3.8 × 10⁻⁷ |
| Porosity | 0.34, Experimental | 0.34, Experimental |
| Bruggeman Exponent | 1.5 | 1.5 |
| Rate Constant (m^{2.5} mol^{-0.5} s⁻¹) | 3.1 × 10^{-13 5} | 8.4 × 10^{-13 6} |
| Density (g cm⁻³) | 5.0 ⁷ | 4.3 ⁸ |
| Variable conductivity | 7000 × (1 − x)² + | 0.006 + 0.2439((Tanh(−8(x − |
| (S m⁻¹) | 5 × (1 − x) + 0.054, | 0.49) + 1)/120 + Tanh(−45(x − |
| | 0.5 ≤ x ≤ 1.0 | 0.025) + 1)/9 + Tanh(−60(x − |
| | in LiₓCoO₂ ^{9, 10} | 0.988) + 1)/70), |
| | | 0 ≤ x ≤ 1.0 in LiₓMn₂O₄ ¹¹ |
| Modified Conductivity | | 0.006 + 0.2439((Tanh(−8(x − |
| (S m⁻¹) | | 0.49) + 1)/120 + Tanh(−45(x − |
| | | 0.025) + 1)/9 + Tanh(−600(x − |
| | | 0.974) + 1)/70) + |
| | | Tanh(−600(x − 0.974) − 1)/ |
| | | 420, |
| | | 0 ≤ x ≤ 1.0 in LiₓMn₂O₄ |
| Open Circuit | −Tanh(5.7(x − 0.555)) − | 4.03 − (Tanh(12.5(x − 0.49) − |
| Voltage (V) | 1)/3.1 − (Exp(59(x − | 1)/18 − 0.035x + 0.05Exp(−80(x − |
| | 0.84) + 1)/4000 + | 0.03)) − (Exp(10(x − |
| | Tanh(7(x − 0.76) − 1)/ | 0.45) + 1)/2000 − (Exp(70(x − |
| | 45 + Exp(−400(x − 0.5))/ | 0.893) + 1))/2000 |
| | 40 + 3.88, | 0 ≤ x ≤ 1.0 |
| | 0.5 ≤ x ≤ 1.0 | in LiₓMn₂O₄, |
| | in LiₓCoO₂, | Experimental |
| | Experimental | |

TABLE 6

| Electrolyte and Other Parameters | Value |
|---|---|
| Transference number, t₊⁰ | 0.415 ¹² |
| Initial Concentration (mol m⁻³) | 1200, Experimental |
| $Thermodynamic Factor , ( 1 + \frac{\partial {lnf}_{\pm }}{\partial lnc} ) ( 1 - {t}_{+}^{0} )$ | 0.28687 c² + 0.74678 c + 0.44103 ¹³ |
| Conductivity (S m⁻¹) | 0.1297c³ + 2.51c^{1.5} + 3.329c ¹³ |
| Diffusivity (m² s⁻¹) | (−6.9444c² + 7.3611c + 2.65) × 10⁻¹⁰, c < 0.8, |
| | 6.4753 × Exp(−0.573c) × 10⁻¹⁰, c ≥ 0.8 ¹³ |
| Temperature (K) | 298.15, Room Temperature |
| Gas Constant (J K⁻¹ mol⁻¹) | 8.3145 |
| Faraday Constant (A s mol⁻¹) | 96485 |
| Separator Thickness (μm) | 100, Experimental |
| Separator Bruggeman Exponent | 5.1, Experimental |
| Separator Porosity | 0.78, Experimental |
| Anode Thickness (μm) | 710, Experimental |
| Anode Solid State Li⁺ Diffusivity (m² s⁻¹) | 2.0 × 10^{-12 14} |
| Anode Active Material Radius (m) | 1.7 × 10^{-7 15} |
| Anode Porosity | 0.40, Experimental |
| Anode Bruggeman Exponent | 1.5 |
| Anode Rate Constant (m^{2.5} mol^{-0.5}s⁻¹) | 3.90 × 10^{-13 16} |
| Anode Density (kg m⁻³) | 3480 ¹⁷ |
| Anode Capacity (mA h g⁻¹) | 175 ¹⁸ |
| Anode Variable conductivity (S m⁻¹) | 300(x + 10⁻⁶)^{0.38} × 5^{(y -1)}/Exp(4.37(y − 1)²⁰⁰), |
| Anode Open Circuit Voltage (V, vs Li/Li⁺) | 0 ≤ y ≤ 1.0 in Li_{4+3y} Ti₅O₁₂ ¹⁹ |
| | 0.21Exp(−116.96y) + 0.45Exp(−5000y) + |
| | 0.27706Exp(−1010.ly) + 1.56 − |
| | 0.001Exp(50(y − 0.87)), |
| | 0 ≤ y ≤ 1.0 in Li_{4+3y}Ti₅O₁₂, Experimental |

### Example 4

### 1. Materials and Methods

### 1.1 Electroactive Material Powder Synthesis

TNO electroactive material powder was synthesized using a sol-gel method. Briefly, 0.5 M of niobium chloride (NbCl₅, Sigma-Aldrich) and 0.25 M of titanium isopropoxide (Ti(OC₃H₇)₄, Sigma-Aldrich) were dissolved in 40 mL ethanol at 40° C. and stirred at 300 RPM to facilitate dissolution and mixing. The solution was dried at room temperature overnight in air, then redissolved in 40 mL deionized (DI) water and dried at 80° C. overnight in air within a fume hood. The resulting precursor was then heated to 700° C. and held at that temperature for 2 hours, where the ramp rates for heating and cooling were both 1° C. min⁻¹.

LCO electroactive material powder was synthesized via precipitation of a precursor followed by solid state reaction.²³ 0.2 M of cobalt sulfate heptahydrate (CoSO₄·7H₂O, Acros Organics) and 0.2 M of sodium oxalate (Na₂C₂O₄, Fisher) were separately dissolved into 400 mL of DI water each and heated to 60° C. The solutions were mixed together via pouring all at once, and the mixture was stirred at 300 RPM. The reaction was allowed to proceed for 30 min before collection of the precipitate via vacuum filtration. The filter cake was rinsed with 1.6 L of DI water. The resulting powder cake was then dried at 80° C. overnight in air, and blended with lithium carbonate (Li₂CO₃, Fisher Chemical) with a molar ratio of 1.05:1 Li:Co using a mortar and a pestle by hand for 10 min. The blended powder was then heated at a ramp rate of 1° C. min⁻¹ to 800° C. without a hold at the top temperature, and then allowed to cool to room temperature without control over the cooling rate.

### 1.2 Materials Characterization

Thermogravimetric analysis (TGA) was conducted using a TA Instruments Q50. Heating initiated from room temperature to 800° C. at a ramp rate of 10° C. min⁻¹ in air atmosphere. Scanning electron micrographs (SEMs) were collected using a FEI Quantum 650. Powder X-ray diffraction (XRD) was conducted using a PANalytical X′pert ProMPD.

Electronic conductivity of materials was measured using a direct current (DC) technique. The as-prepared sintered pellet electrodes were coated with silver paste (Sigma-Aldrich) by hand on each flat side of the porous disc. The coated pellets were sandwiched between stainless steel and compressed by a clamp. A constant voltage at 10 mV was applied and current was recorded using a Gamry Reference 600 to measure the DC resistance necessary to calculate the pellet material electronic conductivity.

### 1.3 Sintered Electrode Fabrication

During fabrication of sintered TNO electrodes, 4 concentrations of sucrose binder were prepared in this work. The sucrose contents were 0.0%, 2.5%, 5.0%, and 7.5% by mass (denoted by 0.0%-sucrose, 2.5%-sucrose, 5.0%-sucrose, and 7.5%-sucrose). The percentage indicates the mass percent of sucrose relative to the total combined mass of sucrose and TNO. For the 0.0%-sucrose sample, 1 g of TNO powder was blended with 2 mL of 1 wt % polyvinyl butyral (PVB) solution (Pfaltz & Bauer) in ethanol using a mortar and pestle by hand until dried. For the other three samples which contained sucrose, a total mass of 1 g consisting of TNO and sucrose powder was blended with 0.5 mL of DI water and 1.5 mL of ethanol using a mortar and a pestle by hand until dried. For all cases, the coated powder was next loaded into a circular pellet die (Carver) with a diameter of 1.3 cm, followed by pressing at 420 MPa for 2 min using a hydraulic press (Carver). The pressed pellet was sintered in argon atmosphere at 800° C. for 1 hour at both ramp up and down rates of 2° C. min⁻¹. The as-prepared pellets had thicknesses ranging between 580-610 μm (measured using digital calipers), areal loadings of 142-148 mg cm⁻², and geometric pore/void fraction of 0.43-0.45 (calculated assuming the crystal density to be 4.3 g cm⁻³). Note that carbon coated (and carbon free) TNO powders were also used in composite electrodes, and for TNO powders used for composite electrodes all processing steps were the same as for sintered electrodes except that there was not a hydraulic compression of the powder.

For sintered LCO electrodes, 1 g of LCO powder was blended with 2 mL of 1 wt % PVB solution in ethanol using a mortar and a pestle by hand until dried. The pressing procedure was the same as above for TNO materials. The pressed pellet was sintered in air at 600° C. for 1 hour at both ramp up and down rates of 1° C. min⁻¹. The as-prepared pellets had measured thicknesses ranging between 810-850 μm, areal loadings of 268-273 mg cm⁻², and geometric pore/void fractions of 0.32-0.34 (calculated assuming the crystal density to be 5.0 g cm⁻³).

### 1.4 Electrochemical Evaluation

For composite electrode cells, the TNO powder was mixed with acetylene carbon black (CB, Alfa Aesar) and 3.33 wt % polyvinyl pyrrolidone (PVP, Sigma Aldrich, 360 kDa molecular weight) in ethanol solution with a mass ratio TNO:PVP:CB of 8:1:1. The resulting slurry was coated onto an aluminum foil current collector using a doctor blade, which resulted in final areal active material loadings measured for punched electrodes to range between 2.0-3.5 mg cm⁻² after drying. Circular electrodes with an area of 1.33 cm² were punched by hand using a die and transferred into a glove box filled with argon. Punched lithium metal foil was used as anodes and Celgard 2325 was the separator, and the electrodes were assembled into electrochemical cells using 2032-type coin cell parts, with assembly all in the glove box. The electrolyte was 1.2 M LiPF₆ in 3:7 ethylene carbonate:ethyl methyl carbonate (Gotion). The as-prepared cells were evaluated using a multichannel battery cycler (MACCOR) between 1.0-2.5 V at C/20, where 387.6 mAh g⁻¹ was assumed to be the TNO theoretical capacity used for adjusting the currents for the C rate determination. It is noted that for Li/TNO cells, the cycling starts on a discharge.

For sintered electrode cells, the as-prepared sintered cathode (LCO pellet) and sintered anode (TNO pellet) were attached to the bottom plate and the spacer of the 2032-type coin cell, respectively, with a custom carbon paste applied between the sintered electrode and stainless steel to reduce contact resistance. The custom carbon paste was applied as a homogenous slurry consisting of 4.76 wt % of CB, 4.76 wt % of PVP, and 90.48 wt % of ethanol. Pellets adhered to the cell components with the paste were then dried in vacuum at 80° C. for 20 min before transferring into the glove box. 2032-type coin cells were assembled with a single spacer which was attached to the anode, as the cathode was directly attached to the bottom piece. The same electrolyte was used for the composite electrodes described above. Glass fiber (Fisher, type G6 circles) was used as separator. The sintered cells were cycled between 1.0-3.2 V, and as a reference point for C rates 1.69 mA cm⁻² corresponded to a rate of C/20.

### 2. Results and Discussions

### 2.1 Materials Characterizations

The initial sol-gel synthesized powder with the targeted TNO composition had broad peaks in collected XRD patterns, suggesting relatively low crystallinity. The broad peaks may have in part been due to the relatively low calcination temperature, and were consistent with previous reports. Explicit assignment of each individual peak was challenging to affirm unambiguously; however, there were TiₓNb_{y}O_{z} phases that could be associated with all peaks. These micrographs suggested the morphology of the material was secondary aggregates that had length dimensions of approximately 20 μm, while the primary particles that formed the larger aggregates were less than 1 μm in length (with many primary particles in the size range of ˜100 nm).

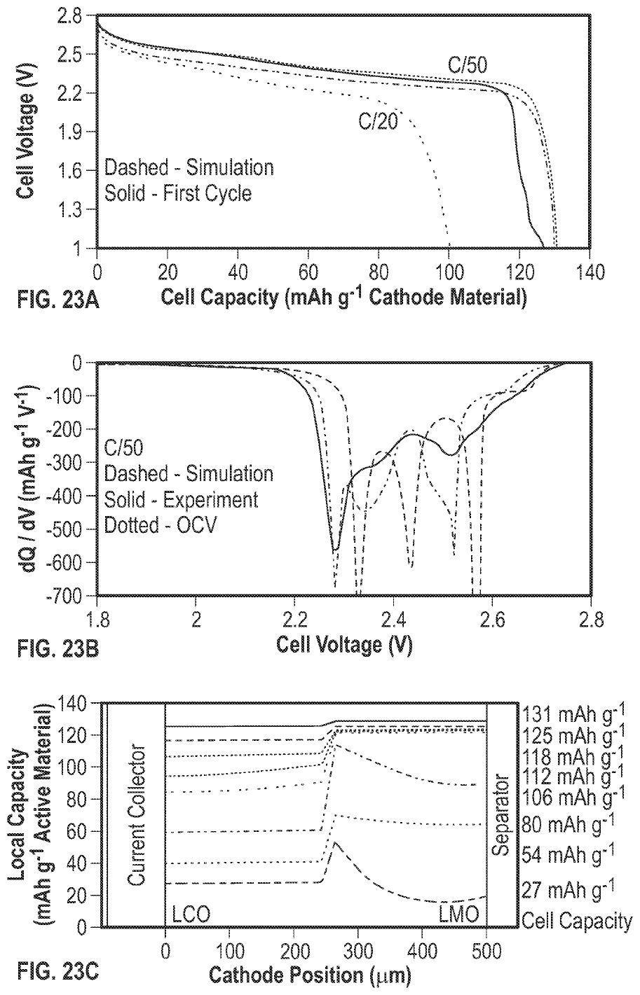

FIG. 24A shows the estimated mass percentage of carbon on the TNO materials with the different amounts of sucrose added before hydraulic compression and thermal treatment in inert atmosphere. Carbon loss/oxidation was observed to occur between 400-500° C., consistent with previous reports. As the sucrose content added to the powder increased, the relative mass content of the carbon coating increased as well. An additional note is that based on the elemental C content of sucrose, theoretically for the mass of sucrose if all that C was converted to a carbon coating 42 wt % of the initial sucrose mass would be expected to remain. FIG. 24A depicts the amount of carbon that would be expected if all the C in the sucrose was converted to a carbon coating. As can be seen, the carbon content for all samples was below these theoretical values, suggesting loss of carbon to other processes such as reduction of the TNO material at the interface. It is also noted that the difference between the theoretical maximum carbon and carbon determined from TGA increased as the sucrose added increased, suggesting less efficiency of sucrose conversion to a carbon coating as the sucrose content was increased.

The DC electronic conductivity measured using TNO porous pellets can be seen in FIG. 24B. All TNO materials exhibited higher electronic conductivity than reported for phase pure TiNb₂O₇ from literature. Even with the 0.0%-sucrose sample, the conductivity was ˜5 orders of magnitude higher, and this higher conductivity was suspected to result in part from the presence of TiNbO₄ phase (consistent with XRD results discussed in the next paragraph), which has a much higher electronic conductivity reported at ˜150 S m⁻¹ Additionally, there may have been some reduction of the TiNb₂O₇ phase, which can have a large impact on the electronic conductivity of this material. For the materials processed with sucrose and subsequently coated with carbon, as the carbon coating content increased the electronic conductivity also increased. Final measured conductivities for the materials with the most carbon content were over 1 S m⁻¹.

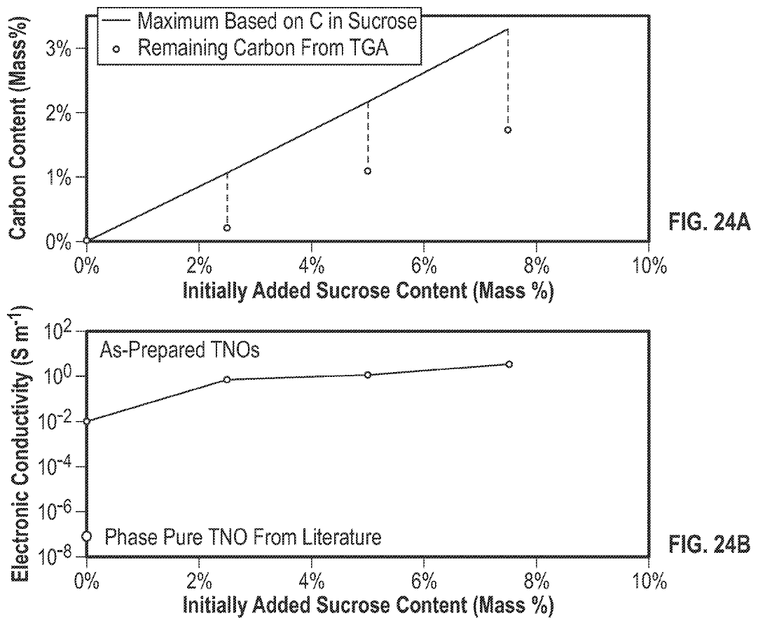

XRD patterns for the TNO pellets after hydraulic compression and heating in argon atmosphere can be found in FIG. 25. All four amounts of sucrose addition resulted in similar XRD patterns. The major phase was assigned as TiNb₂O₇, a monoclinic layered structure with space group of C2/m. An impurity phase was also noted after sintering, which was attributed to TiNbO₄, which would suggest partial reduction of some Nb⁵⁺ to Nb⁴⁺ in the pellet. The peaks consistent with arising due to a TiNbO₄ impurity are marked on FIG. 25. It is noted that to the naked eye, visually the 0.0%-sucrose exhibited dark blue color, while the carbon coated samples were all dark grey, consistent with previous literature. There was an additional small impurity peak at a 20θ position of ˜25°. Explicit assignment of this peak was difficult, although likely candidates could be other Nb-enriched oxide phases such as TiNb₂₄O₆₂, Ti₂Nb₁₄O₃₉, and Ti₂Nb₁₀O₂₉ based on bulk stoichiometry. Since the bulk molar ratio of Ti:Nb from sol-gel synthesis was 1:2, the presence of TiNbO₄ suggested the presence of one or multiple of these Nb-enriched phases.

All samples had a similar appearance. Many of the primary particle sizes were still on the order of ˜100 nm as was the case for the powder before hydraulic compression and thermal treatment. The retention of the primary particle size was also consistent with a mild sintering process. These primary particles were part of larger aggregates that were 10-20 μm in size. Many of the aggregates had an appearance of being flattened, which likely resulted from the hydraulic compression processing step.

### 2.2 Electrochemical Evaluation

Initial electrochemical analysis on the TNO materials was conducted using composite electrodes paired with Li metal anodes. As the sucrose content that was added to the TNO before heat treatment was increased, the gravimetric capacity of the resulting TNO electroactive material decreased. The decrease in gravimetric capacity was likely due to increasing inactive carbon content in the powder and also due to increasing relative amounts of TiNbO₄ phase. The voltage where TiNbO₄ has electrochemical capacity is between 1.0-2.0V and thus overlaps with TNO; however, TiNbO₄ has a reported capacity of 200 mAh g⁻¹ and thus increase in its content would lower the overall material gravimetric capacity relative to TNO.

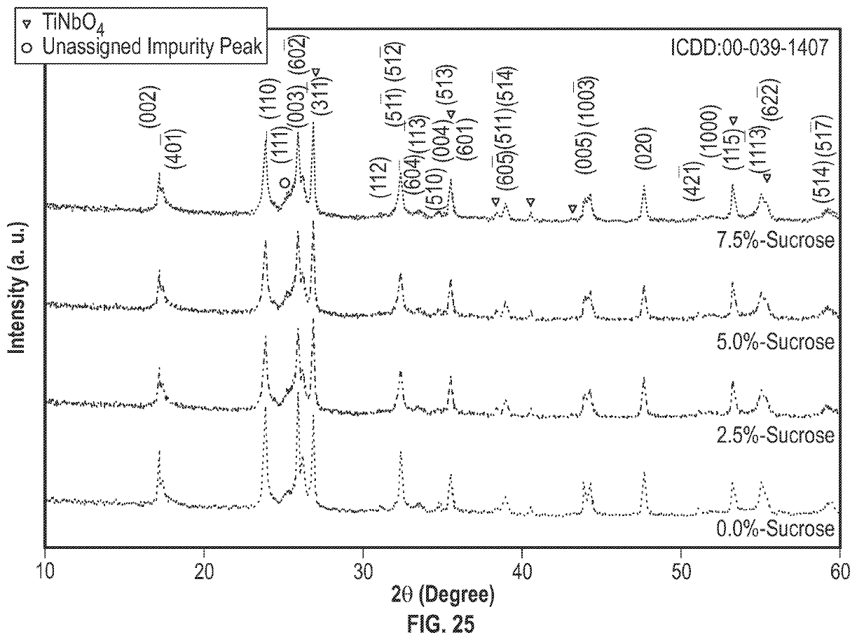

Next, electrochemical characterization was done of cells containing the TNO sintered electrodes directly. The TNO materials were used as sintered anodes paired with LCO sintered cathodes in a full cell configuration. Sintered electrodes were not evaluated in half cells due to the limitations of using lithium metal in such high areal capacity systems, where each cycle would have significant amount of plating and stripping that make the Li electrode the limiting factor. As for sintered cells paired with LCO, when looking at the discharge voltage profiles (FIG. 26), at relatively slow rate of C/20, the 0.0%-sucrose had the largest capacity as expected, because at low rates the resistance due to that material having the lowest matrix electronic conductivity did not impact the electrochemical capacity. At higher rates of C/10 and C/5, the 2.5%-sucrose had the highest capacity among all materials evaluated. This outcome was not explained simply by improvements in the electronic conductivity of the electrode matrix. For such a thick sintered electrode the cell would be expected to be limited by the ion transport through the electrolyte-laden electrode microstructure at such rates, due to Li depletion in the cathode region. As the sucrose content increased, the voltage decreased with a steeper slope near the later discharge region (e.g., >150 mAh g⁻¹ anode) at both C/10 and C/5. This outcome was attributed as a consequence of ion transport in the microstructure being the limiting process once there was sufficient carbon coverage to overcome the matrix electronic conductivity resistance in the TNO electrode. Any excess carbon after achieving the electronic conductivity improvement would be expected to further impede ion transport in the interstitial regions between electroactive material particles, and excess carbon can also negatively impact interfacial resistance of the electroactive materials.

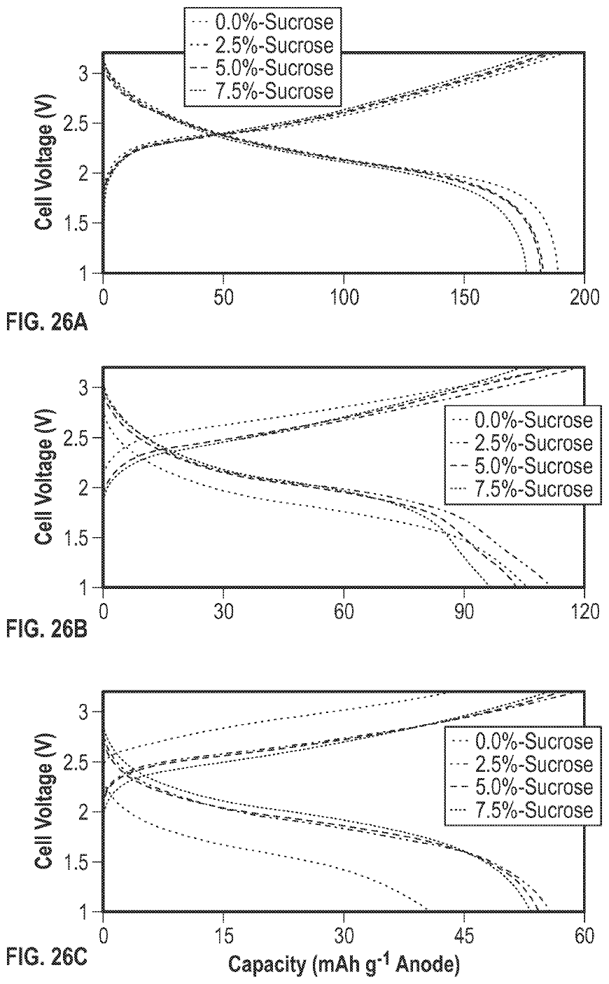

While the rate capability analysis above reflected the retention of electrochemical capacity, another outcome that changed for the different TNO electrode cells was the average discharge voltage. The average discharge voltage as a function of the discharge C rate for the TNO sintered anode cells can be found in FIG. 27. At the lowest discharge rate of C/20, all cells had similar average discharge voltage of 2.17 V. As the C-rates increased, for the 0.0%-sucrose, the average discharge voltage dropped substantially and was 1.64 V at C/5. As the sucrose content increased, the drop in average discharge voltage was mitigated with the 7.5%-sucrose TNO anode cell achieving 1.96 V at C/5. This outcome suggested the electronic conductivity improvement of the additional carbon helped to increase the average discharge voltage, although the ion transport limitations and Li⁺ depletion in the electrolyte likely resulted in the reverse trend for the total capacity at increasing discharge rate. The average voltage for the last five cycles of the rate capability experiment where the rate was adjusted back to C/20 also increased as the sucrose content during TNO processing was increased.

### 2.3 ΔdQ/dV Peak Shift Analysis

According to the Butler-Volmer equation, for most Li-ion battery electroactive materials the current has an exponential dependence on the overpotential if only considering the interfacial kinetics. Thus, in the ideal case galvanic charge and discharge of thin composite electrode batteries with low loadings would often primarily reflect the interfacial kinetics at different C rates. dQ/dV plots show the voltage regions corresponding to the delivery of electrochemical capacity. An additional use of dQ/dV is the ΔdQ/dV calculated for shifts in the peak positions between the charge and discharge cycle at the same current density (shift in voltage location of peaks in differential capacity), where the shift is the ΔdQ/dV values as a function of current densities. For batteries with very thick electrodes, such as the sintered electrode cells evaluated herein, the overpotential contribution from interfacial compared to ionic and/or electronic overpotential is much smaller according to previous analysis. For such thick electrodes, the electronic and ionic conductivity of the solid electrode and liquid electrolyte phase can be reflected in the ΔdQ/dV peak position-where the baseline is the dQ/dV peak at low cycling rates and the ΔdQ/dV is the shift in the peak locations at increasing C rates. For increasing C rates in a cell where the overpotential is primarily due to electronic and/or ionic conductivity through the matrix, it would be expected that the ΔdQ/dV peak positions would shift linearly as a function of increasing current density (or C-rate for identically processed electrodes/cells). Similar analysis was previously reported for indirect evaluation of the impact of the electronic conductivities of sintered LiMn₂O₄-type (LMO) materials with different dopants and lithiation states. The prior analysis of LMO materials demonstrated that dQ/dV not only serves well to analyze the redox potentials in thin composite electrode with negligible electronic and ionic overpotentials, but also to analyze the electronic and ionic conductivities in thick sintered electrodes with relatively low contributions from interfacial overpotentials to the overall cell overpotential. When comparing electroactive materials with different compositions/dopants/treatments, the use of ΔdQ/dV peak positions can exclude the impact from difference in open circuit voltage (OCV). In addition, with thicker electrodes where lithium depletion in general will occur, the peak dQ/dV position well represents the voltage where the electrochemical reactions occur most favorably well before lithium depletion in the cathode region. The Lit depletion likely resulted in the more dramatic decrease in voltage that resulted in lower capacity for the TNO sintered electrodes with the highest sucrose content during processing.

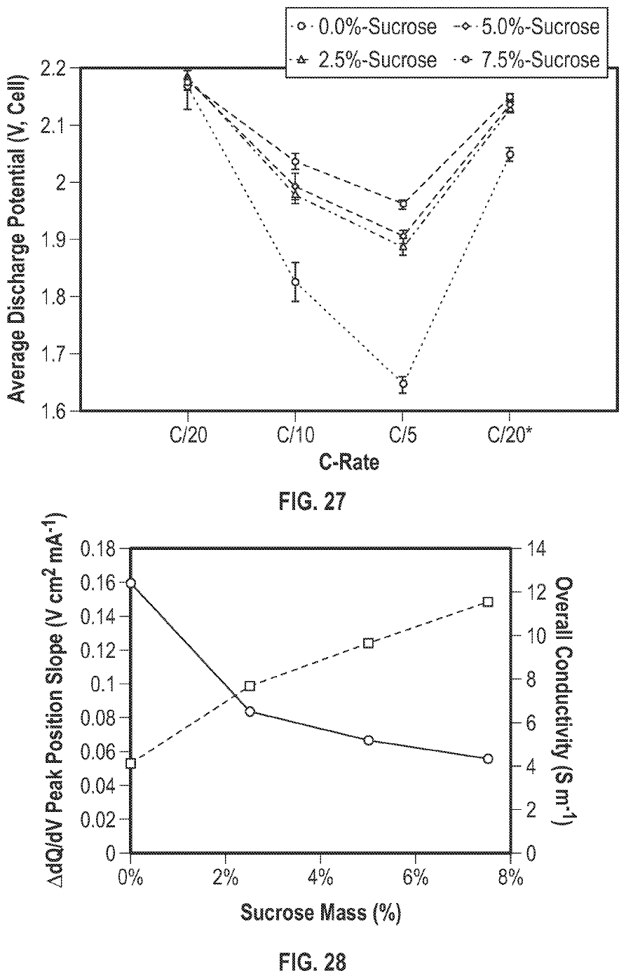

As expected for cells with ionic or electronic electrode conductivity being the primary contributors to overpotential, all cells had a linear dependence between the ΔdQ/dV peak positions and current density. As the sucrose content increased, the slope decreased, with these results summarized in FIG. 28. In contrast to transmission line models or models often assumed in pseudo-two-dimensional simulations, where the current was distributed between the solid electrode and liquid electrolyte across the electrode depth, an overall conductivity (effectively a combination of both electronic conductivity of electrode and ionic conductivity of electrolyte) can be calculated as:

$$σ = {A}^{- 1} L {R}^{- 1}$$

where σ is the overall conductivity, A is the electrode area, L is the total battery thickness including anode, cathode, and separator, and R is the resistance. Furthermore, the approximate slope of the ΔdQ/dV peak position with a unit of V cm² mA⁻¹ is approximated as

$$2 k = AR$$

where k is the slope. Combining both equations, the approximate overall conductivity can be calculated by

$$σ = 2 {k}^{- 1} L$$

The overall conductivities of all TNO sintered anode cells are shown in FIG. 28, whereas the sucrose content increased, the overall conductivity increased and matched the electronic conductivity trend measured for the TNO sintered anode pellets. Note that for the 2.5%-sucrose content and higher, the overall conductivity approached and exceeded the ionic conductivity of the electrolyte used, which further supported that the rate capabilities of 2.5%-sucrose and higher sucrose content TNO sintered anode cells were not limited by the electronic conductivities of the electrode matrix.

The electronic conductivity improvement from carbon coating was beneficial for overall desirable electrochemical energy storage outcomes for TNO materials, but only up until a certain threshold of carbon added. More generally, many coating materials including carbon do not participate in the electrochemical battery reaction and sometimes exacerbate the interfacial kinetics if the coating layer is too thick. In a thick electrode architecture, another disbenefit of excess carbon material is that the excess material can potentially take up volume within the electroactive particle interstitial space of the electrode. Additional material within the pore/void volume which becomes laden with electrolyte will decrease effective ionic transport properties through the electrode. As mentioned earlier, so long as the effective electrode electronic conductivity exceeds approximately 1 S m⁻¹, or roughly the ionic conductivity of the electrolyte (LiPF₆ in carbonates), the matrix electronic conductivity of the sintered electrode no longer limits the capacity of the cell. In the case of higher conductivity electrolytes such as those containing lithium bis(fluorosulfonyl)imide (LIFSI), the threshold for electronic conductivity would be increased to match a value similar in conductivity of the relevant electrolyte.

TiNb₂O₇ was successfully synthesized using a sol-gel method. Sucrose was incorporated into the processing of the TNO material into porous sintered electrodes, where the sucrose played a dual role of binder during powder processing and carbon source for generating carbon during thermal treatment. As the relative weight fraction of sucrose was increased, the relative amount of carbon in the electrode also increased and the resulting initial measured electrode matrix electronic conductivity also increased. The carbon addition resulted in improvements in rate capability and average discharge voltage for cells which used sintered anodes containing the TNO materials. This report provides both a robust route for improving electrochemical outcomes when incorporating relatively low electronic conductivity electroactive material in sintered electrodes and supports general guidelines for targeting a carbon amount that achieves comparable conductivity to the electrolyte to avoid unnecessary ion transport restrictions from excessive carbon.

### Example 5

### Materials and Methods

### 1.1 Electroactive Material Powder Synthesis

The synthesis of LiCoO₂ (LCO) electroactive material powder was based on a previously reported method of oxalate precursor precipitation followed by solid state reaction. 200 mM of cobalt sulfate heptahydrate (CoSO₄·7H₂O, Acros Organics) and 200 mM of sodium oxalate (Na₂C₂O₄, Fisher) were separately dissolved into 2 beakers of 400 mL of deionized (DI) water each and preheated to 60° C. The sulfate solution was poured all at once into the oxalate solution, and the solution was kept at 60° C. with stirring at 300 RPM for half an hour. The resulting precipitate was collected via vacuum filtration, followed by 1.6 L of DI water rinsing, before being transferred to an oven and dried at 80° C. overnight in air. The dried powder was then blended with lithium carbonate (Li₂CO₃, Fisher Chemical) by hand with target Li:Co stoichiometry of 1.05:1 using a mortar and a pestle for 10 min. The mixed powder was placed in a crucible and heated up to 800° C. at a ramp up rate of 1° C. min⁻¹ in air without a hold. The furnace was then allowed to cool to room temperature without control over cooling rate.

TNO electroactive material precursor was synthesized using a sol-gel method. Briefly, 0.5 M of niobium chloride (NbCl₅, Fisher) was dissolved in 40 mL of ethanol at 40° C. and stirred at 300 RPM, followed by addition of 0.25 M of titanium isopropoxide (Ti(OC₃H₇)₄, Sigma-Aldrich) to the same solution. When the solution became fully transparent (typically <30 seconds), it was poured into a drying dish and dried at room temperature overnight in air. The resulting gel was redissolved in 40 mL deionized (DI) water using a spatula by hand until fully dissolved, and then dried at 80° C. overnight in air within a fume hood. The dried precursor was then ground using mortar and pestle by hand for 5 mins and heated in a furnace in air with ramp rates for heating and cooling of 1° C. min⁻¹. The highest target temperature and hold time at that target was 1000° C. for 24 h, 800° C. for 2 h, 700° C. for 2 h, and 600° C. for 2 h (referred as 1000 C, 800 C, 700 C, and 600 C, respectively, when referenced herein).

### 1.2 Composite Electrode Fabrication

All cathodes in composite cells were composite TNO electrodes. The 1000° C., 800° C., 700° C., and 600° C. powder was blended with acetylene carbon black (CB, Alfa Aesar) as conductive additive and 3.33 wt % polyvinyl pyrrolidone (PVP, Sigma Aldrich, 360 kDa molecular weight) as polymer binder with a TNO:PVP:CB weight ratio of 8:1:1. The slurry mixture was then casted onto an aluminum foil current collector using a doctor blade with a gap of 200 μm, and areal electroactive material loadings were 0.9-2.0 mg cm⁻² after drying. Circular electrodes with an area of 1.33 cm² were punched by hand using a die and transferred into a glove box filled with argon.

All anodes in composite cells were Li foils with thicknesses of 100 μm and punched into circular shape with an area of 1.6 cm².

### 1.3 Sintered Electrode Fabrication

All cathodes in sintered cells were sintered LCO electrodes. 1 g of LCO powder was blended with 2 mL of 1 wt % PVB solution in ethanol using a mortar and a pestle by hand until dried. The coated LCO powder was transferred into a circular pellet die (Carver) with an area of 1.33 cm², followed by pressing at 420 MPa for 2 min using a hydraulic press (Carver). The mass of PVB-coated LCO was targeted to be 350 mg for each electrode pellet. The pressed LCO pellet was then sintered in air at 600° C. for 1 hour with ramp rates of 1° C. min⁻¹ for both heating and cooling. The as-prepared pellets had measured thicknesses ranging between 770-800 μm, areal loadings of 253-258 mg cm⁻², and geometric pore/void fractions of 0.32-0.34 (calculated assuming the crystal density to be 5.0 g cm⁻³). Detailed characterization of sintered LCO electrodes can be found elsewhere for using the same procedures.

All anodes in sintered cells were sintered TNO electrodes. The coating and pressing were the same procedure as used for LCO. During the thermal treatment of the pressed TNO pellets, the top target temperature was 1000° C., 800° C., 700° C., and 600° C. for the 1000° C., 800° C., 700° C., and 600° C. source powders, respectively. In all cases the hold at the target temperature was 2 h and the heating and cooling ramp rates were 2° C. min⁻¹. Resulting TNO pellets had measured thicknesses of 440-450 μm and areal loadings of 109-110 mg cm⁻².

### 1.4 Material Characterization and Electrochemical Evaluation

Powder X-ray diffraction (XRD) was performed using a PANalytical X′pert ProMPD. Scanning electron micrographs (SEM) were conducted using a FEI quantum 650.

All electrochemical cell assembly was performed in a glove box with water and oxygen levels <1 ppm. All cells used 2032-type coin cell parts. For composite cells, Celgard 2325 with an area of 1.98 cm² was used as separator, and electrolyte was 1.2 M LiPF₆ in 3:7 ethylene carbonate:ethyl methyl carbonate (Gotion) was used as electrolyte. The assembled cells were evaluated using a multichannel battery cycler (MACCOR) between 1.0-2.5 V (vs. Li/Li⁺) at C/10, where 200 mAh g⁻¹ TNO was assumed for calculating C rates and the current was adjusted based on measured TNO mass loading in the electrodes.

For sintered cells, the as prepared LCO and TNO pellet electrodes were adhered to the bottom plate and the spacer of the 2032-type coin cell, respectively, using a custom carbon paste to reduce contact resistance. The carbon paste consisted of 4.76 wt % of CB, 4.76 wt % of PVP, and 90.48 wt % of ethanol. After attaching the pellets, they were dried in vacuum at 80° C. for 20 min to remove ethanol before transferring into the glove box. Electrolyte was the same used in composite cells, but glass fiber (Fisher, type G6 circles) with an area of 1.98 cm² was used as separator for sintered electrode cells. The sintered cells were cycled between 1.0-3.1 V (cell voltage), and 0.85 mA cm⁻² was assumed to be C/50 for all sintered cells. The mass ration of LCO:TNO was ˜2.5:1, resulting in what was expected to be anode limited cells for all materials.

### 2 Results and Discussions

### 2.1 Materials Characterization

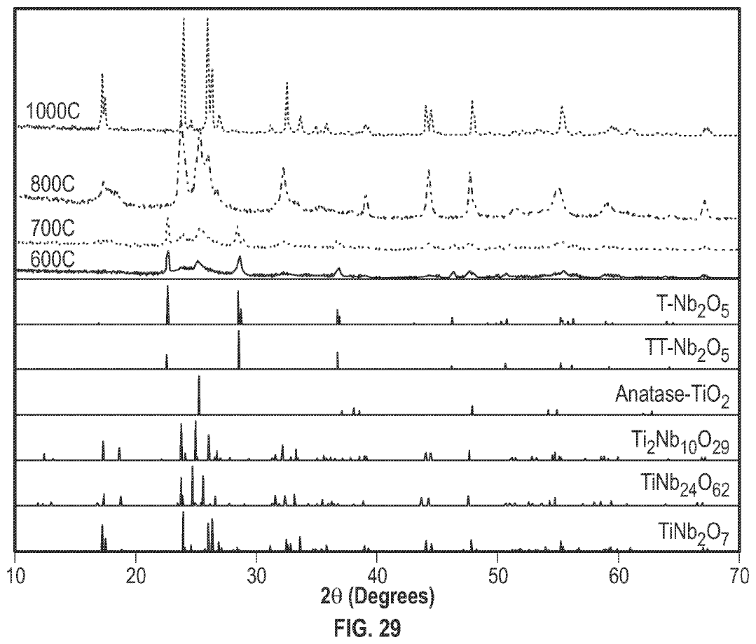

The XRD patterns for all four synthesized TNO materials are shown in FIG. 29. For the 1000 C sample, at this highest temperature synthesis there were no impurity phases observed and the XRD pattern aligned well with the reference patterns for monoclinic C2/m, consistent with other TNO reports. The 800 C sample exhibited broader peaks in the XRD pattern suggesting lower crystallinity, and there were impurity peaks observed which were consistent with a blend of other phases of titanium niobates and anatase TiO₂ as previously reported (by the present inventor) for similarly processed materials. The 700° C. sample possessed major phases assigned as T-Nb₂O₅ (orthorhombic, pbam) and anatase TiO₂, while the minor contributing phases were consistent with multiple titanium niobates. The 600° C. sample compared to the 700° C. sample had slightly lower crystallinity, with TT-Nb205(pseudohexagonal,-p62) consistent with the peaks of the major contributing phase as opposed to T-Nb₂O₅. The observation/trend that lower temperature resulted in TT-Nb₂O₅ was consistent with previous reports.

The 1000° C. sample had large internal porosity, and the primary particles were distinct and exhibited particle size of ˜700 nm. The 800 C sample had slightly less distinguishable internal voids in the secondary aggregates, and the primary particles were much smaller, in the ˜100 nm range. The 700° C. and 600° C. samples appeared similar, and the surface of the secondary particle aggregates was smoother with less defined pore regions compared to the 800° C. and 1000° C. samples. The primary particles did not have pronounced morphology, which possibly originated from the low crystallinity in these materials and would be consistent with the XRD results. The pellet surfaces for all samples were flat due to the hydraulic compression step, and the primary particle morphologies were not changed noticeably relative to the source powders.

### 2.2 Composite Electrode Cell Characterization

TABLE 7

| Sample | 600 C. | 700 C. | 800 C. | 1000 C. |
|---|---|---|---|---|
| First Charge Average Voltage (V, vs Li/Li⁺) | 1.69 | 1.64 | 1.62 | 1.58 |
| First Charge Capacity (mAh g⁻¹ TNO) | 190 | 259 | 233 | 258 |
| First Cycle Coulombic Efficiency (%) | 122% | 111% | 114% | 106% |
| Last (30^{th}) Charge Cycle Capacity Retention (%) | 94.8% | 84.4% | 83.6% | 67.5% |

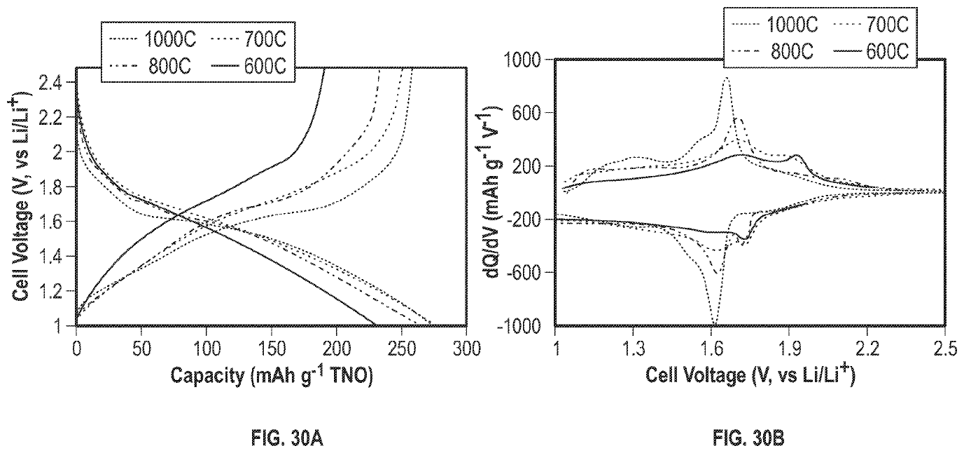

First cycle of discharge and charge voltage profiles for TNO composite electrodes paired with Li foil anodes at rates of C/10, and the corresponding dQ/dV profiles from those cycles, can be found in FIG. 30. The first charge delivered 258 mAh⁻¹ TNO with an initial columbic efficiency (CE) of 106%. The first charge and discharge voltage profile for the 1000° C. TNO electrode included three regions. There were two sloped regions, one below ˜1.5 V and one above ˜1.6 V, and a plateau region in between. Correspondingly, a prominent major dQ/dV peak was observed at ˜1.65 V and the rest voltage regions had much lower capacity. These electrochemical outcomes are relatively low charge/discharge rates were consistent with previous reports for TNO materials with high crystallinity, which originated from the simultaneous redox of Ti⁴⁺/Ti³⁺ and Nb⁵⁺/Nb³⁺. The last charge cycle capacity retention was low of only 67.5%, in which is suspected to be the reason from the large volume change of 6-10% of TNO with high crystallinity during cycling.

For the 800° C. TNO material, the first charge achieved 259 mAh⁻¹ TNO with an initial CE of 111%. For the first discharge there were two small voltage plateaus at ˜1.7 V, and correspondingly two dQ/dV peaks were observed. The smaller dQ/dV peak appeared at ˜1.75 V and was not present in the 1000° C. sample. The following charge cycle had a relatively broad and shallow peak at ˜1.9 V. Coupling the dQ/dV peak position and the low reversibility, it is speculated that such capacity originated from the Ti⁴⁺/Ti³⁺ redox in the TiO₂ phase, which would have been consistent with previous reports. The last charge cycle capacity retention (83.6%) was much improved compared to the 1000° C. sample.

For the 700° C. sample, the first charge achieved 233 mAh⁻¹ TNO with an initial CE of 114%. The capacity was more evenly distributed throughout the voltage window. In the dQ/dV plot, as was the case for the 800° C. material, there were two peaks (at ˜1.75 V and ˜1.6 V). Compared to those of the 800° C. sample, the first discharge peak at ˜1.75 V initiated at a higher voltage and the peak was broader. Also in comparison to the 800 C material the second peak from discharge at ˜1.6 V had smaller intensity but was much wider, and the dQ/dV plot had greater absolute values in the regions outside the peaks as well. These observations were consistent with previous electrochemical reports for T-Nb₂O₅. The last charge cycle capacity retention (84.4%) was improved compared to the 800° C. sample.

For the 600° C. sample, the first charge achieved 190 mAh⁻¹ TNO with an initial CE of 122%. This outcome may have been due to the low crystallinity of the material and/or the inherent smaller capacity of the contributing phase of TT-Nb₂O₅. In addition, the discharge profile had a significant slope with only a very shallow plateau observed. The last charge cycle capacity retention (94.8%) was the best.

In brief, as the synthesis temperature decreased, the last charge cycle capacity retention increased. However, the average charge voltage increased, which would limit the voltage if used as anode in a full cell.

### 2.3 Sintered Electrode Cell Characterization

TABLE 8
Electrochemical Evaluation Summary for sintered TNO electrode vs LCO cathode.

| Sample | 600 C. | 700 C. | 800 C. | 1000 C. |
|---|---|---|---|---|
| First Discharge Average Voltage (V, cell) | 2.12 | 2.23 | 2.25 | 2.33 |
| First Cycle Energy Efficiency (%) | 85.4% | 90.2% | 90.8% | 93.4% |
| First Discharge Capacity (mAh g⁻¹ TNO) | 234 | 233 | 231 | 249 |
| First Cycle Coulombic Efficiency (%) | 88.2% | 88.6% | 92.1% | 94.0% |
| Last (25^{th}) Discharge Cycle Capacity Retention (%) | 78.8% | 95.3% | 90.8% | N/A |

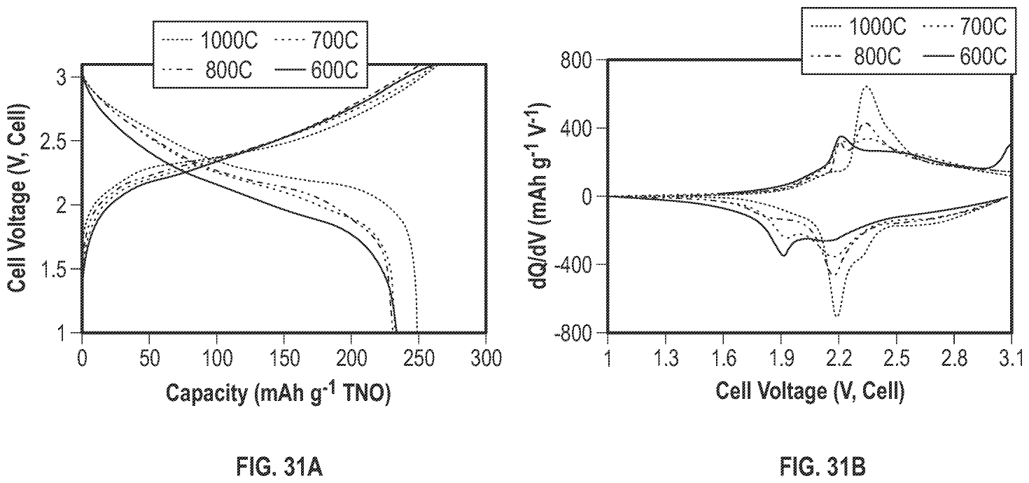

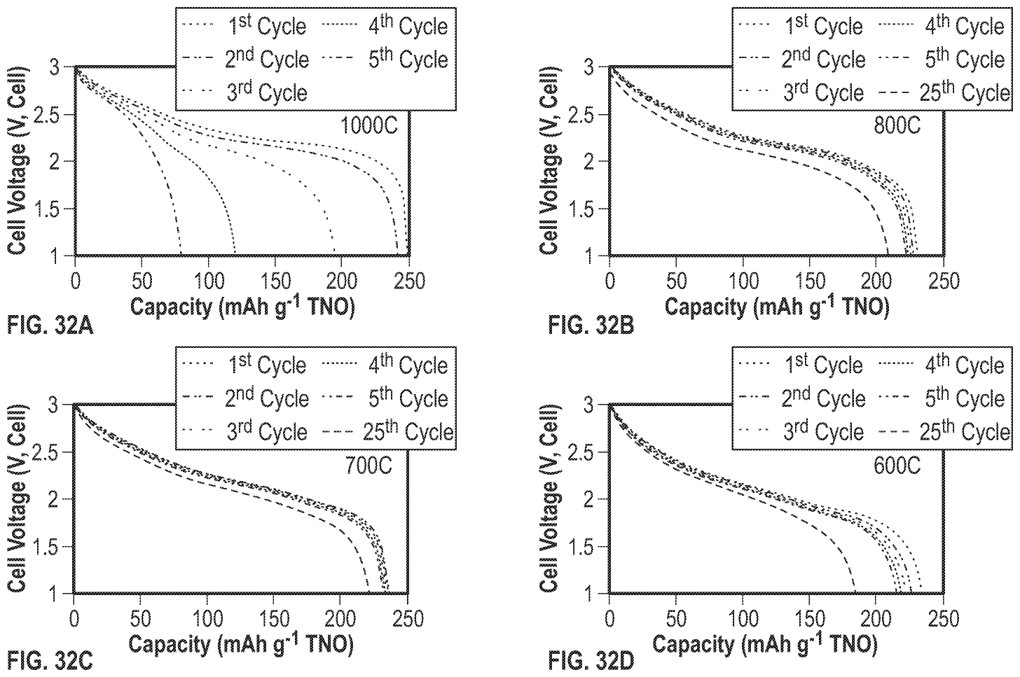

For the first charge and discharge voltage profiles and dQ/dV at C/50 (FIG. 31) for sintered cells with TNO material anodes paired with LCO cathodes, the 1000 C sample had the largest discharge capacity of 249 mAh g⁻¹ TNO with the highest average discharge voltage (2.33 V, cell). The 1000 C TNO also had the highest first cycle coulombic efficiency (94.0%) and voltage efficiency (93.4%). Although the TNO was paired with LCO that had a more sloped OCV instead of a fixed OCV of Li metal, the shape of the dQ/dV was still consistent with the composite dQ/dV. For the sintered cell that corresponds to the first discharge of the composite cell, a single large peak was observed in dQ/dV, although the peak was slightly wider due to factors such as ionic overpotentials and sloped OCV of LCO, which matched the composite dQ/dV. However, there were dramatic stability limitations for the 1000 C TNO sintered anode cells at later cycles. As can be seen in FIG. 32A, after the first five cycles at C/50 the discharge capacity plummeted from ˜250 mAh g⁻¹ TNO to only ˜80 mAh g⁻¹ TNO and the average voltage also declined. Such severe capacity fading was not observed in the composite cell with 1000 C TNO. One possibility for these different outcomes with regards to cycling stability for composite versus sintered electrodes for the same materials may have been due to a mechanical failure of the electrode. For sintered electrode architecture, mechanical integrity of the electrode is provided by the interconnected particles of the electroactive material. TNO has been reported to undergo 6-10% volume change during cycling. Failure from excessive strain and particle fracture within sintered electrodes would result in loss of particle connectivity and matrix electronic conductivity. An additional TNO-LCO sintered electrode cell with 1000 C TNO as the anode was cycled between 1.0-2.7 V for 5 cycles followed by 1.0-2.8 V for 5 cycles. The capacity and voltage fade were much smaller for the first 5 cycles between 1.0-2.7 V. An additional 5 cycles between 1.0-2.8 V increased the rate of capacity fade. The 1000 C sample with high crystallinity was not a suitable material for sintered electrodes due to dramatic capacity fade.

For the 800° C. TNO sintered anode, the first discharge delivered 231 mAh g⁻¹ TNO capacity with an average discharge voltage of 2.25 V, cell. The first cycle voltage efficiency and CE were 90.8%, and 92.1%, both slightly lower than those of the 1000° C. sample. In the dQ/dV plot, the first charge had two peaks, but the first discharge had only one peak, consistent with the composite dQ/dV outcomes. The stability of this sample was much improved with a capacity retention of 91% and energy retention of 85% at 25^{th} cycle, relative to the 1000° C. sample that faded quickly.

For the 700° C. sample, the first discharge delivered 233 mAh g⁻¹ TNO capacity and an average voltage of 2.23 V. The first cycle voltage efficiency and CE were 90.2%, and 88.6%, both slightly lower than those of the 800 C sample. The number and location of peaks in the dQ/dV profile were also similar to those observed in the 800 C composite cell (when accounting for the offsets with regards to the different electrodes involved). The charge/discharge cycling capacity retention/stability was the best among the sintered TNO anodes evaluated, with a capacity retention of 95.3% and energy retention of 91% at 25^{th} cycle. As mentioned earlier, the volume change during cycling was speculated to be a critical factor to sintered electrode cycling stability. The primary phase assigned to the 700 C TNO material was T-Nb₂O₅, with volume change reported after lithiation to be around 2-3%, much smaller than the volume change reported for the higher temperature TNO phase with high crystallinity phases. The reduced volume change for the T-Nb₂O₅ phase in the 700° C. TNO electrode was suspected as the cause of its increased cycling stability.

For the 600° C. sample, at the end of first charge another voltage plateau appeared (also shown in the dQ/dV plot). This outcome was attributed to the inherently lower capacity of this material compared to the other TNO materials, and may have resulted from overlithiating the anatase or TT-Nb₂O₅. Such overlithiation has been reported to destabilize the electrode architecture and create unfavorable solid electrolyte interphase (SEI). The initial intent was not to utilize the capacity at voltages where SEI formation would be significant, but in order to characterize and compare more thoroughly with the other three materials, the same relative loadings and voltage windows were used to maintain comparisons. The 600° C. TNO first discharge capacity reached 234 mAh g⁻¹ TNO and average voltage was 2.12 V, the lowest among all sintered TNO anode materials evaluated. It also had the lowest energy efficiency and CE of 85.4% and 88.2%, respectively. The cell with this material anode had the lowest capacity retention of 78.8% and energy retention of 77% at the 25^{th} cycle relative to the other TNO materials.

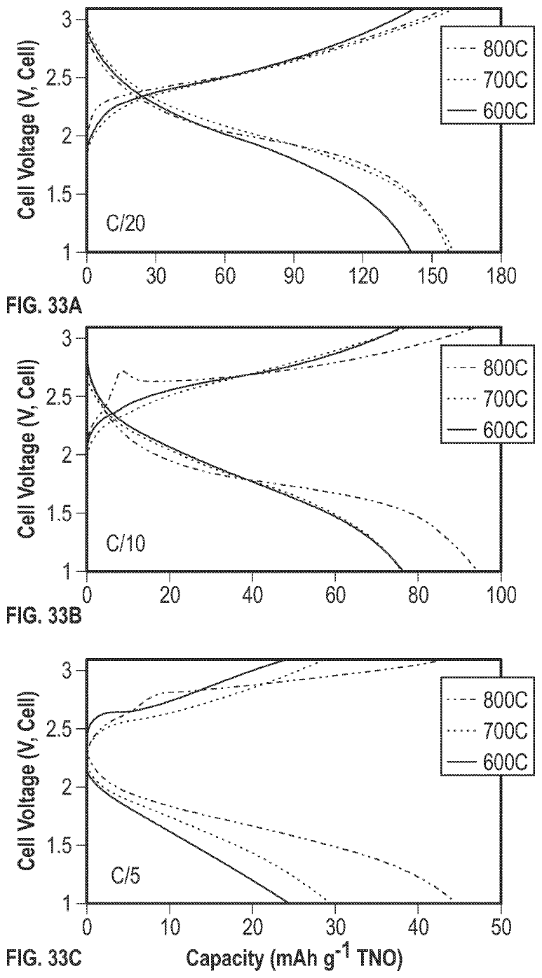

With respect to the rate capabilities, discharge voltage profiles for all samples except for the 1000° C. material can be found in FIG. 33. 1000° C. was not shown due to severe fade in the prior C/50 cycles. The 800 C material had the best capacity and energy retention compared to the 700 C and 600 C sample, suggesting it had the highest overall electronic conductivity. However, closely examining the charge and discharge voltage curves, the initial overpotential was much greater than the other two samples especially at C/5 and C/2.5. It is speculated that the 800 C sample had higher fractions of TNO phases that had more dramatic changes in electronic conductivity as a function of lithiation, and that as the extent of lithiation increased, the material (and electrode matrix) electronic conductivity increased. Another piece of evidence to support this speculates was that at the 16^{th} cycle (first C/2.5 cycle), the capacity was only ˜9 mAh g⁻¹ TNO and went up over 40 mAh g⁻¹ TNO at later cycles. The 16^{th} cycle added a tiny amount of lithiation (˜1.5 mAh g⁻¹ TNO), which would increase the electronic conductivity in the matric which would have facilitated further lithiation for the later cycles. For the 700 C sample, at C/10 and C/5 for both charge and discharge cycle, the overpotential was initially lower, but greater in later stage of the cycles than those of 800 C. Such observations suggested that the 700 C sample had slightly higher electronic conductivity at low lithiation state but lower electronic conductivity at higher lithiation state compared to that of 800 C sample. The overall lower capacity delivered suggested the overall lower electronic conductivity of 700 C sample. It is speculated that the blend phases of T-Nb₂O₅, anatase, and titanium niobates compared to TNO phases had much smaller lithiation dependent electronic conductivity. For the 600 C sample, it had the worst rate capabilities compared to both 700 C and 800 C samples, which could stem from the low crystallinity or the low conductivity of the TT-Nb₂O₅ phase.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not

to be construed as designating levels of importance:

Aspect 1 provides an electrochemical storage device comprising:
an electrode comprising:
   TiNb₂O₇,
   LiCoO₂,
   LiNi_{0.5}Mn_{0.5}O₂,
   lithium metal,
   LiMn₂O₄,
   Li₄Ti₅O₁₂,
   a mixture of LiMn₂O₄ and LiCoO₂,
      a mixture of LiCoO₂ and LiNi_{0.5}Mn_{0.5}O₂, or multiple phases thereof
a mixture thereof.

Aspect 2 provides the electrochemical storage device of Aspect 1, wherein the electrode is a sintered electrode.

Aspect 3 provides the electrochemical storage device of any one of Aspects 1 or 2, wherein the electrode is a composite electrode.

Aspect 4 provides the electrochemical storage device of Aspect 3, wherein the composite electrode comprises a metallic substrate to which the TiNb₂O₇, LiCoO₂, LiNi_{0.5}Mn_{0.5}O₂, lithium metal, LiMn₂O₄, Li₄Ti₅O₁₂, a mixture of LiMn₂O₄ and LiCoO₂, multiple phase thereof, or mixture thereof is applied.

Aspect 5 provides the electrochemical storage device of Aspect 4, wherein the metallic substrate comprises a stainless steel, aluminum, alloys thereof, or mixtures thereof.

Aspect 6 provides the electrochemical storage device of any one of Aspects 1-5, wherein a thickness of the electrode is in a range of from about 50 μm to about 2000 μm.

Aspect 7 provides the electrochemical storage device of any one of Aspects 1-6, wherein a thickness of the electrode is in a range of from about 70 μm to about 400 μm.

Aspect 8 provides the electrochemical storage device of any one of Aspects 1-7, wherein the electrode is substantially free of a conductive additive.

Aspect 9 provides the electrochemical storage device of Aspect 8, wherein the conductive additive comprises a polymer binder, a conductive carbon, or a mixture thereof.

Aspect 10 provides the electrochemical storage device of any one of Aspects 1-9, wherein a porosity of the electrode is in a range of from about 30% to about 50%.

Aspect 11 provides the electrochemical storage device of any one of Aspects 1-10, wherein a porosity of the electrode is in a range of from about 35% to about 40%.

Aspect 12 provides the electrochemical storage device of any one of Aspects 1-11, wherein a capacity of the electrode is in a range of from about 7 mAh/cm² to about 100 mAh/cm².

Aspect 13 provides the electrochemical storage device of any one of Aspects 1-12, wherein a capacity of the electrode is in a range of from about 10 mAh/cm² to about 50 mAh/cm².

Aspect 14 provides the electrochemical storage device of any one of Aspects 1-13, wherein the electrode is an anode.

Aspect 15 provides the electrochemical storage device of any one of Aspects 1-13, wherein the electrode is a cathode.

Aspect 16 provides the electrochemical storage device of Aspect 15, wherein the cathode comprises the LiCoO₂.

Aspect 17 provides the electrochemical storage device of any one of Aspects 1-16, wherein the electrode comprises one dopant.

Aspect 18 provides the electrochemical storage device of Aspect 17, wherein the doped electrode comprises at least two dopants.

Aspect 19 provides the electrochemical storage device of any one of Aspects 17 or 18, wherein the at least one dopant has a 1⁺, 2⁺, or 3⁺ oxidation state.

Aspect 20 provides the electrochemical storage device of any one of Aspects 1-19, wherein the at least one dopant comprises copper, aluminum, sulfur, potassium, or a mixture thereof.

Aspect 21 provides the electrochemical storage device of any one of Aspects 1-20, wherein the electrode is a battery anode.

Aspect 22 provides the electrochemical storage device of any one of Aspects 1-21, wherein the electrode is a battery cathode.

Aspect 23 provides the electrochemical storage device of any one of Aspects 1-22, wherein the electrode is free of a binder, an inactive solid additive, or a mixture thereof.

Aspect 24 provides the electrochemical storage device of any one of Aspects 1-23, further comprising a carbon coating at least partially disposed over the electrode.

Aspect 25 provides the electrochemical storage device of Aspect 24, wherein the carbon coating is disposed over about 30% to about 100% of a total surface area of the electrode.

Aspect 26 provides the electrochemical storage device of Aspect 24, wherein the carbon coating is disposed over about 60% to about 95% of a total surface area of the electrode.

Aspect 27 provides a lithium-ion battery comprising:
a first electrode corresponding to the electrode of any one of Aspects 1-26;
a second electrode spaced apart from the first electrode;
an electrolyte in contact with the first electrode and the second electrode; and
a separator positioned between the first electrode and the second electrode.

Aspect 28 provides the lithium-ion battery of Aspect 27, wherein the electrolyte comprises a salt.

Aspect 29 provides the lithium-ion battery of any one of Aspects 27 or 28, wherein the separator comprises a porous polymer or glass fiber impregnated with electrolyte.

Aspect 30 provides the lithium-ion battery of Aspect 29, wherein the polymer comprises a polyurethane, a polypropylene, a polyethylene, a copolymer thereof, or a mixture thereof.

Aspect 31 provides the electrochemical storage device of any one of Aspects 1-30, wherein the electrochemical storage device comprises a lithium-ion battery.

Aspect 32 provides an article comprising the electrochemical storage device of any one of Aspects 1-31.

Aspect 33 provides the article of Aspect 32, wherein the article comprises a vehicle or an electronic device.

Aspect 34 provides a method of making the electrode of any one of Aspects 1-33, the method comprising:
contacting components of an electroactive material;
blending the components of the electroactive material; and
sintering the blended electroactive material to form the sintered electrode.

Aspect 35 provides the method of Aspect 34, wherein the sintering is performed at a temperature in range of from about 500° C. to about 1100° C.

Aspect 36 provides the method of any one of Aspects 34 or 35, wherein the sintering is performed at a temperature in range of from about 700° C. to about 900° C.

Aspect 37 provides the method of any one of Aspects 34-36, wherein sintering is performed at a variable temperature.

Aspect 38 provides the method of any one of Aspects 34-37, wherein sintering is performed over a period of time in a range of from about 0.5 hours to about 20 hours.

Aspect 39 provides the method of any one of Aspects 34-38, wherein sintering is performed over a period of time in a range of from about 16 hours to about 18 hours.

Aspect 40 provides the method of any one of Aspects 34-39, wherein at least one component of the electrode precursor is sucrose.

Aspect 41 provides a method of making the composite electrode of any one of Aspects 3-40, the method comprising:
forming a slurry of an electroactive material;
casting the slurry of the electroactive material to a substrate; and
drying the slurry of the electroactive material, to form the composite electrode.

Aspect 42 provides a method of using a battery including the electrode of any one of Aspects 1-41, to generate electricity.

Aspect 43 provides a method of using the electrode of any one of Aspects 1-42, electrode to perform electrochemical reactions.

Aspect 44 provides a method of providing or performing one or more of the following: a) communication-sintered electrode full cells incorporating TiNb₂O₇ anode materials, b) communication-TiNb₂O₇ anode for sintered electrode full cells, c) enhancing low electronic conductivity materials in sintered electrodes through multicomponent architecture, d) percolated LiCoO₂ for improved electronic conductivity in multicomponent thick sintered lithium-ion battery electrodes, or e) multicomponent two-layered cathode for thick sintered lithium-ion batteries, as described herein.

Aspect 45 provides The method according to Aspect 44, including each and every novel feature or combination of features disclosed herein.

Aspect 46 provides a system configured to provide one or more of the following: a) communication-sintered electrode full cells incorporating TiNb₂O₇ anode materials, b) communication-TiNb₂O₇ anode for sintered electrode full cells, c) enhancing low electronic conductivity materials in sintered electrodes through multicomponent architecture, d) percolated LiCoO₂ for improved electronic conductivity in multicomponent thick sintered lithium-ion battery electrodes, or e) multicomponent two-layered cathode for thick sintered lithium-ion batteries, as described herein.

Aspect 47 provides The system according to 46, including each and every novel feature or combination of features disclosed herein.

Aspect 48 provides a composition comprising (or aspects therefrom or thereof), one or more of the following: a) communication-sintered electrode full cells incorporating TiNb₂O₇ anode materials, b) communication-TiNb₂O₇ anode for sintered electrode full cells, c) enhancing low electronic conductivity materials in sintered electrodes through multicomponent architecture, d) percolated LiCoO₂ for improved electronic conductivity in multicomponent thick sintered lithium-ion battery electrodes, or e) multicomponent two-layered cathode for thick sintered lithium-ion batteries, as described herein.

Aspect 49 provides The composition according to Aspect 48, including each and every novel feature or combination of features disclosed herein.

Aspect 50 provides an article of manufacture comprising (or aspect thereof) one or more of the following: a) communication-sintered electrode full cells incorporating TiNb₂O₇ anode materials, b) communication-TiNb₂O₇ anode for sintered electrode full cells, c) enhancing low electronic conductivity materials in sintered electrodes through multicomponent architecture, d) percolated LiCoO₂ for improved electronic conductivity in multicomponent thick sintered lithium-ion battery electrodes, or e) multicomponent two-layered cathode for thick sintered lithium-ion batteries, as described herein.

Aspect 51 provides The article of manufacture of Aspect 50, including each and every novel feature or combination of features disclosed herein.

Aspect 52 provides the electrochemical storage device of any one of Aspects 1-31, wherein the electrode further comprises lithium metal.

1. An electrochemical storage device comprising:
an electrode comprising:
TiNb₂O₇,
LiCoO₂,
LiNi_{0.5}Mn_{0.5}O₂,
LiMn₂O₄,
Li₄Ti₅O₁₂,
a mixture of LiMn₂O₄ and LiCoO₂,
a mixture of LiCoO₂ and LiNi_{0.5}Mn_{0.5}O₂,
multiple phases thereof, or
a mixture thereof.

2. The electrochemical storage device of claim 1, wherein the electrode is a sintered electrode.

3. The electrochemical storage device of claim 1, wherein the electrode is a composite electrode.

4. The electrochemical storage device of claim 3, wherein the composite electrode comprises a metallic substrate to which the TiNb₂O₇, LiCoO₂, LiNi_{0.5}Mn_{0.5}O₂, LiMn₂O₄, Li₄Ti₁₅O₁₂, a mixture of LiMn₂O₄ and LiCoO₂, multiple phases thereof, or mixture thereof is applied.

5. (canceled)

6. The electrochemical storage device of claim 1, wherein a thickness of the electrode is in a range of from about 50 μm to about 2000 μm.

7. (canceled)

8. The electrochemical storage device of claim 1, wherein the electrode is substantially free of a conductive additive.

9. (canceled)

10. The electrochemical storage device of claim 1, wherein a porosity of the electrode is in a range of from about 30% to about 50%.

11. (canceled)

12. The electrochemical storage device of claim 1, wherein a capacity of the electrode is in a range of from about 7 mAh/cm² to about 100 mAh/cm².

13. (canceled)

14. (canceled)

15. (canceled)

16. (canceled)

17. (canceled)

18. The electrochemical storage device of claim 1, wherein the electrode comprises at least two dopants.

19. (canceled)

20. (canceled)

21. (canceled)

22. (canceled)

23. The electrochemical storage device of claim 1, wherein the electrode is free of a binder, an inactive solid additive, or a mixture thereof.

24. The electrochemical storage device of claim 1, further comprising a carbon coating at least partially disposed over the electrode.

25. The electrochemical storage device of claim 24, wherein the carbon coating is disposed over about 30% to about 100% of a total surface area of the electrode.

26. (canceled)

27. (canceled)

28. (canceled)

29. (canceled)

30. (canceled)

31. (canceled)

32. (canceled)

33. (canceled)

34. A method of making the electrode of claim 1, the method comprising:
contacting components of an electroactive material;
blending the components of the electroactive material; and
sintering the blended electroactive material to form the sintered electrode.

35. The method of claim 34, wherein the sintering is performed at a temperature in range of from about 500° C. to about 1100° C.

36. The method of claim 34, wherein the sintering is performed at a temperature in range of from about 700° C. to about 900° C.

37. The method of claim 34, wherein sintering is performed at a variable temperature.

38. The method of claim 34, wherein sintering is performed over a period of time in a range of from about 0.5 hours to about 20 hours.

39. The method of claim 34, wherein sintering is performed over a period of time in a range of from about 16 hours to about 18 hours.

40. The method of claim 34, wherein at least one component of the electrode precursor is sucrose.

41. A method of making the composite electrode of claim 3, the method comprising:
forming a slurry of an electroactive material;
casting the slurry of the electroactive material to a substrate; and
drying the slurry of the electroactive material, to form the composite electrode.

42. (canceled)

43. (canceled)

44. (canceled)
